(19) United States
(12) Patent Application Publication
(10) Pub. No.: US 2023/0318997 A1
(43) Pub. Date: Oct. 5, 2023

(54) Voice and video calling and recording within messaging session in message interface

(71) Applicant: Yogesh Rathod, Mumbai (IN)

(72) Inventor: Yogesh Rathod, Mumbai (IN)

(21) Appl. No.: 18/135,127

(22) Filed: Apr. 15, 2023

Related U.S. Application Data
(63) Continuation of application No. PCT/IB2021/059269, filed on Oct. 10, 2021.
Application No. PCT/IB2021/059269 is a continuation of application No. PCT/IB2020/060029, filed on Oct. 26, 2020.

(51) Int. Cl. H04L 51/046; H04N 7/14

(52) U.S. Cl. CPC H04L 51/046; H04N 7/147

(57) ABSTRACT

In various embodiments, enabling a first user and a second user to send and receive messages and one or more types of contents from the messaging or sharing user interface and in the event of receiving from the first user, indication of voice and/or video call by the second user, displaying voice and/or video interface to the first user and the second user or displaying indication or notification or incoming call interface to the second user and in the event of acceptance of call, displaying voice and/or video interface to the first user and the second user for voice or video conversation. In the event of receiving call ending indication from the first user or the second user, ending call and communication session, closing or hiding voice and/or video communication user interface and store recorded communication between the first user and the second user.

### FIELD OF INVENTION

Various embodiments described herein generally relate to systems and methods for enabling a first user and a second user to send and receive messages and one or more types of contents from the messaging or sharing user interface and in the event of receiving from the first user, indication of voice and/or video call by the second user, displaying voice and/or video interface to the first user and the second user or displaying indication or notification or incoming call interface to the second user and in the event of acceptance of call, displaying voice and/or video interface to the first user and the second user for voice or video conversation. In the event of receiving call ending indication from the first user or the second user, ending call and communication session, closing or hiding voice and/or video communication user interface and store recorded communication between the first user and the second user. In some embodiments enabling platform for short video creators, advertisers and viewers and facilitating advertiser to create and publish short video(s) and charging advertisement based on monitored and tracked viewing users' activities, actions, behaviors, interactions, transactions, reactions, sharing, communication and sharing advertisement revenue with short video creator. In another model, advertiser can search and select creator and can submit details requirements. Creator can create video as per requirement and advertiser review, moderate, verify, finalize video and publish video on platform for viewing users of network. Based on monitored and tracked actions and reactions on published video, platform charges advertiser based on advertising model(s) and share revenue with video creator based on revenue sharing model. In another embodiment systems and methods for creating music videos based on selecting or automatically selecting audio file and concurrently playing video file and selected audio file, so first video file (without audio of video) can play with first audio file and first video file (without audio of video) can play with second audio file, wherein first audio file and second audio file contains different audio. Likewise, second video file (without audio of video) can play with third audio file and second video file (without audio of video) can play with fourth audio file, wherein third audio file and fourth audio file contain different audio. In another embodiment graphical user interface for preparing, publishing and viewing microblog or contents. In another embodiment publishing contents as per schedule or schedule as per rules, so viewing user can view published contents as per pre-defined schedule or rules and identification of triggers.

### BACKGROUND OF THE INVENTION

Currently Fiverr is an online marketplace for freelance services. The company provides a platform for freelancers to offer services including developing short video to customers worldwide. Customer or advertiser can search, browse, view details and select freelancer's short video service for development and make order and payment, provide requirements and get short video development work done. But customer need to make payment for video development and advertise or publish video on different platforms and need to make payment for advertisement.

At present advertiser need to hire video producers or influencers to create contents including short video(s) and create one or more advertisement campaigns on one or more social networks, search engines, websites and applications to advertise said video(s). Present invention enables video producers or influencers to produce contents including short video(s) for one or more selected brands or target advertises or shops and submit to platform for review, moderation, verification and making said content searchable and list or publish said content on platform for viewing users of network. Server monitors and tracks number of views, follows to said brand or created brand page, comments, likes, one or more types of call-to-actions including add to interest list, share, make enquiry, request to buy, like to visit place, already used in past and like, refer, wish to try. After reaching particular range of numbers of engagements and reach of said content among users of network or viewing users of network, server or influencer can communicate with said brand or advertiser communicate with platform and enable them to claim said content, brand page and associated followers based on making payment as per charges model(s) (pay per views, followers, actions, reactions) and after owning said content and associated data, followers, brand page and control of said content management, brand owner or admin can start advertisement campaign based on target criteria and server monitors and tracks engagements and reach (number of views, followers, likes, comments, shares and number of actions or custom call-to-actions) and determines or identifies advertisement charges based on advertisement model and collect from advertiser charges and share revenue with content producer or influencer based on revenue sharing models and agreements.

A TikTok branded hashtag challenge is one where a brand asks people to perform a certain task in short video and tag them using a specific hashtag. Users take an idea, and iterate upon it in their own videos. Tiktok creator marketplace enables advertisers to find influencers and partnership with them. But If platform does decide to charge advertisers a fee for using TCM, it may push advertisers away from the platform (towards working with TikTok agencies). Similarly, if platform decides to take a cut of influencer rates/earnings, influencers may opt to bypass TCM in favor of working only with management or agencies.

The YouTube Partner Program lets creators monetize their content on YouTube. Creators can earn money from advertisements served on their videos and from YouTube Premium subscribers watching their content. At present advertiser prepares advertisement including text, post, photo, video and associate and integrate one or more actions or call-to-actions and with said advertisement and advertise said advertisement having integrated actions within advertisement content on target criteria specific contents of other users of network. Present invention enables advertiser to select actions in the form of standardized icons or controls including icon, image, button, link and associate with selected or target criteria specific contents of users of network. Viewing user of said content can view said added actions in the form of icons or control which may ordered based on rank, having more clicks and enable viewing user to scroll icons to select and click or tap on particular selected icon to take associated action or call-to-action or reaction. So, viewing user feels standardized call-to-actions icons on each displayed post and feel non-obstructed, concise, standard advertisement format and look and feel convenient and intuitive user interface. In the event of click or tap on particle icon from displayed set of icons, display further actions or menu of actions or graphical user interface comprises one or more types of contents, actions and reaction controls and one or more types of controls or redirect to website or open application or other one or more types of content.

All prior arts do not teaches enabling advertiser to select short video creators, provide requirement specification or select type of short video from templates, assign short video creation task as per requirement and review, request revision, done moderation and publish finalized short video on network as per provided target criteria. Advertiser can create or develop short video(s) as per requirement from selected creator(s), publish video as per target criteria and schedule within users of network and based on monitored and tracked viewing users' activities, actions, behaviors, interactions, transactions, reactions, sharing, communication identifying charges of advertisement, charging advertiser and determining revenue sharing with short video creator. In another embodiment creator can creates videos for selected one or more brands or products or services and submit to advertiser for review, moderation, acceptance which they can publish for viewing users of network after verification. Platform can share with creator based on revenue sharing as per advertising charges model. Therefore, it is with respect to these considerations and others that the present invention has been made.

The U.S. Pat. No. 9,691,429 describes a way to create videos syncing to audio, including in some cases, when one or more video takes are captured while the selected audio track plays. TikTok allowing its users to stitch together multiple videos while using the same audio track.

In one embodiment present invention enables user to instead of capturing the video takes with the audio track and the video takes may be synchronized to the audio tracks so that they are in time with one another, concurrently and independently playing video and selected audio files (audio file playing in background) or (make video mute or remove integrated voice from video), so user feels both are playing together and are in time with one another. By using pre In an embodiment first loads video file and associated or selected independent audio file in local storage of user device (e.g. smartphone) and then in the event of receiving instruction to play video file, automatically and concurrently start playing associated or user selected or automatically selected based on plurality of factors audio file in background without interruption (slow internet data and like) and in the event of stopping or pausing video file, automatically stopping or pausing audio file or in the event of restarting playing of video file, automatically and concurrently restarting playing of audio file.

At present Twitter microblogging user interface displaying multiple posted contents. Present invention enables user to prepare full screen post style microblogs or contents and enables viewing users to view said posted microblogs or contents in full screen. User can swipe right to view current psot associated source related posted contents in chronological order and user can swipe down or up to view contents in chronological order posted by different sources including followed sources, contextual contents customized for particular user, selected source(s) or category(ies) or keyword(s) or searched or matched microblogs or contents.

At present TikTok, Facebook, Instagram and others enables user to view random, searched, selected or contextual short videos. Television channel centrally schedule and broadcast scheduled programs on television. In present invention by using self-service user interface, publisher can set schedule, upload video and select action and as per said set schedule, publishing, posting or broadcasting or presenting said pre-set schedule associated posted contents to viewing users of network. Viewing users can provide reactions, take selected actions from displayed actions on short video or contents. User can view posted contents, short videos, ephemeral posts, posts, microblog, photos, videos in feed as per pre-set schedule associated with posted contents set by publisher od said contents.

### OBJECT OF THE INVENTION

The principal object of the present invention is to enable creator of videos or contents to select global or national or state or city or local brand or company or shop or organization or product or service and submit one or more short videos to selected global or national or state or city or local brand or company or shop or organization or product or service or advertiser for review, moderation, verification, testing or trialing, able to request revisions or suggested modifications and accepting and finalizing one or more submitted short videos or contents. After finalizing short videos or contents advertiser can submit one or more short videos or contents with target criteria and settings to platform for publishing. Platform can review or directly publish short videos or contents and displaying short videos or contents in viewing user's feed based on plurality of factors including user's interest, age, gender, following, add to one or more types of list, like, share, and comment on video associated source, view multiple times video and searched sources, logged views, actions and reactions on viewed video and associated tags, keywords, recognized objects or scene or person inside video associated name or keywords or contextual keywords, nearby location or associated place or pre-defined geofence associated place, interacted or visited or transacted places, user profile and identified keywords associated with user. Platform or server monitors, tracks and records or stores viewing user's actions and reactions including views, conducted actions including like, comment, share, buy, subscribe, sign up, register, fill form, connect, participate in deal, claim offer, book, get appointment and charge and collect charges from advertiser based on advertising models and determine eligibility (minimum number of views and/or one or more types of actions within pre-define period, reports) and amount for revenue sharing and share revenue with video creators based on revenue sharing models.

The other principal object of the present invention is to enabling platform for short video creators, advertisers and viewers wherein advertiser can publish entertainment short video which covers advertisement of brand, company, firm, product, service without knowing user advertisement. Viewer or users of network can via short video which may comprises surprise, entertainment, education, story related short video as well as advertisement in non-obstructed format i.e. advertisement and entertainment in short video are same. There is no separate advertisement over, inside or in-middle video. Short video format is advertisement in the form of entertainment short video. The other principal object of the present invention is to enable content creator user to produce content for particular brand and publish on network and monitor and track engagements and reach statistics and analytics. Brand owner or admin can search, view, notify about updated engagements and reach statistics and analytics and enable to claim and own or purchase or take control of content and associated engagements and reach data (followers, comments, actions data) and make payment based on engagements and reach statistics and analytics.

The other principal object of the present invention is to enable advertiser or creator or influencer or user to search, match and select contents and select and associate one or more call-to-actions and reactions functions or controls, so viewing users can take action from associated content.

The other principal object of the present invention is to enable user to search, select, suggest, customize and add or attach or link or associate one or more call-to-actions with one or more contents. Platform reviews, accepts or rejects, develop accepted suggestions and make available

for other users of network, so they can add search, match, select and add new call-to-actions with related contents.

The other principal object of the present invention is to creating music videos synchronized with multiple selected audio track and create one file and enable to select audio from plurality of synchronized audio and in the event of playing video, play said selected synchronized audio while playing video. While playing video user can select another audio from list of audios and in the event of changing audio, play said changed synchronized audio start from same time as current video playing time. Next time user can select another or second audio and in the event of playing video, play said selected synchronized another or second audio while playing video. In another way user can select or automatically select audio and in the event of receiving instruction to play video file, concurrently and independently play video file as well as selected independent audio file, wherein audio file having same length of duration as video file. Various embodiments described herein generally relate to systems and methods for creating music videos. In particular, music videos may be created including portions of one or more video takes that are automatically synchronized to one or more audio tracks each separately play based on user selection or in other embodiment creating independent audio files of each selected audio tracks and associate with video, wherein audio is equal or less length to video length.

The other object of present invention is creating and publishing microblog post, view category specific microblog post. The other object of present invention is publishing and broadcasting scheduled contents including short videos

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention. In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

In some embodiments outputting, by a mobile computing device and for display at a presence-sensitive display, a graphical user interface including at least an icon associated with an action, from a plurality of actions, executable by the mobile computing device, receiving, by the mobile computing device and from the presence-sensitive display, an indication of a first user input detected by the presence-sensitive display at a location of the presence-sensitive display associated with the icon and responsive to receiving the indication of the first user input, executing icon associated action or outputting, by the mobile computing device and for display at the presence-sensitive screen, a graphical user interface.

In some embodiments identify or serve search query criteria or filter specific content items of users of network to advertisers, influencers, and users of network for enabling to associate or add or attach or embed or link or integrate one or more actions with one or more content items automatically or manually. Serve content items to viewing users of network, wherein content item comprise overlay or associated or added or attached or embedded or linked or integrated one or more actions controls including icons, wherein each control including icon is associated with action and enable to select particular action control including icon from displayed action controls including icons to execute selected control including icon associated action or function.

In some embodiments content items content items posted by users of network.

In some embodiments content items may include short video, post, story, message, photo, blog, microblog, and one or more types of or combination of any types of contents.

In some embodiments serve content items to user or viewing user based on request, search query, user preferences, matchmaking criteria, following or subscriptions, selected keyword(s), category or hashtag, selected category associated selected keyword or tag or hashtag, scan of code including QR code, face(s) or object(s), recognition of voice issuing voice commend, selecting source(s) or suggestion.

In some embodiments automatically serve content items to user or viewing user.

In some embodiments automatically serve content items to user or viewing user.

In some embodiments displaying action(s) on content item comprises displaying overlay graphical user interface on displayed or currently viewing content including short video or video or post and enable to scroll up and down or left and right to access or view list of displayed actions, select pre-defined area on top or left of icon to view associated information and report including report is not working properly, report as inappropriate, dislike.

In some embodiments in the event of selecting icon, executing associated one or more functions or actions or open graphical user interface or application or widget or menu or further set of actions or options or display one or more types of contents and controls.

In some embodiments receiving invitation from a content creator user to accept submitted content item, accepting submitted content item. advertising content item based on target criteria, monitoring, tracking and logging advertised content item associated engagements and reach, determining or identifying advertisement charges based on engagements and reach and one or more advertisement charges models and determining or identifying revenue sharing with the content creator based on one or more revenue sharing models and agreements.

In some embodiments submitting to a server system, a content item related to particular brand, accepting by the server system, submitted content item, advertising the content item based on target criteria, wherein target criteria set by server admin(s), monitoring, tracking and logging by the server system, advertised content item associated engagements and reach, determining or identifying advertisement charges based on engagements and reach and one or more advertisement charges models and determining or identifying revenue sharing with the content creator based on one or more revenue sharing models and agreements.

In some embodiments enabling brand owner or admin or advertiser related to brand to claim brand related published content control including content, associated engagement and reach data and enable to advertise based on set or updated target criteria, schedule, budget and selected advertisement charges model including pay per view, pay per action or particular type of action or pay per produced content rights.

In some embodiments selecting by a registered advertiser, one or more creators of short videos, sending by the registered advertiser, requirement specifications and selected one or more creators of short videos, sending by a server system, requirement specifications or assignment to selected one or more creators of short videos, accepting by the creator of short video, assignment, submitting by the creator of short video one or more short videos as per requirement specifications or assignment, sending by the sever system, submitted one or more short videos to said registered advertiser for review, verification, request for revision and moderation, in the event of successfully review, verification and moderation, sending request to publish short video with details including selected or customized or attached one or more call-to-actions, preferences, metadata, target criteria and schedule including start and end date of availability of short video for viewing users of network, in the event of successfully review, verification and moderation, publishing by the server system, short videos, receiving request from a client device, displaying short videos, displaying short videos with associated or attached or integrated one or more types of call-to-actions in a feed, monitoring, tracking and logging by the server system, viewers' activities, conducted call-to-actions, interactions, reactions, behavior, transactions related to particular short video and sharing revenue with the short videos creator based on advertisement charges models, revenue sharing model and monitored and tracked viewers' activities, actions, interactions, reactions, behavior, transactions related to particular short video.

In some embodiments in the event of successfully review, verification and moderation, further conducting verification and moderation of received short videos by the server administrator(s).

In some embodiments enabling user to report particular short video as spam or inappropriate or not interested or spam or duplicate or custom report with comment.

In some embodiments monitoring and tracking by the server system, viewers' activities, actions, interactions, reactions, behavior, transactions related to particular short video; and conducting statistics and data analytics to identifying revenue sharing with the short videos creator based on one or more types of revenue sharing model.

In some embodiments revenue sharing model comprise pay per view, pay per thousand impression, pay per call-to-action, pay per short video.

In some embodiments status comprises submitted the requirement, order or assignment accepted, delivery date provided, delivered order or assignment, order or assignment not accepted or cancelled, order or assignment pending, order or assignment completed, revision request, payment made,

In some embodiments receiving registration request from user to register as creator of short videos, wherein registration request comprises one or more types of identity, required user profile and one or more external social networks and applications accounts information, identifying number of posts, viewers, followers, connected users, shares, comments & reviews, likes, dislikes, bookmarks, added to list, reports, ratings, replies related to user or user posted contents on one or more external social networks and applications, verifying user and user eligibility and based on eligibility criteria, identifying eligibility and registering user as creator of short videos.

In some embodiments identifying and verifying number of followers and average views based on influencer associated profile link(s) of one or more external web sites and applications; receiving content and associated target criteria for publishing or advertising content; based on budget and number of followers and average views of criteria specific identified influencers, identifying and selecting or finalizing one or more influencers on one or more external domains; displaying list of finalized influencers with details including unique user name, uniform resource locator (URL) of profile on external domains; in the event of receiving approval, assigning task of producing content and advertising or advertising or endorsing or posting content via selected influencers; and enabling to monitoring, tracking and viewing posted contents associated actual engagements and reach based on links of posted contents by influencers.

In some embodiments target criteria and preferences comprises locations, daily or total budget, schedule including start date, advertisement model including pay based on per particular number of followers or pay per particular number of average views of influencer, automatically selected and ranked influencers based on engagements and reach or user selected and ranked influencers and selected one or more external domain, websites, social networks and applications where advertiser wants to advertise advertisement.

In some embodiments selecting an audio track or a music or a song or a voice, selecting a video or select currently displayed video or access particular video or use already created video. Playing a music video comprising: the selected video, the selected audio track or music or song or voice and playing a music video in which concurrently playing of the selected video with playing of the selected audio track or a music or a song or a voice, wherein video file and audio track or a music or a song or a voice file are independent or different or separate to each other.

In some embodiments selecting audio track based on audio track selected by user, selected by user based on voice command or providing eye or face expression command based on recognizing pre-defined eye and face movement, randomly select audio track, select suggested audio track, automatically select audio track from rank wise list of pre-selected audio tracks, select audio track based on current location or current location associated identified place or identified pre-defined geofence associated audio track, nearby identified contact associated or pre-set audio track, change audio track after each view video, change of time or time range of day including morning, afternoon, evening, night, date, time, date associated festival or event, schedule, identified current event, profile of user and connected users including age, gender, interest, preferences, languages or preferred language(s), past listened or bookmarked or related to particular singers or artists or movies, liked audio tracks or a music or a songs or a voice by user and connected users of user, current trend specific identified an audio or a music or a song or a voice, home and work location and address, education, income range, skills and triggering of one or more triggers and rules.

In some embodiments omit disliked or related to particular language(s) or artist(s), reported or marked audio tracks or a music or a song or a voice from selection of audio track or a music or a song or a voice.

In some embodiments in the event of playing video, automatically start playing of associated or user selected or automatically selected audio.

In some embodiments play audio in background without showing audio controls.

In some embodiments independently play the video and the selected audio track.

In some embodiments enable to select part of audio.

In some embodiments enable to real-time change audio track.

In some embodiments in the event of pause playing video, pause currently playing audio track.

In some embodiments in the event of restart or play paused video, restart playing of paused audio track.

In some embodiments in the event of stopping of playing video, stop currently playing audio track.

In some embodiments in the event of receiving instruction from user to display next short video or video, automatically start playing of the video and concurrently automatically start playing of associated or selected audio track.

In some embodiments in the event of ending of currently playing video and automatically receiving instruction to display next short video or video, automatically start playing of the video and concurrently automatically start playing of associated or selected audio track.

In some embodiments in the event of advancing playing of video for particular duration, automatically advancing playing of audio track said similar duration of advancement of video.

In some embodiments the audio track is stored on at least one of: a user device; a music server; and an external device.

In some embodiments selecting further comprises: determining an amount of time of the selected audio track to be used.

In some embodiments the created music video has a duration equal to the determined amount of time of the selected audio track.

In some embodiments video comprise video without audio.

In some embodiments before playing selected independent audio file, remove audio within video.

In some embodiments before playing selected independent audio file, mute audio within video.

In some embodiment a method for creating a music video in which a plurality of video takes is synchronized to one or more audio track, the method comprising: selecting plurality of audio track, capturing a plurality of video takes, synchronizing each video take of the plurality of captured video takes with the selected each audio tracks while each video take of the plurality of video takes is being captured, wherein synchronizing further comprises playing, from a first beginning, the selected first audio track at substantially the same time as a second beginning of capturing each video take of the plurality of video takes and synchronizing further comprises playing, from a first beginning, the selected second audio track at substantially the same time as a second beginning of playing completed video. Creating a music video comprising: the selected first audio track, at least a subset of the plurality of video takes comprising at least two video takes of the plurality of video takes synchronized with the selected first audio track, the selected second audio track, a completed video comprising further synchronized with the selected second audio track. Playing music video comprising: selecting or randomly select or selecting based on plurality of factors, triggers, rules from selected audio tracks and playing video and associated selected audio track.

In some embodiments selecting audio track based on audio track selected by user, selected by user based on voice command or providing eye or face expression command based on recognizing pre-defined eye and face movement, randomly select audio track, select suggested audio track, automatically select audio track from rank wise list of pre-selected audio tracks, select audio track based on current location or current location associated identified place or identified pre-defined geofence associated audio track, nearby identified contact associated or pre-set audio track, change audio track after each view video, change of time or time range of day including morning, afternoon, evening, night, date, time, date associated festival or event, schedule, identified current event, profile of user and connected users including age, gender, interest, preferences, languages or preferred language(s), past listened or bookmarked or related to particular singers or artists or movies, liked audio tracks or a music or a songs or a voice by user and connected users of user, current trend specific identified an audio or a music or a song or a voice, home and work location and address, education, income range, skills and triggering of one or more triggers and rules.

In some embodiments providing control with video to select audio track and in the event of selecting audio track and selecting play control, play video and concurrently play associated or integrated or synchronized audio track.

In some embodiments creating further comprises: extracting portions of each take of the plurality of captured video takes to be used for sections of the selected one or more audio tracks, the extracted portions forming the subset of the plurality of video takes.

In some embodiments further comprising: playing the selected first audio track while each video take of the plurality of video takes is captured and playing the selected second audio track while playing completed video to synchronize with selected second audio track.

In some embodiments selecting further comprises: determining an amount of time of the selected one or more audio tracks to be used.

In some embodiments the created music video has a duration equal to the determined amount of time of the selected each audio tracks.

In an embodiments video comprise video without audio.

In an embodiments before playing selected independent audio file, remove audio within video.

In an embodiments before playing selected independent audio file, mute audio within video.

In one embodiment creating a music video in which a plurality of video takes is synchronized to one or more audio track, the method comprising: selecting plurality of audio track; capturing a plurality of video takes; synchronizing each video take of the plurality of captured video takes with the selected each audio tracks while each video take of the plurality of video takes is being captured, wherein synchronizing further comprises playing, from a first beginning, the selected first audio track at substantially the same time as a second beginning of capturing each video take of the plurality of video takes and synchronizing further comprises playing, from a first beginning, the selected second audio track at substantially the same time as a second beginning of playing completed video; creating a music video comprising: the selected first audio track; at least a subset of the plurality of video takes comprising at least two video takes of the plurality of video takes synchronized with the selected first audio track; the selected second audio track; a completed video comprising further synchronized with the selected second audio track; playing music video comprising: selecting or randomly select or selecting based on plurality of factors, triggers, rules from selected audio tracks; and playing video and associated selected audio track.

In some embodiments selecting audio track based on audio track selected by user, selected by user based on voice command or providing eye or face expression command based on recognizing pre-defined eye and face movement, randomly select audio track, select suggested audio track, automatically select audio track from rank wise list of pre-selected audio tracks, select audio track based on current location or current location associated identified place or identified pre-defined geofence associated audio track, nearby identified contact associated or pre-set audio track, change audio track after each view video, change of time or time range of day including morning, afternoon, evening, night, date, time, date associated festival or event, schedule, identified current event, profile of user and connected users including age, gender, interest, preferences, languages or preferred language(s), past listened or bookmarked or related to particular singers or artists or movies, liked audio tracks or a music or a songs or a voice by user and connected users of user, current trend specific identified an audio or a music or a song or a voice, home and work location and address, education, income range, skills and triggering of one or more triggers and rules.

In some embodiments providing control with video to select audio track and in the event of selecting audio track and selecting play control, play video and concurrently play associated or integrated or synchronized audio track.

In some embodiments creating further comprises: extracting portions of each take of the plurality of captured video takes to be used for sections of the selected one or more audio tracks, the extracted portions forming the subset of the plurality of video takes.

In some embodiments playing the selected first audio track while each video take of the plurality of video takes is captured and playing the selected second audio track while playing completed video to synchronize with selected second audio track.

In some embodiments selecting further comprises: determining an amount of time of the selected one or more audio tracks to be used.

In some embodiments the created music video has a duration equal to the determined amount of time of the selected each audio tracks.

In some embodiments the Server comprising: receiving request to display video;

receiving request to select audio file from plurality of audio files or receiving request to select audio file from set of audio files associated with video; downloading or displaying requested video and one or more audio files; enable to select audio track from list of audio tracks; and in the event of receiving instruction to play video, start playing video and concurrently automatically start playing associated default audio or user selected audio or automatically selected audio.

In some embodiments in the event of receiving instruction to pause or stop video, pause playing video and concurrently automatically pause or stop playing associated default audio or user selected audio.

In some embodiments in the event of receiving instruction to restart paused video, start playing video and concurrently automatically start playing associated default audio or user selected audio.

In some embodiments in the event of receiving instruction to play next video, stop currently playing video and concurrently automatically stop playing associated default audio or user selected audio and start playing next video and concurrently automatically start playing associated default audio or user selected audio.

In some embodiments in the event of ending of video and audio, automatically receiving instruction to play next video, downloading or displaying requested next video and one or more audio files and start playing video and concurrently automatically start playing associated default audio or user selected audio.

In some embodiments in the event of receiving instruction to play video from particular selected position, start playing video from particular selected position and concurrently automatically start playing associated default audio or user selected audio from same position as particular selected position of video.

In some embodiments receiving request to select audio file based on audio track selected by user, selected by user based on voice command or providing eye or face expression command based on recognizing pre-defined eye and face movement, randomly select audio track, select suggested audio track, automatically select audio track from rank wise list of pre-selected audio tracks, select audio track based on current location or current location associated identified place or identified pre-defined geofence associated audio track, nearby identified contact associated or pre-set audio track, change audio track after each view video, change of time or time range of day including morning, afternoon, evening, night, date, time, date associated festival or event, schedule, identified current event, profile of user and connected users including age, gender, interest, preferences, languages or preferred language(s), past listened or bookmarked or related to particular singers or artists or movies, liked audio tracks or a music or a songs or a voice by user and connected users of user, current trend specific identified an audio or a music or a song or a voice, home and work location and address, education, income range, skills and triggering of one or more triggers and rules.

In some embodiments two-way voice and video communication within instant messaging or chatting session and user interface, wherein method comprising: initiating or establishing messaging session between the first user and the second user; enabling a first user and a second user to send and receive messages and one or more types of contents from the messaging or sharing user interface; in the event of receiving from the first user, indication of voice and/or video call by the second user, displaying voice and/or video interface to the first user and the second user or displaying indication or notification or incoming call interface to the second user and in the event of acceptance of call, displaying voice and/or video interface to the first user and the second user; initiate voice and/or video communication session between the first user and the second user and enabling the first user and the second user to start voice and/or video communication with each other; in the event of receiving call ending indication from the first user and the second user, ending call, end voice and/or video communication session, closing or hiding voice and/or video communication user interface and store recorded voice and/or video communication between the first user and the second user; displaying recorded voice and/or video communication between the first user and the second user in messaging or shared contents interface or messages threads of the first user and the second user; and in the event of selection of recorded voice and/or video communication, playing recorded voice and/or video communication. In various embodiments in the event of making or initiating call by the caller, automatically start one or two way voice or video communication and enabling callee or user(s) to speak, pause, end call and listen recorded voice or video call conversation and based on settings or selection of option(s), enabling callee to listen, view video, listen or view recorded, speak, mute or unmute microphone or voice, pause, restart, reject, miss, block and end call or read or view voice to text messages or transcript based on voice to text technology.

In some embodiments in the event of making call, display incoming call interface or message within messaging session with accept call, reject call control including button or link or provide voice notification or notification or play pre-set ringtone or voice or audio or conduct pre-set type of vibration or any combination thereof.

In some embodiments enabling the second user to reject call; in the event of rejecting call notifying the first user about rejected call and continue communication via messaging within current message session.

In some embodiments enabling the second user to miss call, wherein in the event of non-acceptance of call within pre-set duration, notifying the first user about mis call and continue communication via messaging within current message session. In an embodiment enabling user to play recorded voice and video call or view or read text transcript of recorded voice call or voice of recorded video call or displaying text transcript while playing recorded video of video call. In an embodiment enabling user to select ephemeral voice or video call option; in the event of ending of voice or video call, does not record or show recorded voice or video call within messaging thread of current messaging session within messaging interface. In an embodiment after making and accepting voice or video call during messaging session within messaging interface, during voice or video call, enabling users to pause or hold or re-start voice or video call or turn off or turn on voice or video of current voice or video call within messaging interface, wherein record and display voice or video of voice or video call between start and pause or re-start and pause voice or video call.

In some embodiments two-way voice and video communication within 3rd parties independent instant messaging or chatting session and user interface or application, wherein method comprising: receiving from a first user, selection of a second user; generating uniform resource locator (URL) or short link based on information associated with the second user; initiating or establishing messaging session between the first user and the second user; enabling a first user and a second user to send and receive messages and one or more types of contents from the messaging or sharing user interface; enabling a first user to send or share uniform resource locator (URL) or short link associated with the second user to the second user; in the event of selection of received uniform resource locator (URL) or short link associated with the second user by the second user, displaying voice and/or video interface to the first user and the second user or displaying indication or notification or incoming call interface to the second user and in the event of acceptance of call, displaying voice and/or video interface to the first user and the second user; initiate voice and/or video communication session between the first user and the second user and enabling the first user and the second user to start voice and/or video communication with each other; in the event of receiving call ending indication from the first user and the second user, ending call, end voice and/or video communication session, closing or hiding voice and/or video communication user interface and store recorded voice and/or video communication between the first user and the second user; enabling to, the first user and the second user, to share or automatically share recorded voice and/or video communication with the first user and the second user; displaying recorded voice and/or video communication between the first user and the second user in messaging or shared contents interface or messages threads in the 3rd parties instant messenger or chat application of the first user and the second user; and in the event of selection of recorded voice and/or video communication, playing recorded voice and/or video communication.

In some embodiments the graphical user interface for displaying advertised videos comprising: displaying and start playing the first video of the first advertiser as per associated first date and time pre-set by the first advertiser; in the event of ending of the first video, start playing the second video of the second advertiser as per associated second date and time pre-set by the second advertiser.

In some embodiments the graphical user interface for displaying advertised videos comprising: displaying and start playing the first video of the first advertiser as per associated sequence number pre-set by the first advertiser; in the event of ending of the first video, start playing the second video of the second advertiser as per associated sequence number pre-set by the second advertiser.

In some embodiments the self-service graphical user interface comprising: receiving schedule or date & time, short video and action(s); and displaying short video and associated action(s) as per scheduled date & time.

In some embodiments self-service and self-serve video advertising comprising: enabling a first advertiser to associating a first date and time with a first video; enabling a second advertiser to associating second date and time with a second video; displaying and start playing the first video of the first advertiser as per associated first date and time; in the event of ending of the first video, start playing the second video of the second advertiser as per associated second date and time.

In some embodiments displaying and start playing the first video of the first advertiser in a feed as per associated first date and time; in the event of ending of the first video, start playing the second video of the second advertiser in the feed as per associated second date and time.

In some embodiments enable advertiser to make payment.

In some embodiments enable advertiser to associate one or more actions with video.

In some embodiments enable advertiser to set number of viewers as target criteria.

In some embodiments displaying and start playing the first video of a first advertiser in a first feed as per associated first date and time; in the event of ending of the first video, start playing the second video of a second advertiser in the first feed as per associated second date and time; displaying and start playing a third video of a third advertiser in a second feed as per associated third date and time; in the event of ending of the third video, start playing a fourth video of a fourth advertiser in the second feed as per associated fourth date and time.

In some embodiments the graphical user interface comprising: displaying and start playing the first video or first set of videos of first advertiser in a feed; in the event of ending of the first video or first set of videos of first advertiser, start playing the second video or second set of video of second advertiser in the feed.

In some embodiments selecting next video comprises select randomly or select randomly from set of videos, select not viewed video, select based on manually or automatically provided time slot or date and time, automatically select based on location, place, language, device type, subscription, preferences, profile data, current or logged activities data including one or more types of activities of viewing user.

In some embodiments the graphical user interface comprising: displaying and start playing the first video or first set of video of first advertiser in a first available time slot; in the event of ending of the first video, start playing the second video or second set of video of second advertiser in a second available time slot.

In some embodiments associating date and time or scheduled date and time with content; and displaying content (in feed) based on/as per associated date and time or scheduled date and time.

In some embodiments associating date and time with one or more types of one or more content items including short video or video, post, story, photo, microblog or message.

In some embodiments monitor tracks viewing of content and identify and store identity of associated viewers for statistics, data analytics.

In some embodiments associating date and time or scheduled date and time with content; and displaying content in one or more types of feeds or user interfaces or category(ies) or groups or tags or keyword(s) based on/as per associated date and time or scheduled date and time.

In some embodiments the graphical user interface comprising: displaying and start playing the first video in a feed of first preset number of viewing users; in the event of identifying exceeding first preset number of viewing users for first video, displaying and start playing a second video in a feed of second preset number of viewing users or currently available or remaining viewing users, wherein identifying pending number of viewers for the second video and displaying and start playing a second video in a feed of pending number of viewing users in a next set of available viewing users.

In some embodiments identifying viewing users based on opening of application.

In some embodiments identifying viewing users based on target criteria.

In some embodiments monitoring, tracking and identifying first set of currently active viewing users; automatically displaying and automatically playing next video based on target criteria among first set of currently active viewing users; monitoring and tracking actions and reactions on video including number of viewers or views and numbers of one or more types of actions and reactions by first set of viewing users; calculating number of viewing users or views; determining pending number of views as per target criteria; in the event of identifying of pending number of views, monitoring, tracking and identifying second set of currently active viewing users; automatically displaying and automatically playing next video based on target criteria among second set of currently active viewing users; monitoring and tracking actions and reactions on video including number of viewers or views and numbers of one or more types of actions and reactions by second set of viewing users.

In some embodiments in the event of non-identifying target criteria specific viewing users within pre-set duration deactivate or remove or hide video.

In some embodiments charging based on pay per views, pay per action or type of action.

In some embodiments identifying currently active viewing users based on identifying opening of application.

In some embodiments identifying currently active viewing users based on detecting current viewers

In some embodiments a server, comprising: a processor; and a memory storing instructions executed by the processor to: access videos and associated date; identify videos related to a current date; display the current date associated videos in a feed, wherein automated sequential display of the videos based on plurality of factors including first uploaded first display basis, associated rank, unseen, last paused, matched target criteria including country, age range, gender and any combination thereof; and in the event of identification of change of date or pre-set duration, identify, retrieve, send, load and sequentially display changed date or current date associated videos or next pre-defined or identified set of videos.

In some embodiments a server, comprising: a processor; and a memory storing instructions executed by the processor to: store videos and associated date, wherein videos posted by advertisers or publishers; access videos and associated date; identify videos related to a current date; and display the current date associated videos in a feed.

In some embodiments a server, comprising: a processor; and a memory storing instructions executed by the processor to: maintain a date specific gallery comprising a plurality of ephemeral messages posted by a plurality of advertisers for viewing by viewing users, wherein each of the ephemeral messages comprises a photograph or a video, the maintaining of the date specific gallery comprising making the date specific gallery available for viewing, upon request, via respective user devices associated with the viewing users; for each of the plurality of ephemeral messages, maintain an associated message duration parameter that indicates a display duration for the corresponding ephemeral message during viewing of the date specific gallery, and maintain a gallery participation parameter that indicates a time value including twenty four hours for continued availability of the corresponding ephemeral message in the date specific gallery or date specific gallery has a gallery timer that establishes a lifespan of the date specific gallery; responsive to receiving an date specific gallery view request from one of the viewing users, cause automated sequential display of the plurality of ephemeral messages on a corresponding user device by performance of operations comprising: starting a message timer when viewing of one of the plurality of the ephemeral messages is commenced, determining that the message timer expires when the message timer equals the corresponding display duration, responsive to expiry of the message timer, deleting the ephemeral messages and displaying a next one of the plurality of ephemeral messages in the date specific gallery, and repeating the starting, determining, deleting and displaying operations until all ephemeral messages in the date specific gallery are viewed; remove or hide the ephemeral messages from the date specific gallery in response to the identification of an expired gallery participation parameter including expiration of twenty four hours corresponding to the ephemeral messages, the ephemeral messages after removal or hide thereof being unavailable for viewer viewing as part of the date specific gallery; and eliminate the date specific gallery so that the date specific gallery is unavailable for viewing responsive to any request from viewing user, the date specific gallery being eliminated upon expiration of a date specific gallery timer.

In some embodiments display messages in single feed.

In some embodiments display messages in categories feeds including country, state, city, area, pin code.

In some embodiments identify viewing user's related country, state, city, area, pin code based on current location or home address or office address.

In some embodiments display messages in categories feeds based on message associated target criteria including selected country, state, city, area, pin code.

In some embodiments responsive to receiving an date specific gallery view request from one of the viewing users, identifying target criteria specific ephemeral messages.

In some embodiments target criteria comprises selected one or more countries, age range, gender, language, type of devices including android and iOS operating system devices, customers, selected one or more types of interests, selected one or more types of feed or category or location including selected one or more countries, states, cities, and areas, scheduled date or date and time, number of viewers and any combination thereof.

In some embodiments the memory storing instruction executed by the processor includes instructions to: receive from the advertiser or publisher a newly posted ephemeral message; store the newly posted ephemeral message and an associated time slot(s).

In some embodiments the memory storing instruction executed by the processor includes instructions to: receive from the advertiser or publisher a newly posted ephemeral message; store the newly posted ephemeral message and an associated one or more selected countries, states, cities, areas and pin codes.

In some embodiments display message as per message associated time slot(s).

In some embodiments enable user to pause and restart video or short video.

In some embodiments an ephemeral message controller with instructions executed by a processor to: present on the display a first ephemeral message of the set of ephemeral messages for a first transitory period of time defined by a timer, wherein the first ephemeral message is deleted when the first transitory period of time expires; receive from a touch controller a haptic contact signal indicative of a gesture applied to the display or particular region of display or control during the first transitory period of time; wherein the ephemeral message controller deletes the first ephemeral message in response to the haptic contact signal and proceeds to present on the display a second ephemeral message of the set of ephemeral messages for a second transitory period of time defined by the timer, wherein the ephemeral message controller deletes the second ephemeral message upon the expiration of the second transitory period of time; wherein the second ephemeral message is deleted when the touch controller receives another haptic contact signal indicative of another gesture applied to the display or particular region of display or control during the second transitory period of time; and wherein the ephemeral message controller initiates the timer upon the display of the first ephemeral message and the display of the second ephemeral message.

In some embodiments the memory storing instruction executed by the processor includes instructions to: receive from the advertiser or publisher a newly posted ephemeral message; store the newly posted ephemeral message and an associated message duration parameter, and associate the ephemeral message with the date specific ephemeral gallery.

In some embodiments the associated message duration parameter is a default parameter.

In some embodiments the associated message duration parameter is based on length of video duration.

In some embodiments the associated message duration parameter is set by the user.

In some embodiments monitor, track and store number of viewers or views and call-to-actions including user actions and reactions and determine charges based on number of viewers or views and call-to-actions.

In some embodiments video comprises one or more countries or languages specific videos, wherein display video based on viewing user's selected or pre-set language.

In some embodiments video comprises one or more countries or languages specific audio associated with video, wherein play audio associated with video based on viewing user's selected or pre-set language.

In some embodiments video comprises one or more countries or languages specific sub-title associated with video, wherein display sub-title associated with video based on viewing user's selected or pre-set language.

In some embodiments video comprises one or more music associated with video, wherein play music associated with video based on default music or viewing user selected music.

In some embodiments n the memory storing instruction executed by the processor includes instructions to: receive from the advertiser or publisher a newly posted ephemeral message; store the newly posted ephemeral message and an associated one or more actions.

In some embodiments enable user to save currently viewing message including short video associated actions with details and enable to view details and conduct associated actions within pre-set duration.

In some embodiments the memory storing instruction executed by the processor includes instructions to: receive from the advertiser or publisher a newly posted ephemeral message; store the newly posted ephemeral message and an associated details including advertiser identity, brand name, brand category and sub-category, product name, product category, service name, service category, contact information, website, address, type including global, national, state or city level, type of industry, budget including daily or weekly or monthly or yearly budget, selected advertisement charges model including default or pay per views or pay per views and/or actions, goals or objectives of adverting or publishing including Brand Building, Increase traffic to brand's website, Increase Followers, Increase Downloads and Sign-up, Increase Product Sales, Increase Custom Call-to-Actions, Produce Video, message including video associated metadata including language(s), size, portrait or landscape video, author, duration or length of video, verification status or certification, date and time of upload, resolution, tags, hashtags, keywords, categories, subcategories related to message including video, automatically identified object keywords and text inside video based on recognized series images of video associated objects and optical character recognition (OCR), automatically identified keywords based on voice recognition and voice to text techniques, advertisement campaign and group name, category, details, and administrators details.

In some embodiments maintain a date specific ephemeral gallery comprising a plurality of ephemeral messages posted by a plurality of advertisers for viewing by viewing users, wherein each of the ephemeral messages comprises a photograph or a video, the maintaining of the date specific ephemeral gallery comprising making the date specific ephemeral gallery available for viewing, upon request, via respective user devices associated with the viewing users; for each of the plurality of ephemeral messages, maintain an associated message duration parameter that indicates a display duration for the corresponding ephemeral message during viewing of the date specific ephemeral gallery, and maintain a date specific gallery participation parameter that indicates a time value including twenty four hours for continued availability of the corresponding ephemeral message in the date specific ephemeral gallery or date specific gallery has a gallery timer that establishes a lifespan of the date specific gallery; responsive to receiving a date specific ephemeral gallery view request from one of the one or more viewers, cause automated sequential display of the plurality of ephemeral messages on a corresponding user device by performance of operations comprising: starting a message timer when viewing of one of the plurality of the ephemeral messages is commenced, determining that the message timer expires when the message timer equals the corresponding display duration, responsive to expiry of the message timer, displaying a next one of the plurality of ephemeral messages in the date specific ephemeral gallery, and repeating the starting, determining, and displaying operations until all ephemeral messages in the date specific ephemeral gallery are viewed; remove or hide the ephemeral messages from the date specific gallery in response to the identification of an expired gallery participation parameter including expiration of twenty four hours corresponding to the ephemeral messages, the ephemeral messages after removal thereof being unavailable for viewer viewing as part of the date specific gallery; and eliminate the date specific gallery so that the date specific gallery is unavailable for viewing responsive to any request from viewing user, the date specific gallery being eliminated upon expiration of a date specific gallery timer.

In some embodiments display messages in single feed.

In some embodiments display messages in categories feeds including country, state, city, area, pin code.

In some embodiments identify viewing user's related country, state, city, area, pin code based on current location or home address or office address.

In some embodiments display messages in categories feeds based on message associated target criteria including selected country, state, city, area, pin code.

In some embodiments responsive to receiving an date specific gallery view request from one of the viewing users, identifying target criteria specific ephemeral messages.

In some embodiments the memory storing instruction executed by the processor includes instructions to: receive from the advertiser or publisher a newly posted ephemeral message; store the newly posted ephemeral message and an associated one or more selected countries, states, cities, areas and pin codes.

In some embodiments target criteria comprises selected one or more countries, age range, gender, language, type of devices including android and iOS operating system devices, customers, selected one or more types of interests, selected one or more types of feed or category or location including selected one or more countries, states, cities, and areas, scheduled date or date and time, number of viewers and any combination thereof.

In some embodiments enable user to pause and restart video or short video.

In some embodiments enable user to view previous message including video or short video.

In some embodiments enable user to view next message including video or short video.

In some embodiments monitor, track and store number of viewers or views and call-to-actions including user actions and reactions and determine charges based on number of viewers or views and call-to-actions.

In some embodiments wherein video comprises one or more countries or languages specific videos, wherein display video based on viewing user's selected or pre-set language.

In some embodiments video comprises one or more countries or languages specific audio associated with video, wherein play audio associated with video based on viewing user's selected or pre-set language.

In some embodiments video comprises one or more countries or languages specific sub-title associated with video, wherein display sub-title associated with video based on viewing user's selected or pre-set language.

In some embodiments video comprises one or more music associated with video, wherein play music associated with video based on default music or viewing user selected music.

In some embodiments the memory storing instruction executed by the processor includes instructions to: receive from the advertiser or publisher a newly posted ephemeral message; store the newly posted ephemeral message and an associated one or more actions.

In some embodiments enable user to save currently viewing message including short video associated actions with details and enable to view details and conduct associated actions within pre-set duration.

In some embodiments receive from the advertiser or publisher a newly posted ephemeral message; store the newly posted ephemeral message and an associated details including advertiser identity, brand name, brand category and sub-category, product name, product category, service name, service category, contact information, website, address, type including global, national, state or city level, type of industry, budget including daily or weekly or monthly or yearly budget, selected advertisement charges model including default or pay per views or pay per views and/or actions, goals or objectives of adverting or publishing including Brand Building, Increase traffic to brand's website, Increase Followers, Increase Downloads and Sign-up, Increase Product Sales, Increase Custom Call-to-Actions, Produce Video, message including video associated metadata including language(s), video file size, dimensions, file type, portrait or landscape video, author, duration or length of video, verification status or certification, date and time of upload, resolution, video code, tags, hashtags, keywords, categories, subcategories related to message including video, automatically identified object keywords and text inside video based on recognized series images of video associated objects and optical character recognition (OCR), automatically identified keywords based on voice recognition and voice to text techniques, advertisement campaign and group name, category, details, and administrators details.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic. One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines. Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system). Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program. The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a network diagram depicting a network system having a client-server architecture configured for enabling content producers to register, submit or prepare as per requirement produced contents or submit produced contents to platform for moderation or publication or for directly publication for viewing users of network and then enable advertiser to claim and own based on revenue sharing model(s), enabling viewing users to register, view contents in feed, take one or more actions and enable advertisers to register, publish requirement specification, search influencers and content producers to prepare and endorse contents, add or attach or link call-to-actions and reactions controls with content of users of network and publish based on target criteria, claim and own already published contents having engagements and reach and advertise said contents based on target criteria and make advertisement payment based on one or more charges models including pay per view, pay per action, platform can share revenue with content producers and influencers based on revenue sharing models and agreements. Developer of actions or call-to-actions can register with the platform and upload, verify and list or publish actions or call-to-actions for advertisers, influencer and viewing users of network.

FIG. 2 an illustrative block diagram of a user device in accordance with various embodiments;

FIGS. 3-4 illustrates registration and verification of content creators or creator user. Creator user can manually provide or update or automatically update via connected or linked system their engagements and reach of posted contents on external domains, social networks, applications and websites related data.

FIG. 5 illustrates graphical user interface (GUI) for enabling creator user or content creator or influencer to prepare one or more types of contents including post or short video related to selected brand or product or service or company or shop or one or more types of entities and submit to advertiser for review, acceptance, revision, moderation, verification and advertiser can submit said finalized content to platform for publication for viewing users of network or creator suer can submit said content directly to platform and after sufficient number of engagements and reach communicate with said brand owner or admin to claim and own said content based on charges models and revenue sharing models.

FIG. 6 illustrates graphical user interface (GUI) for enabling advertiser user to search influencers and contents as per search query, criteria and submit request to selected content creator users or influencers to produce contents as per requirement and get paid based on monitored and tracked engagements and reach and revenue sharing models and agreements.

FIG. 7 illustrates graphical user interface (GUI) for enabling advertiser to prepare requirement specification and send request to selected content creator users or publish requirements which creators can search and approach advertiser to produce contents.

FIGS. 8-9 illustrates graphical user interface (GUI) for enabling advertiser to create and manage campaign(s), set budget, target criteria, advertisement model, add or associate or attach or integrate or link one or more actions and publish or advertise contents, monito and tracks engagements and reach and update campaign accordingly.

FIG. 10 illustrates graphical user interface (GUI) for enabling advertiser to create campaign wherein advertiser can select influencers as per set criteria on selected external domains, social networks, websites and applications, provide schedule, budget and select advertising charges model and publish or advertise or endorse contents via external domains' influencers.

FIG. 11 illustrates graphical user interface (GUI) for enabling advertiser or influencer or users of network to search published and stored contents of users of network based on criteria and select content items and select and associate one or more actions. Advertiser can publish or advertise said contents and associated actions to enable viewing users of network to select and take actions.

FIGS. 12-14 illustrates graphical user interface (GUI) or feed interface wherein viewing user can view displayed contents and associated actions and can select and take one or more actions from currently viewing particular content item. User can select surprise button to get surprise, surprise offers, best deals, priorities, free things, contents, digital or virtual goods.

FIG. 15 is illustrative diagrams of user interfaces displayed on a user device for selecting an audio track, presenting a selected audio track, capturing and displaying video takes for a music video to be created, created music video including a plurality of captured video takes synchronized to selected audio track in accordance with various embodiments;

FIG. 16 is an illustrative flowchart of a process for creating and playing music videos in accordance with various embodiments;

FIG. 17 is an illustrative diagram describing various embodiments of packaging, selecting and playing audio for particular video;

FIG. 18 illustrates graphical user interface wherein user can draft or prepare microblog post and apply various types of settings by using various options and settings;

FIGS. 19-25 illustrates various graphical user interface for viewing displayed microblog posts or viewing selected category specific posts and accessing associated default actions and each post associated custom actions;

FIGS. 26-30 illustrates graphical user interface for enabling publisher to publish or broadcast content including short video based on pre-set schedule or date and time and enabling viewing users of network to view said published or broadcast post from server or from server set by publisher as per associated date and time set by publisher;

FIG. 31 illustrates graphical user interface for enabling user to share selected contact specific generated custom link with said contact and enabling contact user to select or open link to communicate with user via link associated user interface;

FIG. 32 illustrates graphical user interface for enabling user to selected contact and share voice/video communication control or interface with selected contact in the form of message via messenger or sharing or chat interface for enabling receiving user or contact to make call or attend call and after ending of call accessing recorded call or text script of recorded call in-between messages and continue send and receive messages or further share call interface or make call with one or more selected contacts;

FIG. 33 illustrates graphical user interface for enabling user to make call via call control from website with website or call control associated admin or available user or agent or in another embodiment enabling any user to make call with any other user based on one or more types of unique identity;

FIG. 34 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

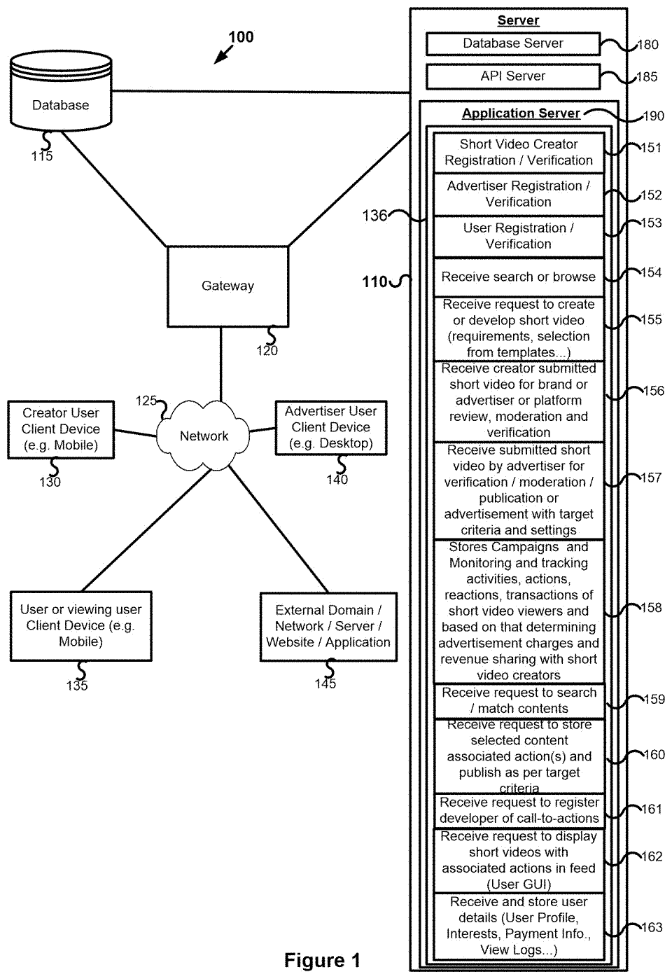

FIG. 1 illustrates an example user application store platform, network and system, under an embodiment. According to some embodiments, system 100 can be implemented through software that operates on a portable computing device, such as a mobile computing device. System 100 can be configured to communicate with one or more network services, databases, objects that coordinate, orchestrate or otherwise provide search results, produced or submitted contents, published contents and associated actions and reaction controls, monitoring activities and actions and generating and presenting feed. Additionally, the mobile computing device can integrate third-party services which enable further functionality through system 100.

The system for producing and publishing/advertising contents with associated custom actions based on revenue sharing model(s) for enabling creators to produce contents and get paid based on shared revenue by platform from monitored and tracked associated engagements (likes, comments, share, one or more types of conducted actions) and reach (views, followers), advertiser can produce or claim contents and make payment to platform based on monitored and tracked associated engagements (likes, comments, share, one or more types of conducted actions) and reach (views, followers), user can view contents and take one or more associated actions. While FIG. 1 illustrates a gateway 120, a database 115 and a server 110 as separate entities, the illustration is provided for example purposes only and is not meant to limit the configuration of the producing and publishing/advertising contents with associated custom actions based on revenue sharing model(s) system. In some embodiments, gateway 120, database 115 and server 110 may be implemented in the producing and publishing/advertising contents with associated custom actions based on revenue sharing model(s) system, a single system, or any combination of systems.

As illustrated in FIG. 1, the producing and publishing/advertising contents with associated custom actions based on revenue sharing model(s) system may include a creator user application associated user device or mobile devices 130, advertiser user application associated user device or mobile devices 140 and user or viewing user associated user device or mobile devices 135. Devices or Mobile devices 130/135/140 may be particular set number of or an arbitrary number of devices or mobile devices which may be capable of registering, searching, viewing, posting, sharing, publishing, broadcasting, advertising, sending, matching, accessing and managing contents, associated actions, monitored and tracked engagements and reach, search results. Each device or mobile device in the set of user application user's 130/135/140 and user of said user's user application's device or mobile devices 130/140 may be configured to communicate, via a wireless connection, with each one of the other mobile devices or devices 130/140/135/145. Each one of the mobile devices or devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the producing and publishing/advertising contents with associated custom actions based on revenue sharing model(s) system may include gateway 120. Gateway 120 may be a web gateway which may be configured to communicate with other entities of the platform and network and managing the producing and publishing/advertising contents with associated custom actions based on revenue sharing model(s) system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of the producing and publishing/advertising contents with associated custom actions based on revenue sharing model(s) system. In various embodiments, gateway 120 may be connected to database 115 and/or server 110 via a wired or a wireless network connection.

Gateway 120 may be configured to receive search queries, send search results, receive, store, index and publish posted contents with actions, monitor and track engagements and reach with published contents to/from mobile devices 130/140/135/145. Gateway 120 may be configured to send and receive one or more types of user data comprises registration information and profile of creator users, advertiser users and users or viewing users of network, submitted or published contents, users' logged data including actions and reactions on contents, logged activities, actions, events, senses, transactions, task and workflow and campaign status, updates, presence information, locations, check-in places and like related to creators, users and advertisers to/from mobile devices 130/140/135/145. For example, gateway 120 may be configured to receive registration, verification, submitted or published or advertised or updated contents e.g. short video or posts, search queries and receive information or logged data about monitored or tracked activities, actions, status, events, reactions and transactions of viewing user from client devices 130/135/140, receive contents submitted or published or posted and updated by creators, advertisers and users associated with user application from client devices 130/135/140 to database 115 for storage.

As another example, gateway 120 may be configured to serve contextual content items in feed, display search query specific contents, profiles of creators, users and advertisers, monitor and track actions and reactions and display associated actions and reactions controls or GUIs to viewing user of content in feed stored in database 115 to mobile devices 130/135/140. Gateway 120 may be configured to receive request to display search query or contextual or suggested or selected category or hashtag or keywords specific contents or receive search requests from mobile devices 130/135/140 for searching and presenting contents, profiles, actions.

For example, gateway 120 may receive a request from a mobile device and may query database or index database or storage medium 115 with the request for searching and matching request specific or search query specific matched search results including contents, requirements specifications and profiles. Gateway 120 may be configured to inform server 110 of updated data. For example, gateway 120 may be configured to notify server 110 when a new or updated content, requirement specifications, profiles, logged activities, actions, events, transactions, status, reactions has been received from a mobile device stored on database 115.

As illustrated in FIG. 1, the producing and publishing/advertising contents with associated custom actions based on revenue sharing model(s) system may include a database, such as database 115. Database 115 may be connected to gateway 120 and server 110 via wired and/or wireless connections. Database 115 may be configured to store a database of registered user's profile, accounts, produced, submitted, published or posted or shared contents, call-to-actions, user actions and reaction controls, user data including logged activities, actions, events, transactions, reactions, status, communication, sharing, updates, behaviors, searching activities and payments information received from mobile devices 130/140/135 via network 125 and gateway 120.

As illustrated in FIG. 1, the user application store, platform and network and managing user application system may include a server, such as server 110. Server may be connected to database 115 and gateway 120 via wired and/or wireless connections. As described above, server 110 may be notified, by gateway 120, of new or updated contents, profiles, requirement specifications, logged data stored in database 115.

FIG. 1 illustrates a block diagram of the producing and publishing/advertising contents with associated custom actions based on revenue sharing model(s) system configured to implement the platform where user(s) can register, upload or submit developed, created, generated contents, search or view suggested contextual contents including posts, photos, video, short videos, message, story, profiles, call-to-actions and requirements and actions and reactions controls or GUIs to searching user or creator user or advertiser. In some embodiments, gateway 120, database 115 and server 110 may be implemented in the user application store, platform and network and managing user application system, a single system, or any combination of systems.

The server 110 stores database server 180, API server 185 and application server 190 which stores submitted or published contents, registration details, profiles, accounts, coamings, call-to-actions, and requirements, synchronize user related data from/to connected or linked external networks to implement operations of various embodiments of the invention and may include executable instructions to access a client device which coordinates operations disclosed herein. Alternately, may include executable instructions to coordinate some of the operations disclosed herein, while the client device implements other operations.

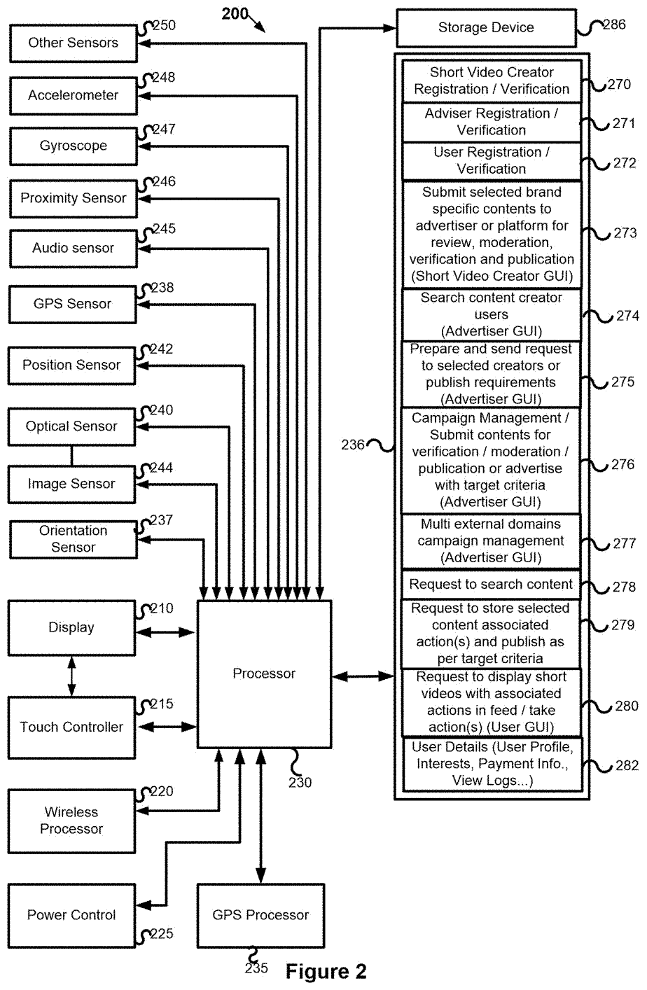

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random-access memory. The memory 236 stores creator application, advertiser application and user application (Smart Client or Web based) to implement operations of one of the embodiments of the invention. The creator application, advertiser application and user application (Smart Client or Web based) 236 may include executable instructions to access a client device and/or a server which coordinates operations disclosed herein. Alternately, the creator application, advertiser application and user application (Smart Client or Web based) 236 may include executable instructions to coordinate some of the operations disclosed herein, while the server implements other operations.

The processor 230 is also coupled to image sensors 238. The image sensors 238 may be known digital image sensors, such as charge coupled devices. The image sensors capture visual media, which is presented on display 210. The image sensors 238 capture visual media and present the visual media on the display 210 so that a user can observe the captured visual media.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized. While many of the components of FIG. 2 are known in the art, new functionality is achieved through the creator application (register, verify creator, submit contents for moderation and publication to advertiser and platform, search requirements and advertisers, monitor and track produced and published contents associated engagements and reach and get payments based on revenue sharing models and agreements, advertiser application (register, verify advertisers, prepare and submit requirement specification, review, moderate, request revision, verify contents, submit contents for publication, create and manage campaigns, attach call-to a-actions, monitor and track published contents associated engagements and reach and make payment based on advertisement models and agreements, user application (register and verify user, search and view contents, select and view contents, view displayed contents, take one or more types of actions from displayed content item) operating in conjunction with a server.

FIG. 2 shows a block diagram illustrating one example embodiment of a mobile device 200. The mobile device 200 includes an optical sensor 244 or image sensor 238, a Global Positioning System (GPS) sensor 235, a position sensor 242, a processor 230, a storage 236, and a display 210.

The optical sensor 244 includes an image sensor 238, such as, a charge-coupled device. The optical sensor 244 captures visual media. The optical sensor 244 can be used to media items such as pictures and videos.

The GPS sensor 238 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 244 of the mobile device is pointed and an orientation sensor 237 to determine the orientation of the mobile device (e.g., horizontal, vertical etc.).

The processor 230 may be a central processing unit that includes a media capture application 270.

The media capture application 270 includes executable instructions to generate media items such as pictures and videos using the optical sensor 240 or image sensor 244. The media capture application 270 also associates a media item with the geolocation and the position of the mobile device 200 at the time the media item is generated using the GPS sensor 238 and the position sensor 242.

The storage 236 includes a memory that may be or include flash memory, random access memory, any other type of memory accessible by the processor 230, or any suitable combination thereof. The storage 236 stores the applications, contents, user related data, profile, search results, bookmarks, campaigns, call-to-actions, requirements, logged data. The storage 236 also stores executable instructions corresponding to the registration and profile, content request preparation and submission, requirements preparation and submission, campaign management application, Search Application, Feed Application, Communication Application, Web Browser/Mobile Browser, Map Application and Push Notification.

The display 210 includes, for example, a touch screen display. The display 210 displays the search query specific, requested, selected category or keyword or hashtag related contents including short videos, videos, posts, photos, blogs and like or displays the auto matched or suggested contents and call-to-actions or media items produced by creator or generated by the media capture application 270. A user captures, records and selects media items for drafting and posting one or more types of contents or adding to one or more types of posts or feeds, stories or galleries by touching the corresponding media items on the display 210. A touch controller monitors signals applied to the display 210 to coordinate the capturing, recording, and selection of the media items.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

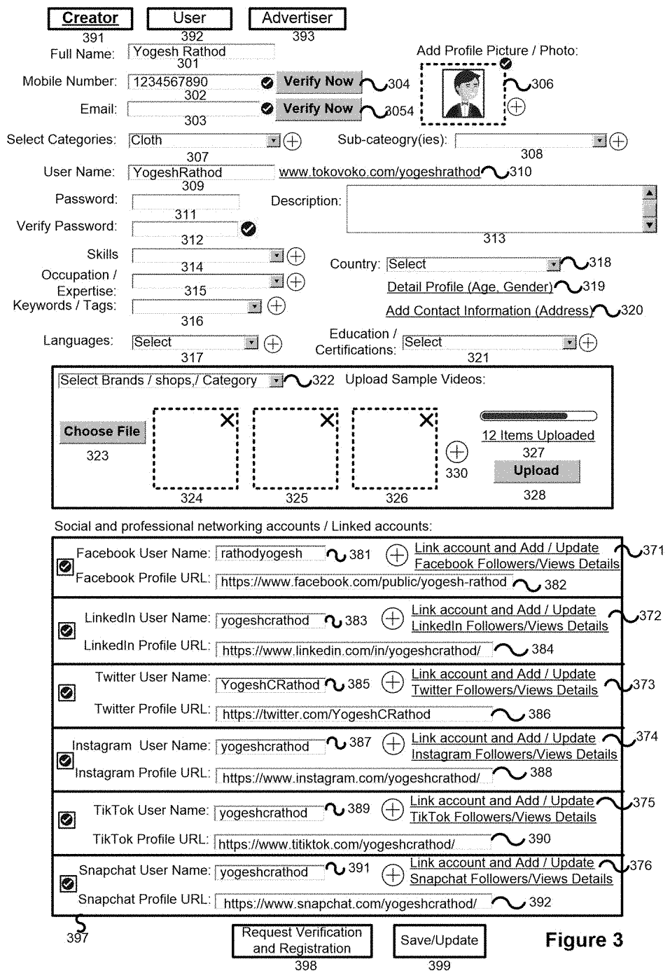

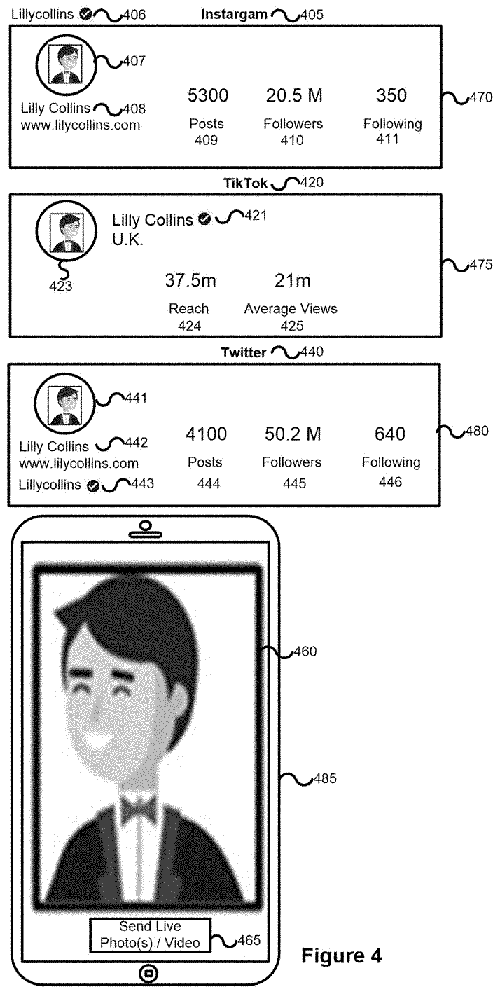

FIGS. 3-4 illustrates exemplary graphical user interface for enabling creator of one or more types of contents or influencer to register with the platform 100. Creator can send request to register and verify from creator application 236 (270) of client device 200 (130) to server 110 module 151 with details including name 301, mobile number 302, email address 303, add or update profile picture(s)/photo(s) or profile picture(s)/photo(s) 306 on one or more external linked social networks 398, having face and body parts related selected one or more categories 307 or types, sub-categories 308, keywords & tags 316, user name 309, password 311/312, one or more types of selected skills 314, occupation & expertise 315, country 318, home and work address 320, audience country, detail profile including age, gender, interests, language 319, contact information 320, selected main language(s) of content 317, education & certificates 321, one or more types of ratings and badges, details of one or more accounts of external domains, websites, social networks, and applications 398 including Facebook, LinkedIn, Snapchat, Twitter, Instagram and TikTok for linking or connecting or adding accounts, wherein details comprises user name 381/383/385/387/389/391 and profile link or uniform resource locator (URL) 382/384/386/388/390/392 of respective social networks or applications. In another embodiment creator user can add or update additional details of each said external domains, websites, social networks, and applications, wherein additional details comprises number of posts, number of views, average number of views for posts, number of followers, number of aggregate or average different types of reactions including number of likes, shares, replies, emoticons, comments and one or more types of call-to-actions on posted contents 371/372/373/374/375/376. In another embodiment creator user can select files 323 or import or drag and drop files and upload 327/328 one or more sample contents 324/325/326 including short videos, videos, photos, posts, stories or ephemeral stories, micro blogs or messages. In another embodiment creator user can select one or more categories, subcategories, keywords, tags, name of brands, products, services, companies, firms, schools, colleges, shops, and place of business 322 and can select files 323 or import or drag and drop files and upload 327/328 one or more sample contents 324/325/326 including short videos, videos, photos, posts, stories or ephemeral stories, micro blogs or messages. In another embodiment instructing creator user to add or update creator user's or influencer's or creator's photo(s) (showing clear face and body parts or as per rules) on profile of said added and linked external domains or websites or applications or social networks and verifying creator user via receiving 465 from creator or influencer live photo or video 460 of creator or influencer and matching said live phot(s) or image(s) of video of creator or influencer (depicting creator user's face or body or as per pre-defined rules) with uploaded or added or updated photo(s) (depicting user's face or body or as per pre-defined rules) 306 and one or more profile photos 407/423/441 on respective external domains 470/475/480 identified or extracted manually or via provided profile link(s) 382/384/386/388/390/392 of respective external domains 397. So, creator user's profile photo 306 on current platform 100 is similar to live photo 460 as well as profile photo(s) 407/423/441 on one or more external domains at the time or registration to verify that creator user's external domains' accounts are related to creator user. In an embodiment verification of creator user's mobile device 130 is happen via sending one-time password (OTP) on creator user provided mobile number and in the event of entering or automatically detecting incoming one-time password (OTP) verifying creator user and creator user's mobile device 130. Creator user's email address is verifying via sending email and in the event of clicking or tapping from email verifying creator user or send email with one-time password which creator user need to input for verification. In an embodiment after providing details creator user can save or update details 399 or creator user can send request to verify and register creator user 398 with the platform 100.

FIG. 4 illustrates exemplary details of creator user's external domain's accounts including Instagram 470, TikTok 475 and Twitter 480, wherein details comprise creator user's profile photo 407/423/441, user name and user unique identity or handle 408/421/442, location, description, one or more links or uniform resource locators (URLs) number of posts, followers, viewers, views, users, engagements, reactions 409/410/411/424/425/44/445/446.

In another embodiment user or general user or viewing user or user of network can send request to register and verification from user application 236 (272) of user client device 200 (135) to server 110 module with details including full name, unique user name or identity, password, mobile number, email address. In an embodiment verification of user's mobile device 135 is happen via sending one-time password (OTP) on user provided mobile number and in the event of entering or automatically detecting incoming one-time password (OTP) verifying user and user's mobile device.

In another embodiment advertiser or brand admin or shop owner or admin or any authorized person on behalf of place of business or brand or shop or seller or company or organization can send request to register and verification from advertiser application 236 (271) from the user client device 140 to the server 110 module 152 with details including full name, role, position, place of business name, logo, photos, videos, description, working hours, category, sub-category, address, selected verified place on map owned by advertiser, maps and direction, ratings, reviews, products and services catalog and details, contact person information and profile, contact information, website, mobile number, email address, WhatsApp phone number, unique user name or identity, password, payment information. In an embodiment verification of advertiser user's mobile device 140 is happen via sending one-time password (OTP) on advertiser user provided mobile number and in the event of entering or automatically detecting incoming one-time password (OTP) verifying advertiser user and advertiser user's mobile device.

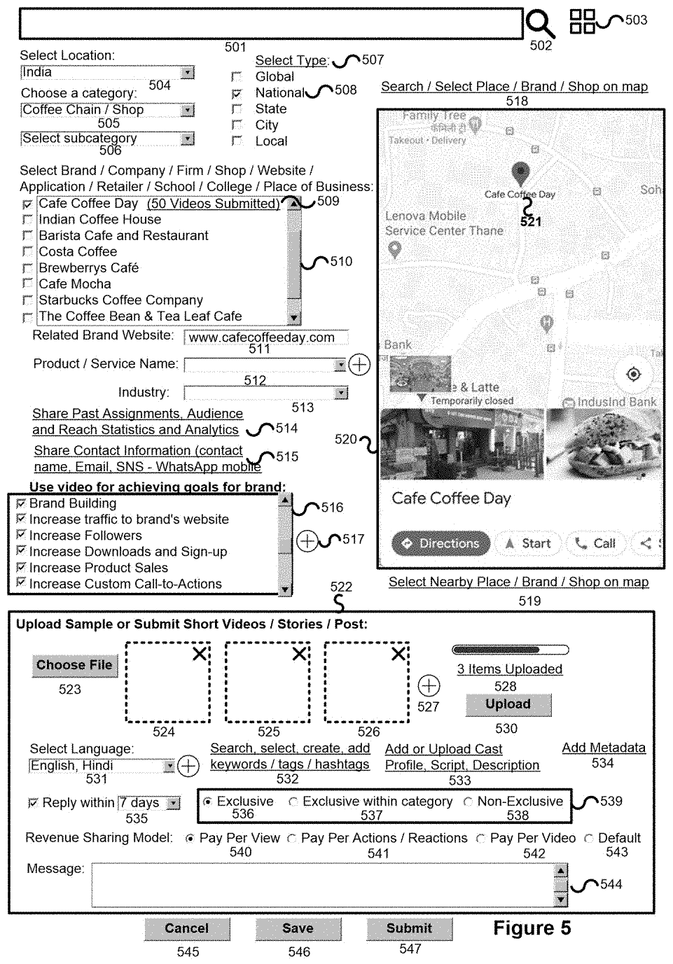

In one embodiment FIG. 5 illustrates graphical user interface (GUI) 273 of creator user device 200 (130) for enabling creator user to search brands 501, match brands based on one or more selections or advance search criteria or search 518, match, browse and select place or place of business 521 on map 520 or select place or place of business 521 on map 520 from nearby places or nearby selected category or filter specific places 519 or select brands from one or more categories lists 503 or select one or more locations including country, state, city, region, area, pre-defined geofence, pin code 504, select one or more categories 505 and sub-categories 506, select type of brand including global, country, state, city and local level brand 507 and select from list 510 said selected one or more locations 504, one or more categories 505 and sub-categories 506 and type of brand e.g. 508 specific one or more brands e.g. 509, view, input or select associated website 511, select industry 512, select language(s) of content 531 and upload 530 associated produced or developed or created one or more selected or imported or dragged and dropped files 523 of types of contents 524/525/526 including one or more short videos, videos, photos, posts, voice, microblog or blog or article or message and associated one or more types of call-to-actions or link(s) or uniform resource locators (URLs) of call-to-actions. User can search, match, select and add or update one or more keywords and tags 532, share past assignments, audience and reach statistics and analytics 514, share contact information including contact name, email address, SNS (WhatsApp mobile) 515, Add or update or upload cast profile, scripts of video, description, add or update one or more types of metadata 534, select content rights policy 539 including allow exclusivity 536 or allow exclusivity within category 536 or non-exclusive 538, select expected or preferred revenue sharing model including pay per view 540, pay per view and type of actions and reactions 541, pay per content including per video or short video or post or blog or photo 542 or default 543, select one or more types of usage of content for advertiser including Brand Building, Increase traffic to brand's website, Increase Followers, Increase, Downloads and Sign-up, Increase Product Sales, and Increase Custom Call-to-Actions 516 or add usage type and details 517, custom message for advertiser 544 and expected reply within particular duration e.g. within particular number of days 535. User can save form 546 for later submission or submit request 547 with said details and contents to selected one or more brands or admin(s) of brand(s) or advertiser(s) via server 110 module 156 for reviewing proposal, accepting proposal and review, moderate and verify said uploaded contents and provided details Advertiser can send request to further verify, moderate, list or publish or directly list or publish said advertiser or brand verified, revised and moderated contents to server 110 module 156 for making them available for view based on target criteria and making them searchable for viewing users of networks.

In another embodiment creator user of content including short video(s) related to selected brand(s) can produce said selected bran related contents including short video(s) and directly submit content including short video to server 110 module 156 for review, moderation, verification, and make searchable, listing and publishing among users of network of directly publish or make searchable for users of network and monitor and tracks number of views, follows, reports including spam and inappropriate contents, comments, likes, and shares on said published contents including short video(s) related to selected brand(s) and inform related contact person of brand about engagements and reach and enable brand owner or admin or authorized person of brand to claim said content including post or short video and access associated data, logs, statistics, analytics, add one or more selected or custom call-to-actions and reaction controls, set target criteria and settings. So, creators can produce as many contents as they want for selected brands, place of business and local shops and directly publish or publish after server admin(s) review, moderation and verification. In another embodiment advertiser or business owner or brands can register with the platform and can view already published contents related to their brand or products or services and monitor, track and view reach, engagements and conversations and can claim one or more selected or ranked published contents related to brand and claim contents or request to access associated data, logs, engagements, conversation data, add or update one or more call-to-actions and reaction controls, access various types of statistics and analytics, create campaign and set target criteria, budget and schedule for advertising or distributing or broadcasting said cotenants among target criteria specific users during scheduled start and end data and up-to reaching daily budget. In another embodiment sending brands about engagements and reach related to contents associated with brands. In another embodiment enable brand owner to directly search and view their brands related contents associated engagements and reach and enable to claim them. So instead of creating general surprise short videos, creators can produce surprise and innovative (idea, concept, dialogue, script, camera tricks, voice and cast) short videos which contains entertainment as well as brand message and if content gets sufficient amount of views, followers of video associated brand or brand page, comments, shares, likes, number of call-to actions (one or more call-to-actions attached with said content by influencer or content creator) then advertiser attracts content and content data and control and make payment of charges based on advertisement charges model which will share by platform with said content producer influencer or content creator.

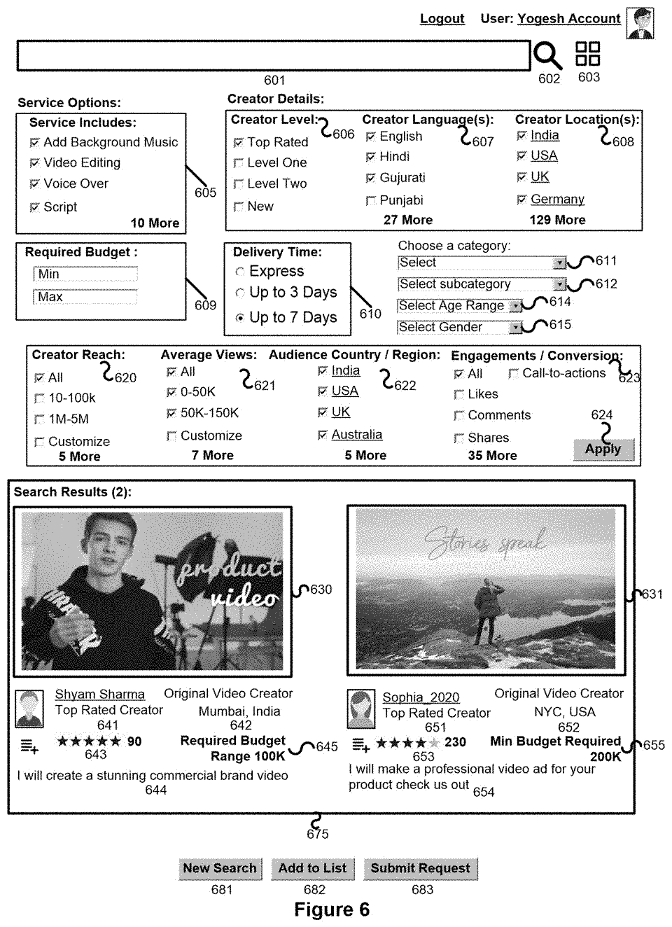

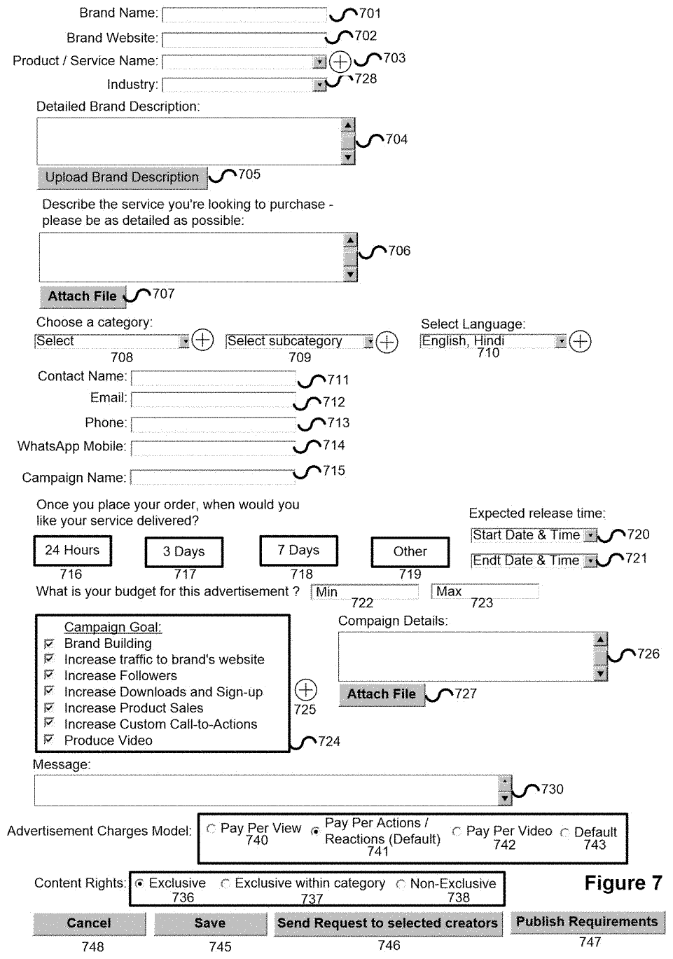

In another embodiment FIG. 6 illustrates graphical user interface wherein advertiser user can search, match, browse and select and view profiles of creators or creator users of network or can search based on one or more selected criteria or filters including search keywords 601, select one or more types of services 605, required budget 609, creator detail including selected one or more creator level(s) 606, creator language(s) 607, creator location(s) 608, delivery time 610, categories 611, sub-category 612, age range 614 and gender 615 of creator user, reach or ranges of followers of creators 620, ranges of number of views of posted contents or average number of views of posted contents 621, audience country of creator 622, type and number of engagements or reactions including like, dislike, comment or conversations or call-to actions including buy, sign up, subscribe, trail, claim sample or offer, participate in deal, book, get appointment, add to list, share, follow, connect, share contact information, make call, send massage, watch video, visit website, install application 623 and apply 624 said selections to send search request from search interface 274 of client device 200 (274) to sever module 154. Server module 154 receives said search query and associated criteria and retrieves search query and associated criteria specific data and contents and generates search results and display search results 675. Advertiser can view, review profile, select, add to list 682 creators, conduct new search 681 and can submit request 683 (discuss in detail in FIG. 7) to selected creators from search results or from lists or bookmarks or shortlist or from categories lists.

FIG. 7 illustrates graphical user interface 275 wherein advertiser can input or select brand name 701, brand website 702, one or more products and services 703, industry 728, description 704 and/or upload brand description 705, describe required services 706, attach file related to requirement specification 707, select category 708, sub-category 709, language(s) 710, provide contact information including contact name 711, email 712, phone 713, WhatsApp mobile number 714, campaign name 715, expect required delivery 716-719, expected release date 720/721, budget 722/723, selected one or more types of campaign goals 724 and add custom goals 735, campaign details 726 and attach campaign related files 727 describe concept, idea, theme, purpose, requirement, script of video or content, custom message 730, select advertisement charges model including pay per view 738, pay per video 742, default advertisement charges model 743, pay per type of action and reaction (wherein type of actions and reactions selected by advertiser at the time of publishing content and charges may vary for each type of action and reaction) and based on that identify revenue sharing model for creators. Advertiser can mention required exclusivity or license for content inducing exclusive rights 736, exclusive within category 737 or non-exclusive 736. Advertiser can save said details 745 or cancel 748. In another embodiment advertiser can send request 746 with said details from user interface 275 server 110 module 155 to selected creators including selected creators from search results and one or more types of lists of creator users. Creator users can accept said received proposal and associated rules, polices, agreements a condition and create or produce said requirement specific one or more types of contents including short video, video, post, blog and submit to said advertiser for acceptance and review, moderation, and verification. Advertiser an accept, request one or more revisions and submit finalized content for listing or publication to platform or server 110 module 157 for directly publication or for moderation, verification and approval and listing or publishing for making them viewable or searchable for other users of network based on target criteria. In another embodiment advertiser can publish 747 said requirement specification via server module 155 which registered creator users of network can search, browse, view, review, add to list and accept proposal and associated rules, polices, agreements an conditions and create or produce said requirement specific one or more types of contents including short video, video, post, blog and submit to said advertiser via server module 156 for acceptance and review, moderation, and verification. Advertiser an accept, request one or more revisions and submit finalized content for listing or publication to platform or server 110 module 157 for directly publication or for moderation, verification and approval and listing or publishing for making them viewable or searchable for other users of network based on target criteria.

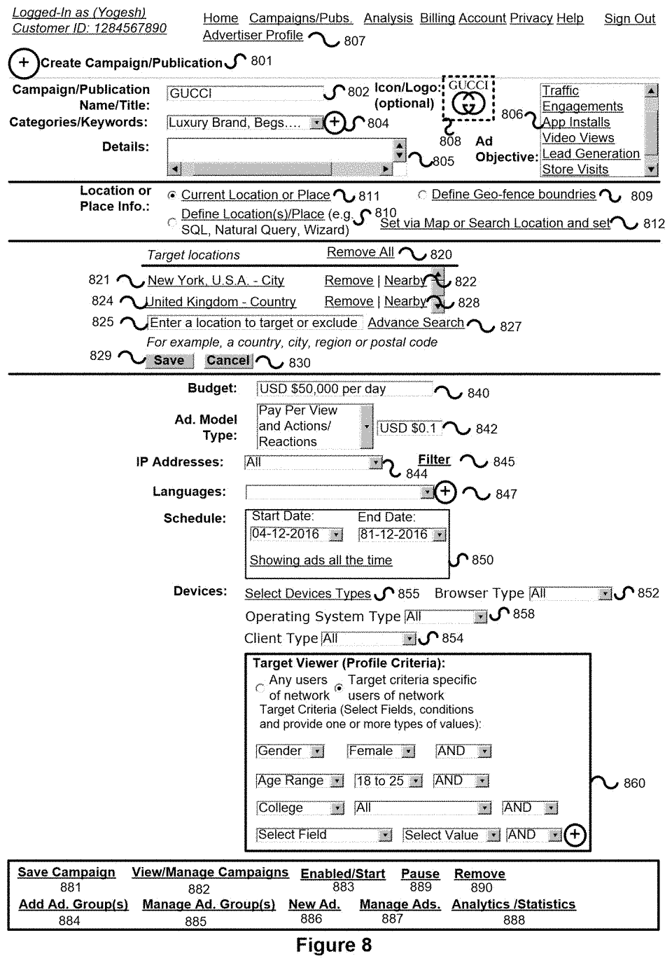

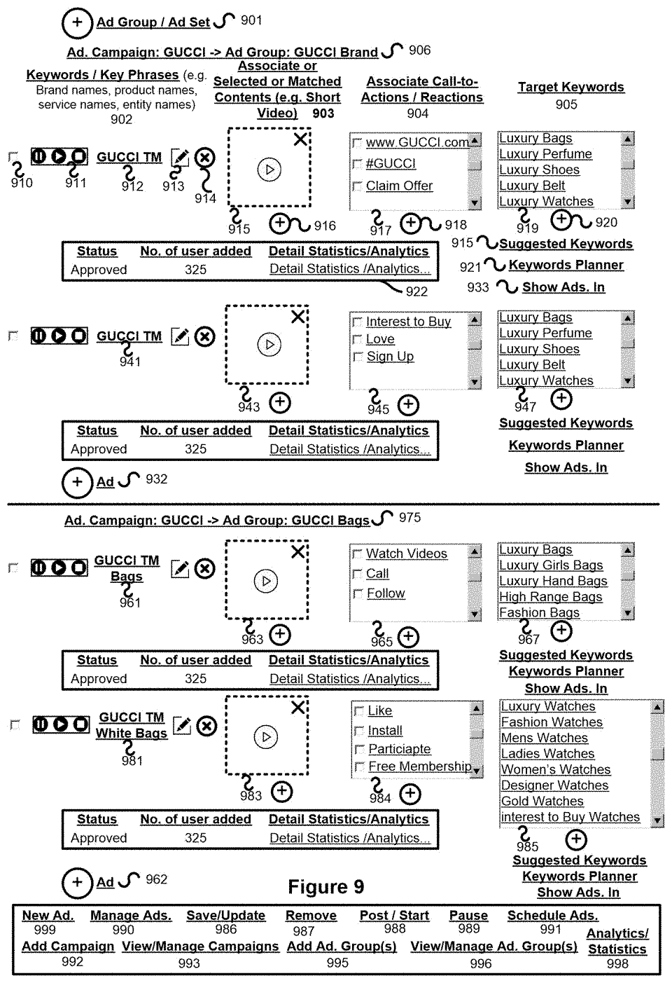

FIG. 8-9 illustrates campaign management user interface(s) 276 for one embodiment enabling advertiser or publisher user to create advertiser user account (sign up) or sign in (if already created), view or update profile 807, access billing information & payment information by authorized advertiser. In an embodiment after creating account, server or system verifies advertiser or publisher and activate advertiser user account to enable logged in account user to create and manage one or more advertisement campaigns, advertisement groups, advertisements and associate target criteria and other settings. In an embodiment enabling advertiser to create one or more advertisement campaigns 801 or enabling user to create one or more publications 801, campaign or publication comprises a set of advertisement groups (advertisements, keywords, and bids) that share a budget, advertisement model type, location targeting, type of user profile or defined characteristics of user targeting, schedules of targeting, languages targeting, device(s) type(s) targeting, campaign types (discussed in detail in FIG. 9) and other settings, campaign settings let advertiser control where and when their advertisements appear and how much they want to spend and campaigns are often used to organize categories of products or services that advertiser offer, Advertiser enable to provide campaign or publication name 802, provide campaign or publication related categories and keywords 804, provide icon or logo or image 808, provide campaign details 805, set or define or provide locations to target advertisement or showing keyword(s) based on matching targeted advertisement related location(s) with current location of user device including select current location as target location 811, select locations or places, provide address, provide geolocation information (e.g., coordinates including latitude, longitude, aptitude) or search or select location(s) or place(s) from/on map 812 or select or define geo-fence boundaries 809 or define types and characteristics of location or query specific locations or places based on structured query language (SQL), natural query and wizard interface, enable to enter (input, auto-fill up, suggested list) location to target or include or exclude location(s) 825, for example user adds locations 821 and 824, remove all added 820, remove selected or find nearby and add 822 or 823, user advance search to provide location criteria, conditions, rules, boundaries, query specific locations or places (For example SQL query: “Select Places where Place Type=‘GUCCI’ or Natural Query” “all GUCCI shops of world”). Advertiser can create separate advertisement campaigns to run advertisements in different locations or using different budgets. Advertiser can provide budget for particular duration including daily maximum spending budget of advertisement 840, daily budget is the amount that advertiser set for each campaign to indicate how much, on average, advertiser's willing to spend per day, advertisement model including pay per view, pay per type of action and reaction (different type of action or reaction may have different charges which also vary based on location) 842, which means that advertiser pay only if someone views or take associated one or more actions or call-to-actions and reactions. In general, the higher the advertiser's bid and the more relevant advertisements and keywords, the more likely advertiser's advertisement will show at a higher position in the displayed or suggested contents in feed. Advertiser can provides associated target criteria including add, include or exclude or filter 845 IP addresses 844, one or more languages 847, schedule of showing of advertisement including start date, end date and showing advertisements all the time or particular time, time range at particular date or day 850, select targeted device type(s) 855 including mobile devices, personal computer, wearable device, tablets, android device and/or iOS devices etc., define target user's profile type or characteristics or modeling of target users including any users of network or target criteria specific users of network including one or more types of one or more profile fields including gender, age or age range, education, qualification, home or work locations, related entities including organization or school or college or company name(s) and Boolean operators and any combination thereof 860. After creating and providing information and settings related to created campaign, user or publisher or advertiser can save campaign 881 at server database 115 of server 100 via server module, so user can access, update, start 883, pause 889, stop or remove 890, view and manage 882 one or more created campaigns and associate information and settings including one or more advertisement groups 884 and 885, and content including short video, video, story, post advertisements 886 and 887 and can access started one or more campaigns, advertisement groups and advertisement associated or generated analytics and statistics 888.

FIG. 9 illustrates user interface for enabling advertiser or publisher to create one or more advertisement groups 906 and 975 related to particular or selected campaign 802. After creating and set-up of campaign 802 (as discussed in FIG. 8), advertiser can create advertisement group e.g. 901 via clicking or tapping on ad group button 910. An ad group contains one or more ads 912 and 941 which target a shared or different set of keywords. Each of advertiser's or publisher's campaigns (discussed in FIG. 8) is made up of one or more ad groups 906 and 975. Advertiser can use ad groups to organize ads by a common theme and use different ad groups for different product or service types. For example, GUCCI™ creates campaign GUCCI™ (discussed in FIG. 8) and creates ad groups 906 and 975 including one for GUCCI™ brand and other for GUCCI™ bags. After creating ad group e.g. 906 (“GUCCI™ Brand”), advertiser can create advertisement(s) via create advertisement icon or link or control or button 932 e.g. 912. Ad group is where advertiser will add 932, edit 913, remove 914 advertised content including short video, video, post, story, micro blog, e.g. 912 (“GUCCI™”), add, edit, remove 917/918 one or more call-to-actions or user actions links & controls, applications or links of applications, one or more types of media items or links of added one or more types of media items, one or more types of offer(s) including discount, redeemable points, coupons, cash backs, free gifts or samples or one or more types of benefits and add, edit, remove 920 or choose keywords 919 from suggested list of keywords 915 or select via keywords planner 921 (which helps to find out best relevant keywords which are found more in user data or user related collections of keywords) that can trigger those ads 912 and/or 941 when someone's (i.e. any users of network) user data (user's one or more types of profile or structured information (fields and provided associated values), logged or stored data related to user's activities, actions, events, transactions, senses, behavior, sharing, communications, collaborations, interactions, status, and current or past or checked-in locations or places) and user's collection of keywords including said advertisement related keywords contains said target keywords 919, add 9231. Every campaign needs at least 1 ad group, and every ad group needs at least 1 ad. In another embodiment advertiser can provide target keywords 919 and select type of match (not shown in figure) including broad match, exact match, phrase match, or negative match, wherein broad match is the default match type and when advertiser use broad match, advertiser's ads automatically run on relevant variations of keywords 919, even if these terms aren't in advertisement related target keyword lists 919. In another embodiment advertiser can search, match, select, view details, purchase (if paid), customize, apply privacy settings & add one or more user actions or call-to-actions, controls, functions, objects, buttons, interfaces, links, contents, applications, web services and forms provided by one or more developers 917/918.

In another embodiment after creating advertisement or publication campaign(s) 802 (as discussed in FIG. 8), campaign associated advertisement group(s) 906 and 975 and advertisement group 906 and 975 related advertisement keyword(s) 912, 941, 961, 981, user or publisher or advertiser can anytime save campaign associated advertisement group(s) and associated content (short video, video, post, blog, message, photo, story) advertisement(s) at server database 115 of server 100 via server module 158) and/or local storage medium of user device 200, so user can access, update, start 988, pause 989, stop or remove 987, view and manage 990 one or more created campaigns associated advertisement group(s) and associated content advertisement(s) and associate information and settings including one or more advertisement groups 906 and 975, and content advertisements 912, 941, 961, 981 and can add new ads 999, manage currently created ads 990, add new ad group(s) 995, mange ad group(s) 996, add campaign(s) 992, manage campaign(s) 993 and can access started one or more campaigns, advertisement groups and advertisement associated or generated analytics and statistics 998.

In another embodiment after creating advertisement or publication campaign(s) 902 (as discussed in FIG. 8), campaign associated advertisement group(s) 906 and 975 and advertisement group 906 and 975 related advertisement keyword(s) 912, 941, 961, 981 with the intention that targeted contextual users of network show said advertised contents (short video, video, post, story, photo, blog, message) in various types of feeds, lists, suggested content items. In another embodiment system or server 110, first verifies advertisement (keywords, logo, brand, product name, service name, description or details, and advertiser's identities etc.) and then allow or approved or make eligible to start said advertisements. In another embodiment advertiser can view, access, and manage each campaign, each ad group of each campaign and each keyword advertisement of each ad group of each campaign related status, statistics and analytics 998. Server module 158 stores, updates data related to campaigns and monitors and tracks activities, actions, interactions, reactions, behavior, transactions of short video viewers and based on that determining advertisement charges and revenue sharing with creators related to short video.

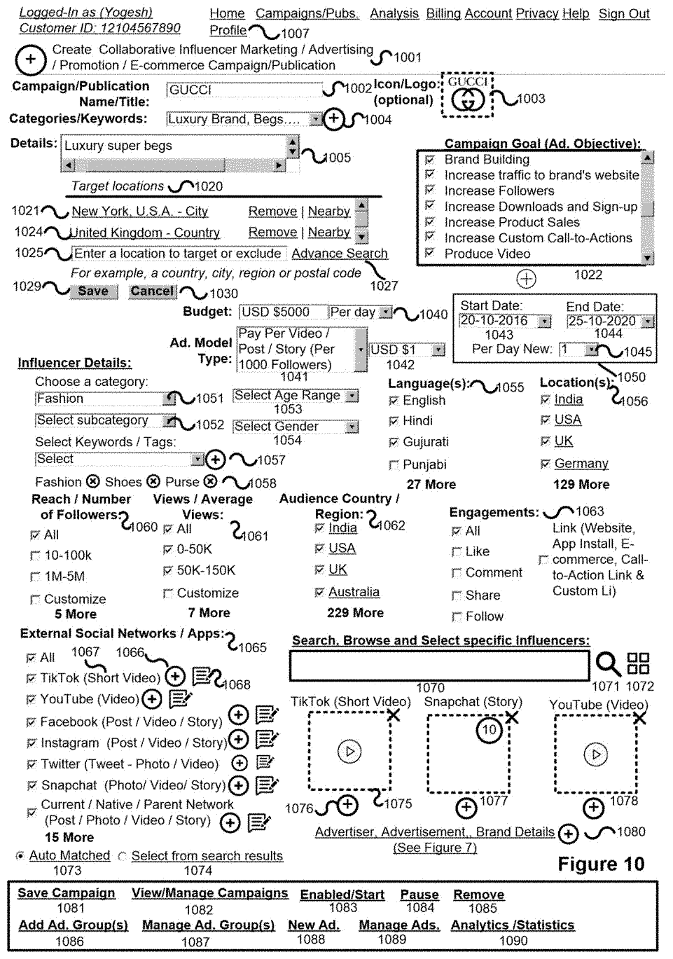

FIG. 10 illustrate graphical user interface 277 for advertisers who want to search, match, browse, and select influencers on multiple external domains, web sites, social networks and applications and publish or endorse multiple types of content advertisements via said selected or auto matched influencers. Advertiser can create campaign 1001 and select or input or enter campaign name 1002, categories and keywords 1004, icon 1003, add details 1005, select one or more target locations 1021/1024, use advance search 1027 to select one or more types or combination of locations, exclude location(s) 1025 and save 1029 or cancel 1030 locations. Advertiser can add campaign goals including Brand Building, increase traffic to brand's website, Increase Followers, Increase Downloads and Sign-up, Increase Product Sales, Increase Custom Call-to-Actions and Produce Video 1022. Advertiser can add per day budget 1040, advertisement model type 1041 including e.g. Pay Per Video/Post/Story (Per 1000 Followers) 1041/1042 or Pay per view wherein identify number of views or average views and actions and reactions including followers, connections, shares, likes, comments of influencer based on influencer added linked account or profile link or updated by influencer and verified by server admin, start and end date of campaign and per day new post for endorsement or publication or posting or producing or publishing via selected or auto matched influencers on selected external domains or social networks or applications. Advertiser can select influencer details including category 1051, sub-category 1052, keywords or tags 1057/1058, selected age range 1053, selected gender 1054, selected location 1055 and selected language 1056 of influencer. Advertiser can select one or more target criteria including ranges of reach or number of followers 1060, ranges of views of posted contents or average views of posted contents of influencers, selected countries or region of audience of influencers 1062, if present network or system or server is linked or connected with external domain or system or server via APIs then enable to select displayed ranges and numbers of different types of actions and reactions 1063, select one or more external domains or social networks or websites or applications 1065 from list and enable to add or update or upload 1066 said selected social network 1067 specific content type 1075/1077/1076 or provide, update and submit requirement specification (see FIG. 7 for details) 1068 to instruct to produce said requirement specification specific contents from said selected or auto matched influencers. In an embodiment based on search queries 1070/1071 or selection from categories directories 1072 or search based on above mentioned criteria displaying list of influencers and enable advertiser to further search, filter, and shortlist influencers 1074. In another embodiment based on criteria, selection and preferences automatically match influencers 1073. Advertiser can manually verify and view actual followers, reach, average views of posted contents of influencer by visiting related social network. Advertiser can save 1081, manage 1082, start 1083, pause 1084, remove 1085 campaign, add 1086, manage Ad. Group 1087, add 1088 and manage 1089 new advertisement and access analytics and statistics 1090. In another embodiment based on advertiser provided budget limit number of influencers from selected or auto matched influencers for producing and publishing or endorsing content advertisement.

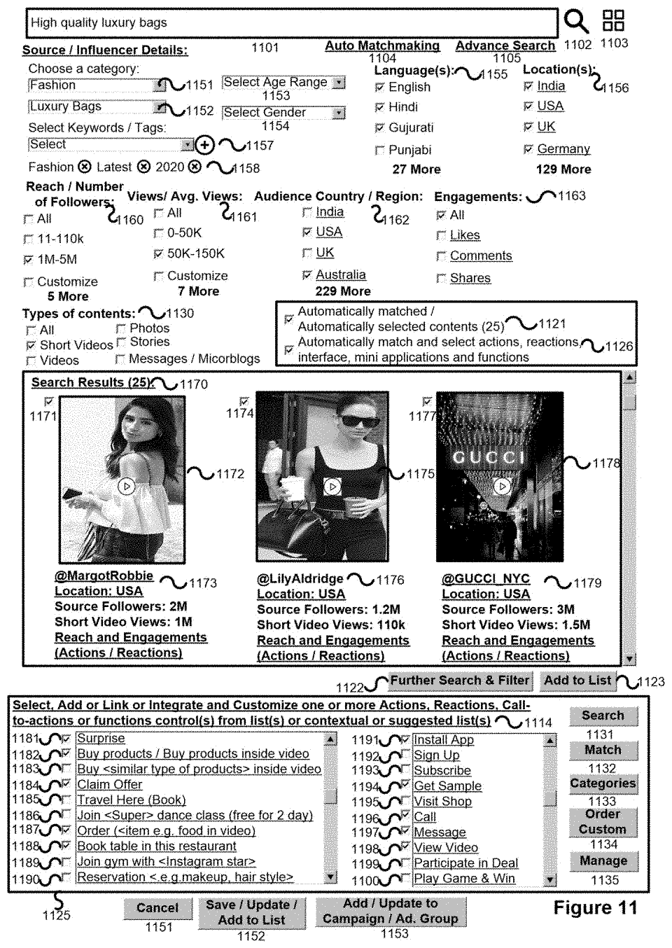

In an embodiment server 110 database or linked or connected storage medium 115 stores one or more types of contents including short videos, videos, photos, posts, stories, blogs, and messages and associated keywords, tags, categories, and one or more types of metadata and system data posted or published or sent by users of network. Server module identifies keywords based on contents including short videos, videos, photos, posts, stories, blogs, and messages and associated keywords, tags, categories, and one or more types of metadata and system data, recognized objects or scene inside video images associated identified keywords and name of people based on object or scene or face or body recognition techniques, identifies keywords based on voice recognition techniques, identifies keywords based on optical characters recognition (OCR) techniques, identified and updates keywords based on provided comments and store, index and associate said keywords with each identified content item including short video, video, photo, post, story, blog, and message. FIG. 11 illustrates graphical user interface 278 for enabling advertisers or influencers or users of network to send request to search contents to server 110 module 159 based on search query or inputted one or more keywords, Boolean operators including AND. OR, NOT, phrases and any combination thereof, one or more structured query language (SQL) queries, natural query, using advance search or selecting one or more selections or filters or criteria including category 1151, sub-category 1152, keywords 1157/1158 related to contents or influencer related data including profile, influencer details including ae range 1153, gender 1154, language(s) 1155, location(s) 1156, ranges of numbers of followers 1160, ranges of aggregate number of views of posted contents or average number of views of posted contents 1161, audience countries 1162, one or more types and numbers of actions and reactions 1163, one or more types of contents 1130 and can tap or click on search control or button 1102 to send search query and associated selected one or more criteria or filters or selected options to server 110 module 159 for searching said search query and selected one or more criteria or filters or selected options specific one or more types of contents. Server 110 module 159 searches, matches, retrieves and generates search query and selected one or more criteria or filters or selected options specific one or more types of contents from server 110 database or linked or connected storage medium 115 and displaying generated search results 1170 to searching user.

In an embodiment searching user or advertiser or influencer or user can view and review searched contents 1172/1175/1178 including object or scene, concept, idea, dialogue, story, text, location inside content including video and associated categories, keywords, tags, metadata to identify relevance and select 1171/1174/1177 one or more contextual or relevant content items including short videos 1172/1175/1178. In another embodiment searching user or advertiser or influencer or user can send request automatically match and select contents to server 110 module 159 or select automatically matched or automatically selected contents 1121, wherein automatically match or select contents based on daily budget, total budget, bid, schedule, required number of views, reach and engagements or select top ranked particular number of contents or further filter 1122 based on rank, added or updated keywords, selected filters, structured query language (SQL) or natural query and criteria and select contents from list of filtered content items. In multi user environment, multiple authorized users can search, match, review, and select content items and add to short lists 1123 and finalize selection of content items or admin(s) can finalize selection of content items.

In an embodiment after searching, matching, reviewing, identifying, finalizing and selecting or selecting auto matching and auto selecting content item(s), advertiser or influencer or user can select one or more actions or call-to-actions and reactions functions or objects or user interfaces or applications or mini applications controls including link or uniform resource locator (URL), or icons or shortcuts or buttons 1181/1182/1184/1188/1191/1196/1197/1198 from list of actions, call-to-actions, mini applications, user interfaces and functions 1125 for associating or attaching or overlaying or embedding or integrating or linking with said selected all 1171/1172 or one or more selected contents 1171. In another embodiment select different types of actions, call-to-actions, mini applications, user interfaces and functions for different selected content items. Server module 160 receives uniquely identified content item and associated uniquely identified call-to-action(s), reaction(s) functions or controls, mini application(s), user interface(s).

In an embodiment after searching, matching, reviewing, identifying, finalizing and selecting or auto matching and auto selecting content item(s), advertiser or influencer or user can select option 1126 for automatically identifying or automatically selecting contextual one or more actions or call-to-actions and reactions functions or objects or user interfaces or applications or mini applications controls including link or uniform resource locator (URL), or icons or shortcuts or buttons 1181/1182/1184/1188/1191/1196/1197/1198 from list of actions, call-to-actions, mini applications, user interfaces and functions 1125 for automatically associating or attaching or overlaying or embedding or integrating or linking with said selected all 1171/1172 or one or more selected contents 1171. In another embodiment automatically select different types of actions, call-to-actions, mini applications, user interfaces and functions for automatically selected different selected content items.

Advertiser or influencer or user can cancel 1151 or select save or update or add to list 1152 selected contents and associated or linked or embedded or connected or overlayed or integrated actions, call-to-actions, mini applications, user interfaces and functions.

In another embodiment advertiser can create new campaign 801 or use existing as template for new campaign or select existing campaign 802 and add one or more contents including short videos, videos, posts, stories, photos, micro blogs or messages or one or more types of contents or combination of contents (photo, video, audio, text, uniform resource locator (URL), emoticons, stickers, location information, object links (profile, application, call-to-action, group, event), actions and reaction control(s)) 1172/1175 to one or more newly created or already exists Ad. group(s) 906/975 and associated newly created or already exists all or selected advertisement 912/941/961/981 which displayed in list of added content items 915 (which user can further add, update or remove) and associated one or more actions, call-to-actions, mini applications, user interfaces and functions displayed in list 917 (which user can further add, update or remove). Advertiser can save or update campaign, change target criteria and settings and start, schedule, pause campaign and view associated detail statistics and analytics (discussed in detail in FIGS. 8-9). In another embodiment users of network can attach one or more or pre-defined allowed number of selected actions or call-to-actions or reactions controls or custom actions or call-to-actions or reactions controls only with their own prepared or posted contents. In another embodiment only pre-defined influencers of network can attach one or more or pre-defined allowed number of selected actions or call-to-actions or reactions controls or custom actions or call-to-actions or reactions controls only with their own prepared or posted contents, wherein define influencer based on number of posts, followers, viewers, views, one or more types of actions and reactions.

In another embodiment enabling external or 3rd parties' developers to register with platform 100 via server module 161 and enable to develop and submit for verification, listing, publication and making searchable actions or call-to-actions, mini applications, user interfaces and functions for registered and authorized advertisers and/or influencers and/or users of networks. Advertisers or influencers or users of networks can search 1131, match 1132, browse categories directories 1133 and select actions or call-to-actions, mini applications, user interfaces and functions and view associated details and customize as per requirement or order custom 1134 actions or call-to-actions, mini applications, user interfaces and functions to one or more registered or authorized developers and enable to manage 1135 actions or call-to-actions, mini applications, user interfaces and functions including search, select, view details, ratings, reviews, download and install or uninstall or directly use without need to download, install or uninstall install or update or use online, provide likes, ratings, comments or reviews, make payment, subscribe, use payment model including pay per view, pay per type of action or reaction, pay per content (short video, video, post, story), create or select list and add to list, categories, sort, filter, order, drag and drop and attach with content item(s), shortlist, view details, customize, rank actions or call-to-actions, mini applications, user interfaces and functions. Customization of actions or call-to-actions, mini applications, user interfaces and functions may comprises add or update brand name, place of business name, name of contact person, contact details, offer details, add further series or sequence of actions/call-to-actions/reactions/mini applications/User interfaces/functions, add or update products, services and associated details and structured details, add or update or customize forms, date and time, phone number, website, email address, deal description and action(s), calendar, one or more types of content including video, uniform resource locator (URL), rules, price, agreements, terms and conditions, privacy and presentation settings, accepted payment methods, and like.

In another embodiment types of content sources may comprise present network as well as external or 3^{rd} parties' domains, networks, applications, web services, databases, servers and devices.

In another embodiment at a time enable only single advertiser to add or attach or display or overlay or integrate selected actions and reactions controls with particular selected uniquely identified content item during scheduled start and end date and time and after that allow other advertisers to attach or display or overlay or integrate selected actions and reactions controls with said same uniquely identified content item.

At present advertisers shows one or more types of advertisements overly or besides displayed content. But advertisers are not able to integrate or attach selected actions and reactions controls or custom actions and reactions controls on selected or matched contents and display said selected actions or reactions controls with selected or matched contents to target criteria specific users of network.

Server module 158 stores, updates data related to external domains campaigns and monitors and tracks activities, actions, interactions, reactions, behavior, transactions of short video viewers and based on that determining advertisement charges and revenue sharing with creators related to short video.

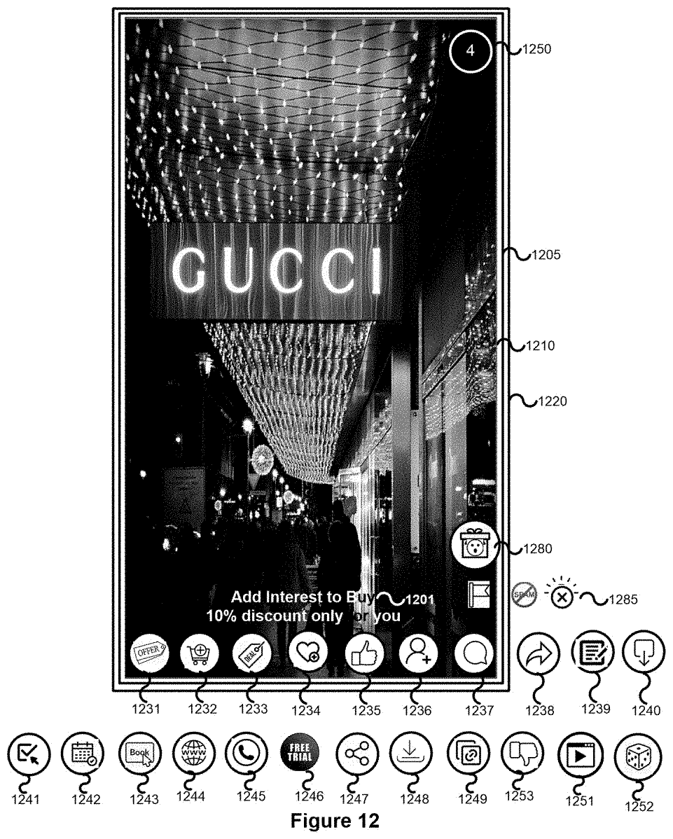

FIGS. 12-14 illustrates graphical user interface or news feed or timeline or feed graphical user interface 1205 (280) for displaying one or more types of contents or particular type of content items e.g. short videos 1210 via server module 162, wherein displaying by the server 110 module 162 one or more types of contents or particular type of content items e.g. short videos are based on automatically display or selection of category(ies)/sub-category(ies) or keyword(s) or tag(s) or hashtag(s) or search query or auto matchmaking criteria or preferences or filter(s) or automatically display or update based on followed sources or following or display contents posted by connected users or contacts including all contacts, phone contacts, family members, best friends, groups, mutual social connections, mutual professional or business contacts, email contacts and any combination thereof, automatically display based on suggestions, user preferences, logged past viewing of videos analysis including full or partially viewed, liked, shared, commented types of contents, associated keywords, logged activities, actions, transactions, and interactions details of user and connected users, visited or interacted or transacted places associated details, current place, nearby places and associated identified entities or relevant persons, scanned code including QR code or object(s) or face(s), recognized voice, user related data and logged activities, actions, reactions, interactions, transactions, participations, digital activities, status, communication, collaboration, sharing details from linked systems, servers, applications, services, databases, storage mediums, networks, devices including warble devices (e.g. digital spectacles and watch) via APIs, SDKs and web services and wherein displaying by the server 110 module content item with associated one or more actions, call-to-actions, reactions, mini applications or applications, functions, user interface(s) controls including icons. For example, short video 1210 displays associated icons 1231-1240 wherein each icon is associated with associated action(s), call-to-action(s), mini application(s) or application(s), function(s), user interface(s) and content item(s) (discussed in detail in FIG. 11).

In an embodiment user can tap or click within predefined area surround or top of particular icon 1234 to view icon associated details 1201 including name of action or reaction, short description, offer details including discount, voucher, coupon, cashback, and redeemable points, rules, price, offer duration, unified resource locator (URL), sub menu.

For example, user can tap on top of “Offer” icon 1231 displayed on currently viewing post 1210 and view offer details e.g. buy 1 and get 1 free, view GUCCI bag photos and videos. Viewing user can click or tap on “Offer” icon 1231 to buy, make payment from selected payment method from list of added payment methods (debit card, credit card, net banking or direct bank, PayPal, crypto currency, pay later, pay via installment) and get offer benefits. In another example user can click or tap on icon e-commerce to redirect user to associated webpage or open user integrated or connected or linked interface for enabling user to view GUCCI bags and add to cart and make payment to purchase selected bags. In another example user can tap on “Deal” icon 1233 to participate in particular deal or again tap on icon within particular duration or before swipe above to view next content or short video to remove from participation. User can tap on top of “Deal” icon 1233 to view group deals details including offer, number of participations

And number of remaining required participations to fulfill deal rules, duration left. User can share deals with connected users of network or can share on other networks' connected users. In another example user can tap on icon 1234 to add advertised product(s) or service(s) in interest list, so user can view later and can make payment and buy from list. In another example in the event of tapping on like button 1235 by viewing user, display like button to like post and display advertised product and enable user to like advertised product. In another example user can click or tap on membership icon 1239 to one tap become member with advertiser (e.g. GUCCI) and share viewing user's details with advertiser GUCCI brand based on user's permission and pre-set privacy settings. In another example in the event of tapping or clicking on “Install” icon 1240, based on type of device, user redirected to application installation page wherein user can download and install advertiser or brand associated application. User can share details for quick registration and login.

Likewise other types of actions and reactions associated with particular content item (e.g. short video or post) may comprises subscribe (get offer only for you and only once in this post) 1241, schedule free consultancy or visit at particular shop or firm 1242, book tickets for advertisement associated movie or event or tour or show 1243, open advertisement or advertised brand or product or service associated website 1244, make call 1245, claim or register free trail or sample 1246, share offer or advertisement or associated one or more actions with one or more connected users or one or more connected users on one or more external domains, social networks, and applications 1247, download one or more types of contents including video, catalogues, presentation 1248, copy link of content or copy link of advertisement for sharing or note down or bookmarking for later access and use 1249, dislike displayed contents or associated advertisement 1253, watch video 1251, play game and get offer or win 1252 and one or more types of custom and other types of actions, call-to-actions and reactions.

In another embodiment user can swipe up to view previous content item (e.g. short video) or swipe down to view next content item (e.g. short video). In another embodiment user can swipe left to view previous content item (e.g. short video) or swipe right to view next content item (e.g. short video). In another embodiment user can tap anywhere on screen 1205 or pre-defined area or icon or displayed post or video 1210 to pause video or tap or click again on to anywhere on screen 1205 or pre-defined area or icon or displayed post or video 1210 to restart video. In another embodiment in the event of ending of video automatically display next video.

In another embodiment display actions and reactions controls 1235-1239 related to displayed content, wherein actions and reactions controls comprises like currently viewing content (e.g. short video or post), follow currently viewing content (e.g. short video or post) associated posting user or source, comment on currently viewing content (e.g. short video or post), share currently viewing content (e.g. short video or post). In another embodiment display actions and reactions controls 1235-1239 related to displayed content (e.g. short video or post) associated advertisement, wherein actions and reactions controls comprises like currently viewing advertisement or advertised product(s) or service(s), follow currently viewing content (e.g. short video) associated advertiser or brand, comment on currently viewing content (e.g. short video) associated advertisement or advertised product(s) or service(s), share currently viewing content associated advertisement or associated action(s). In another embodiment in the event of tapping or clicking on like or follow or comment or share control or icon, displaying 2 icons or buttons to like, follow, comment on and share content or advertisement.

In an embodiment displayed content e.g. short video 1210 is posted by or related to other user or influencer and displayed associated actions or call-to-actions or reactions associated controls or icons 1231-1240 are associated with another advertiser or user or influencer. In another embodiment displayed content e.g. short video 1210 and displayed associated actions or call-to-actions or reactions associated controls or icons 1231-1240 are posted by and associated with same advertiser or user or influencer.

In an embodiment in the event of clicking or tapping on particular icon 1234 execute associated function(s) or action(s) or call-to-action(s) or further display menu, list, options.

In an embodiment user just need to one click or one tap on particular action or reaction control to take particular action. In another embodiment in the event of tapping or clicking on particular action or reaction control, displaying associated one or more types of content including text, message, video, displaying or open user interface or application, displaying other one or more or series or sequence of actions or reactions controls.

In an embodiment user can swipe left or swipe right to scroll acts and reactions control displayed on currently viewing content item in feed.

In another embodiment dynamically display actions and reactions controls on content item based on current location associated place, current trend, current event, current activities, transaction, status, user profile, incoming message or email or call, calendar entries, schedule, date and time associated event, festival and day, action taken by connected users of user on currently viewing content or next content items, participation and interaction with one or more types and named entities, geofence associated actions and reaction controls.

Currently short videos in feed may contains surprise contents produced by users and viewing by users of network. In another embodiment displaying “Surprise” button or control or icon 1280 on displayed content item (e.g. short video) 1210 and in the event of clicking or tapping on displayed “Surprise” button or control or icon 1280, display one or more types of free or sponsored or discounted virtual goods, offer free movie viewing, play song not yet released for public, offer free gift or sample, offer free trail, offer free consulting, offer launch with particular celebrity, send birthday gift, establish surprise video call with particular friend, offer free coupon or voucher, offer free launch at particular restaurant, offer free tickets including movie, show, event, cruise, and flight, offer free tour, offer last few remaining tickets, offer free ride, wherein display offers and free virtual goods including emoticons, stickers, ringtones, virtual cards, post, local post based on user profile, user activities and transactions, logged user's actions and reactions, visits at advertised location of shop or place of business.

In another embodiment use can view linked videos or automatically linked videos by clicking or tapping on number icon 1250 (displaying number of linked contents e.g. short videos). In another embodiment identifying videos to automatically link with particular videos based on identifying similar videos or particular hashtags or keywords or tags or categories related videos. In another embodiment users of network can link one or more videos with particular video. In another embodiment creators can link multiple short videos like episodes or part of program or chronological stories. In another embodiment

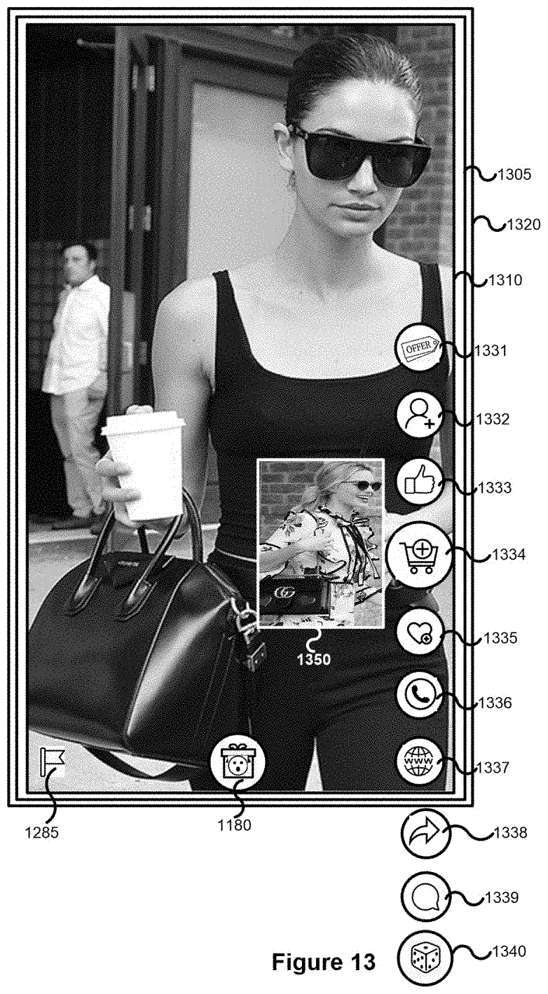

In the event of swipe up on screen 1305 or displayed content item 1310 or instructing to display next content item e.g. short video up, FIG. 13 illustrates graphical user interface or feed interface wherein user can view displayed next content item e.g. short video 1310 and associated or integrated or embedded or overlaid or linked actions and reactions controls 1331-1340. Displayed content item e.g. short video 1310 posted by different user or related to and attached or integrate or associated by different brand or advertiser—see FIGS. 11-12 for details (e.g. Givenchy Antigona Bag) and displayed associated actions and reactions controls 1331-1340 related to (e.g. Gucci GG Shoulder Bag 1350) different brand, product, service and advertiser or different type of brand, product, service and advertiser (e.g. short video or post related to celebrity and bag but actions on post related to beauty parlor or salon or yoga class or luxury car or spectacles or accessories).

For example, user can tap on icon 1334 and view advertised brand product or service presentation or photo or post or short video and/or buy product or service. In another example user can tap on icon 1331 to with one tap become member and get offer or claim offer. In another example user can add advertised product, associated actions to interest list and can access later or within prescribed or associated duration. In another example user can make call 1336 and ask query, get consulting and buy selected products. In another example user can visit website 1337 and view new products and buy or order online. In another example user can play game 1340 and win product.

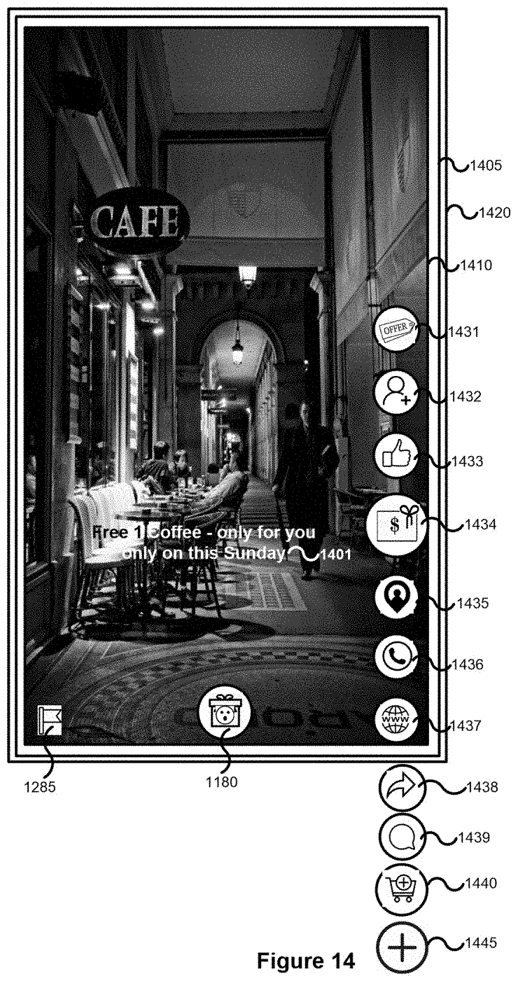

In the event of swipe down from screen 1305 or content item 1310 for or instructing to displaying next content in feed, FIG. 14 illustrates displaying of next content item 1410 and associated call-to-actions and reaction controls 1431-1440, wherein content item 1410 associated call-to-actions and reaction controls added or attached or integrated by advertiser. For example, user can click or tap on top of left side of icon 1434 to view associated details 1401 and can tap on icon 1434 to register or claim or show interest to visit café house and drink free coffee on coming Sunday or also comment that will come with friends and family. In another example user can click or tap on icon 1440 to view catalogue and details of products and can select product(s), make payments and order one or more types of coffee. In another example viewing user of post 1410 can click or tap on currently viewing content (e.g. short video 1410) associated displayed action icon 1435 from currently viewing content (e.g. short video 1410) to provide indication or reaction like to visit store. In another example user can click or tap on icon 1431 to get offer if user subscribe for daily particular number of coffee order.

In another embodiment viewing user can select add actions or call-to-actions or reactions icon 1445 to search, match, browse, select, view details, customize and add one or more actions or call-to-actions or reactions with said currently viewing content (e.g. short video 1410) and submit to server 110 module 160 for review, moderation, and verification. After completing review, moderation, and verification by server admin(s) or authorized platform staff, server 110 module 160 accept or reject and publish or add or make available said accepted one or more actions or call-to-actions or reactions with said content 1410 for viewing users or users of network. For example user can suggest or select, customize and add call-to-actions “Invite friends at this place at Schedule”, “Send partnership request to display products”, “Make order and delivery from this place”, “Bookmark”, “Rate Place”, “Survey”, “Virtual Tour”, “Play game”, “Group Deal (Visit [8 More]) at Particular Date)”, “Book table or reservation at Date/Time”, “Send request to sell products”, “Send request to offer on-demand service”, “View Menu Give tips to person”.

In another embodiment creators, influencers, advertisers and users of network can suggest new types of call-to-actions with details to server 110 module 160 for review, moderation, revisions, updates, verification and acceptance and develop, test and make available accepted suggested call-to-actions for other users of network. In another embodiment share revenue with users who suggested and added one or more call-to-actions based on engagements and reach and conversion.

In another embodiment user can order, remove, view associated information including details, offer details, links or URLs, rules, policies, conditions, how to use or help, save, save link, bookmark, add to list, drag and drop on anywhere screen or pre-defined area to bookmark, report, remove, add to list, auto share pre-defined contacts, share to one or more contacts, and report icons or controls or associated actions.

In another embodiment displaying or ranking or filtering content associated actions or call-to-actions controls including icons based on current location, user profile including age, gender, interest, privacy settings, preferences, past interactions, transactions, reactions, communication, sharing, visits, engagements, participations with actions or brand, scanning of code or QR code, face or object, nearby contact persons, recognized voice or voice command.

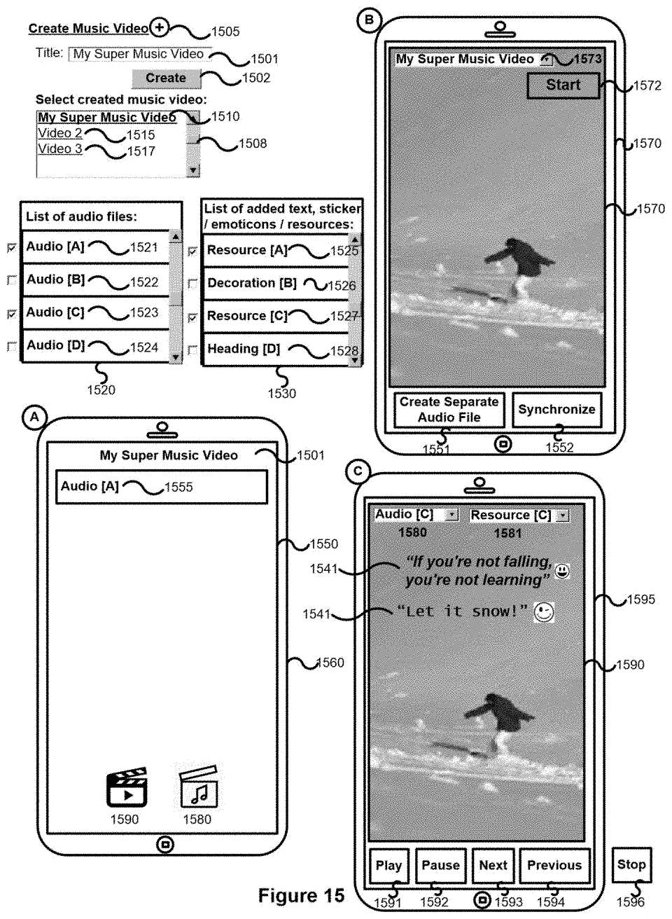

FIG. 15 is an illustrative diagram of a graphical user interface displayed on a user device 200 in accordance with various embodiments. User interface 1500, in some embodiments, is displayed on a display screen, such as display 210 of user device 200. User interface 1500 may include create music video button 1505. A user may select create music video button 1505, in some embodiments, to start a process of producing or making a music video (described in more detail below).

In some embodiments, graphical user interface 1500 may include list of created music videos 1508 including already created videos 1505 and 1510. User can edit, delete, preview selected video from list 1508.

Graphical user interfaces 1520 displayed on a user device 100 for selecting an audio track in accordance with various embodiments. Graphical user interface 1520 includes audio tracks 1521-1524 displayed therein, which are presented in response to a user selecting Create Music Video

Control or link or button 1505 on graphical user interface 1520. Audio tracks 1521-1524, in some embodiments, may be stored locally in local storage 286 on user device 200 or externally including connected or linked cloud storage or remote storage medium.

In some embodiments, in the event of selecting audio track 1521, that particular selected audio track 1521 will be selected as the basis for the music video that will be created.

In some embodiments, in response to selecting an audio track, a user may be able to select a section of the song that the music video will be created for. For example, audio track 1521 may be 2 minutes 10 seconds in length. A user may not want to create a music video that is that long, and instead may select, for example, a 1-minute part of audio track 1521 as a basis for the music video that will be created.

Graphical user interface 1550 displayed on a user device 200 presenting a selected audio track 1555 for a music video 1501 to be created in accordance with various embodiments. User interface 1550, in some embodiments, may include a listing of audio tracks that have been selected by a user to be used for a music video that will be created. For example, a user may select an audio track, such as audio track 1555, and that audio track may be displayed within user interface 1550 at listing.

In some embodiments, a user may wish to select a different audio track from audio tracks list (1521-1524). In some embodiments, a user may seek to modify a duration of the audio track they selected.

Graphical user interface 1500 may also include record video control or button 1590 and create music video control or button 1580. After audio listing 1555 has loaded, a user may select video take button 1590 to begin to record or capture video takes for a music video that will be created based on the selected audio track. After a user has determined that all the video takes for the music video have been recorded or captured, the user may select create music video button 1580 to create the music video based on the selected audio track and the captured video takes.

Graphical user interface 1500, in some embodiments, is an exemplary image capturing interface displayed on a user device (e.g., user device 200) in response to a user selecting video take button 1590. For example, in response to selecting video take button 1590 of user interface 1550, camera 244 on user device 200 may open or begin operating, and images that may be captured by camera 244 may be displayed within viewing area 1570 of user interface. In some embodiments, a user may switch between two or more cameras located on their user device by selecting switch camera button. For example, if user device 200 includes a front facing camera and a rear facing camera, switch camera button may allow the user to switch between the two.

In one embodiment a user may begin capturing images, such as video, by selecting start button 1572. For example, a user may begin to capture video for a music video to be created by first selecting start button 1572. In some embodiments, a countdown may appear within viewing area 1570 in response to a user selecting start button 1572. The countdown may enable the user to ready themselves for the image capturing process to begin. In some embodiments, after a user selects start button 1572, the selected first audio track (e.g., audio track 1521), may begin to play, and the image capturing process may capture images until the first audio track, or selected portion of the first audio track, has completed. In some embodiments, after adding or synchronizing selected first audio track with video, user can select second audio track 1523 and after a user selects synchronize button 1552, the selected second audio track (e.g., audio track 1523), may begin to play, and concurrently the recorded video playing until the second audio track, or selected portion of the second audio track, has completed.

In another embodiment a user may begin capturing images, such as video, by selecting start button 1572. For example, a user may begin to capture video for a music video to be created by first selecting start button 1572. In some embodiments, a countdown may appear within viewing area 1570 in response to a user selecting start button 1572. The countdown may enable the user to ready themselves for the image capturing process to begin. In some embodiments, after a user selects start button 1572, the selected first audio track (e.g., audio track 1521), may begin to play, and the image capturing process may capture images until the first audio track, or selected portion of the first audio track, has completed. Video without audio file and associated or linked first audio file created and in the event of instructing to play video, concurrently and automatically play associated first audio file in background so user feels both are playing together and are same. In some embodiments, after creating and associating first audio track with video, user can select second audio track 1523 and after a user selects create separate audio file button 1551, the selected second audio track (e.g., audio track 1523), may begin to play, and concurrently the recorded video playing until the second audio track, or selected portion of the second audio track, has completed. Video without audio file and associated or linked second audio file created and in the event of instructing to play video, concurrently and automatically play associated second audio file in background so user feels both are playing together and are same.

However, in some embodiments, one or more additional buttons, such as a pause, restart, stop button may be included within user interface.

By having the first audio track playing while the various video takes are captured, the video takes may be captured “in sync” with the first audio track and when second audio track playing while the already created video playing, the video “in sync” with the second audio track. This way, each video take, whether it begins at the beginning of the first audio track or at some other point of the first audio track, will be synchronized to the first audio track and whether it begins at the beginning of the second audio track or at some other point of the second audio track, will be synchronized to the second audio track. In the event of selection of first audio track play video with the first audio track and in the event of selection of second audio track play video with the second audio track.

In some of the embodiments, FIG. 15 (C) illustrates in the event of displaying particular video 1590, enable user to click or tap on “Play” button 1591 to play video 1590 or automatically start playing video 1590 with default selected or automatically determined audio track e.g. “Audio [A]” associated or synchronized with video 1590 or user can select audio track e.g. “Audio [C]” from list of audio tracks associated or synchronized audio tracks 1580. In the event of selecting of audio track e.g. “Audio [C]” 1580, automatically start playing video 1590 from start or from particular position time (change audio in middle of playing video or pause and restart video with changed audio track or use slider to change position of playing video) and automatically and concurrently start playing default selected synchronized audio track file e.g. “Audio [C]” associated with video 1580 from start or from particular position time same as video position time. In the event of clicking or tapping on “Play” button 1692, play video 1590 and play selected synchronized “Audio[C]” 1580. In the event of clicking or tapping on “Pause” button 1592, pause playing video 1590 and associated synchronized “Audio[C]” 1580. In the event of clicking or tapping on “Stop” button 1596, stop playing video 1590 and associated synchronized “Audio[C]” 1580 and display next video or short video in the feed. In the event of clicking or tapping on “Next” button 1593, stop playing video 1590 and associated synchronized “Audio[C]” 1580 and displaying next video or short video in the feed and automatically start playing displayed video or short video and start playing associated synchronized audio track. In the event of clicking or tapping on “Previous” button 1594, stop playing current video 1590 and associated synchronized “Audio[C]” 1580 and displaying previously displayed and played video or short video in the feed and automatically start playing previously displayed video or short video and start playing associated synchronized audio track.

At present single video have single synchronized audio track. In some of the embodiments, present invention teaches new format of video in which one or single video may have multiple or one or more synchronized audio tracks. When user play video, play associated default synchronized audio or enable user to select audio or automatically select audio based on plurality of factors, triggering of triggers and rules and play video with selected synchronized audio (from same position time of video e.g. video is playing from 10 seconds then synchronized audio track is also start playing from 10 seconds). System packaged video with one or more synchronized audio tracks. System provides new type of control comprises list of one or more synchronized audio tracks with video, for enabling user to click or tap on control and select particular audio track from list and play video with said select audio track or in middle or next time can select another audio track and can play video with said select another audio track.

In another embodiments, FIG. 15 (C) illustrates in the event of displaying particular video 1590, enable user to click or tap on “Play” button 1591 to play video 1590 or automatically start playing video 1590 and automatically and concurrently start playing default or automatically determined selected audio track file e.g. “Audio [A]” associated with video 1590 or user can select audio track e.g. “Audio [C]” associated audio track 1580 from list of audio tracks. In the event of selecting of audio track e.g. “Audio [C]” 1580, automatically start playing video 1590 from start or from particular position time (change audio in middle of playing video or pause and restart video with changed audio track or use slider to change position of playing video) and automatically and concurrently start playing default selected audio track file e.g. “Audio [C]” associated with video 1580 from start or from particular position time same as video position time. In the event of clicking or tapping on “Play” button 1692, play video 1590 and concurrently play selected “Audio[C]” file 1580. In the event of clicking or tapping on “Pause” button 1592, pause playing video 1590 and associated “Audio[C]” file 1580. In the event of clicking or tapping on “Stop” button 1596, stop playing video 1590 and associated “Audio[C]” file 1580 and display next video or short video in the feed. In the event of clicking or tapping on “Next” button 1593, stop playing video 1590 and associated “Audio[C]” file 1580 and displaying next video or short video in the feed and automatically start playing displayed video or short video and start playing associated audio track file. In the event of clicking or tapping on “Previous” button 1594, stop playing current video 1590 and associated “Audio[C]” file 1580 and displaying previously displayed and played video or short video in the feed and automatically start playing previously displayed video or short video and start playing associated audio track file.

At present single video have single synchronized audio track. In some of the embodiments, present invention teaches new format of video in which one or single video may associate or related with multiple or one or more audio tracks files (having same length as of video length). When user play video, automatically and concurrently playing associated default audio file or enable user to select audio file or automatically select audio based on plurality of factors, triggering of triggers and rules and play video with selected audio (from same position time of video e.g. video is playing from 10 seconds then audio file is also start playing from 10 seconds). System packaged video with one or more audio tracks files or video metadata contains links or unique name and details of linked or associated or related audio files. System provides new type of control comprises list of one or more audio tracks linked or associated or related with video, for enabling user to click or tap on control and select particular audio track from list and play video and concurrently play said selected audio track or in middle or next time can select another audio track file and concurrently play video with said selected another audio track file.

In another embodiment's user can add and associate one or more sets of video augmentation resources including text (associated font, size, color, style), emoticons, emojis, stickers, animations. Viewing user can use and view default set of video augmentation resources 1541 on video while playing video or viewing user can select particular set of video augmentation resources 1541 from resources list 1581 from video and view said selected set of video augmentation resources on video while playing video. In another embodiments user can view automatically selected resource set on currently playing video from list of associated sets or resources, wherein automatically select set of resource based on selected audio associated resource set, user profile (age, gender, inters, home and work location), current date and associated event, current location, place or pre-defined geofence, current status, past logged viewing of contents analytics, logged user activities, actions and transactions. In another embodiment users of network, server admin(s) and advertiser provided can submit and associate one or more resources for verification and make available on video for selection for other viewing users of network.

In some embodiments enabling creator to associate metadata with audio track including gender, age range, interest, location, language, religion, education, type of activity(ies), date and time ranges, day, date e.g. event. So server or system can automatically select audio track based on matching user data, current status, activities, location & updates and user profile(s) including age, gender, interest, location, language, religion, education, current place or place of business or pre-defined geofence, current activity, current day, current time, current date associated event (e.g. birthday or festival)) with audio associated metadata including gender, age range, interest, location language, religion, education, type of activity, current day, current time, current date associated type of event or festival, place or place of business or pre-defined geofence from list of audio tracks associated by creator to identify suitable audio track for user for currently viewing video or short video. In some embodiment dynamically and real-time insert voice in audio while playing video. For example when user [Yogesh] visit ““McDonald” store then displaying to user “McDonald” related video in feed and in the event of start playing of audio, dynamically insert computer generated or user pre-created in user's voice or pre-created or pre-selected or pre-associated voice or pre-set music in audio at particular placeholder or marked position (e.g. at particular number of second) in video or voice field in voice script of video e.g. “Welcome to” [Place] “McDonald,” [Visitor Name]. While playing audio or music and voice audio, mix “Welcome to” [“Mulund”] “McDonald,” [“Yogesh”] in English or mother tongue of user [Yogesh] e.g. Gujrati language and personalized information in voice and text or emoticons or multi-media format e.g. “Your Favorite Super Coffee”. If in the event of identifying nearby contacts of user e.g. [Yogesh] nearby contacts are user [Amita] then identifying relationship and based on monitored and tracked user device current location identify number of times of visits of current place e.g. McDonald and inserted voice in currently viewing video may be comprise: “Welcome [Yogesh] and [Amita] for [12^{th} time] at McDonald. Don't forget to order your favorite super coffee” based on viewing user's privacy settings, profile, connections details (name, profile (birth date, anniversary, home and work address, role, position), profile photo, relationships, location, checked-in places, status, updates), logs including visited places, activities, actions, participations, transactions, status, updates, communication, collaboration, sharing, reactions, one or more types of detail user profile including general, social network, health, physical, travel, work & job, business profile, liked, purchased and interest to buy products, services, persons, events, movies, food items and user related data and activities details from one or more linked or connected system, applications, websites, servers, databases and devices. In another embodiment video comprises different types of video takes. Enabling creator to make video or part of video or particular one or more video takes of video or create customize and personalize short video. Based on user and user connected users ‘related data, create real-time customizable video for viewing users of network. In an embodiment user can pre-create, select type and submit plurality types of voice and video or video take(s) of expressions, emotions e.g. eating food, attitude, praising something, good morning, good after, good evening, good night, have a good day, wow, like, tasty, congratulation happy birth day, happy marriage anniversary, liked or disliked something, interest to buy expression of user in user's voice (e.g. local language) and face and body form) and allow video creator to dynamically and real-time add particular type of pre-created expressions and emotions in currently viewing video of said creator. For example, at the end of viewing particular favorite food dish of user add “wow” type voice in user's pre-created voice in currently viewing video for said viewing user by creator of said video. In another embodiment based on privacy settings access, use, dynamically and real-time add in currently viewing video connected users of user's pre-created emotions, expressions in voice and video take(s) while displaying video to user. In another example in marketing of particular gift product related short video use user's near contacts' name, birthday or anniversary and add dynamically add voice before few days of birthday e.g. “[Yogesh] after [4 days] your [anniversary], gift this neckless” in local language and music. In another embodiment instructing user to provide voice or video takes for particular words, dialogues and sentences with expression, emotion, style, attitude type.

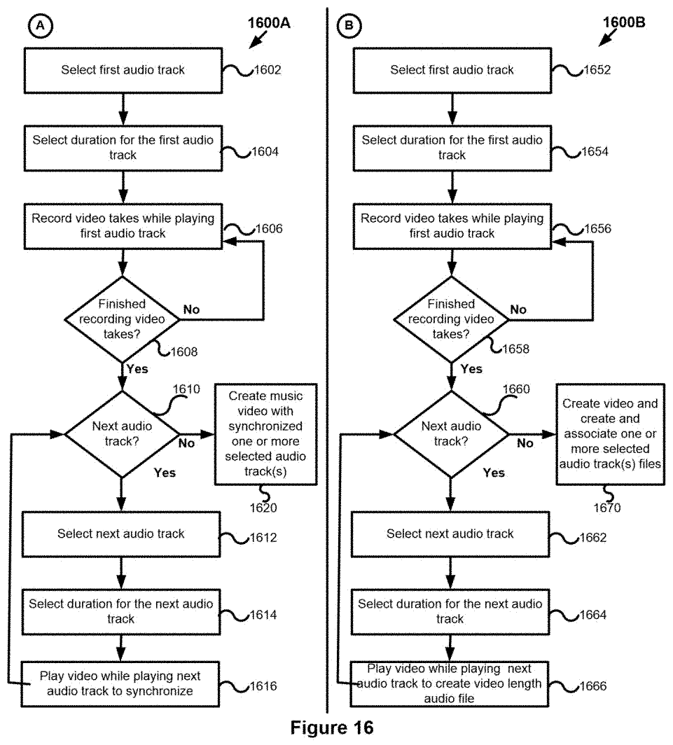

FIG. 16 (A) is an illustrative flowchart of a process for creating music videos in accordance with various embodiments. Process 1600A may begin at step 1602. At step 1602, a first audio track may be selected. For example, a user may select first audio track stored on their user device to be used as a basis for creating a music video. As another example, the selected first audio track may be stored on an external device, such as the audio track may be stored on a cloud storage system.

Process 1600A may then proceed to step 1604. At step 1604, a duration may be selected for the first audio track selected at step 1602. For example, a user may decide to only include a portion of the selected first audio track for the music video that will be created. A user may modify a start point and end point for the particular first audio track. As yet another example, step 1604 of process 1600A may be omitted in some embodiments. For this particular scenario, the duration of the selected first audio track may default to the entire audio track's duration, and the user may not be required to select a beginning or end to the audio track for the music video. In some embodiments, step 1604 may be skipped or omitted and the duration of the selected audio track may default to be the entire duration of the audio track.

At step 1606, a video take may be captured while the selected first audio track plays. In some embodiments, in response to selecting the first audio track and/or in response to selecting a duration for a first audio track (e.g., steps 1602 and/or 1604), an option to capture a video take may be presented to a user. A user may select the capture video take option to begin to capture video for a music video to be created based on the selected first audio track. For example, a user may select start button 1572, or capture button to begin to capturing video takes.

As a user begins to capture video for a video take, the selected first audio track, or selected section of the first audio track selected, may begin playing. For example, after a user selects capture button, the selected first audio track may begin to play. In some embodiments, by playing the selected first audio track while a video take is captured, that video take may be synchronized with the first audio track automatically. For example, each moment of the captured video take may be synchronized to a corresponding section of the selected first audio track, as the video take is captured in time with the first audio track as it plays. In some embodiments, a position indicator may indicate a current position of the audio track playing while the video take is being captured.

Process 1600A then proceeds to step 1608. At step 1608, a determination is made as to whether or not the user is finished capturing video takes. If, at step 1608, it is determined that the user is not finished capturing video takes for the music video to be created, then process 1600A returns to step 1606 and additional video takes are captured. For example, after a user finishes capturing Take 1 seen, the user may decide to capture another video take. The user may then repeat step 1606 such that a new video take is captured (e.g., Take 2), where the selected first audio track also plays while the new video take is being captured. For example, Take 2 as seen in may be a second video take captured after a user has captured Take 1. The user may capture as many additional video takes as desired. In some embodiments, a user may delete one or more video takes and/or replace one or more video takes with one or more additional video takes.

If, however, at step 1608, it is determined that the user has captured all the video takes needed to create the music video of his/her choice, then process 1600A proceeds to step 1610. At step 1610, a determination is made as to whether or not the user wants to add second audio track. If, at step 1610, it is determined that the user wants to add second audio track for the music video, then at step 1612 user can select second audio track 1523 and then at step 1614 user can select duration for the next audio track (describe in detail in above) and then in step 1616 as a user begins to play video, the selected second audio track, or selected section of the second audio track selected, may begin playing. For example, after a user selects video play button, the selected second audio track may begin to play. In some embodiments, by playing the selected second audio track while the video is playing, that video may be synchronized with the second audio track automatically.

At step 1610, a determination is made as to whether or not the user wants to add next or third audio track. If, at step 1610, it is determined that the user does not wants to add next or third audio track for the music video, then at step 1620, a music video is created with synchronized one or more selected audio track(s)

In some embodiments, user can select audio track from list of synchronized audio tracks associated with video and in the event of starting of video play or selecting video play, automatically start playing associated selected audio track.

FIG. 16 (B) is an illustrative flowchart of a process for creating music videos in accordance with various embodiments. Process 1600B may begin at step 1652. At step 1652, a first audio track may be selected. For example, a user may select first audio track stored on their user device to be used as a basis for creating a music video. As another example, the selected first audio track may be stored on an external device, such as the audio track may be stored on a cloud storage system.

Process 1600B may then proceed to step 1654. At step 1654, a duration may be selected for the first audio track selected at step 1652. For example, a user may decide to only include a portion of the selected first audio track for the music video that will be created. A user may modify a start point and end point for the particular first audio track. As yet another example, step 1654 of process 1600B may be omitted in some embodiments. For this particular scenario, the duration of the selected first audio track may default to the entire audio track's duration, and the user may not be required to select a beginning or end to the audio track for the music video. In some embodiments, step 1654 may be skipped or omitted and the duration of the selected audio track may default to be the entire duration of the audio track.

At step 1656, a video take may be captured while the selected first audio track plays. In some embodiments, in response to selecting the first audio track and/or in response to selecting a duration for a first audio track (e.g., steps 1652 and/or 1654), an option to capture a video take may be presented to a user. A user may select the capture video take option to begin to capture video for a music video to be created based on the selected first audio track. For example, a user may select start button 1572, or capture button to begin to capturing video takes.

As a user begins to capture video for a video take, the selected first audio track, or selected section of the first audio track selected, may begin playing. For example, after a user selects capture button, the selected first audio track may begin to play. In some embodiments, by playing the selected first audio track while a video take is captured, automatically create or append first audio file.

Process 1600B then proceeds to step 1658. At step 1658, a determination is made as to whether or not the user is finished capturing video takes. If, at step 1658, it is determined that the user is not finished capturing video takes for the music video to be created, then process 1600Bs returns to step 1656 and additional video takes are captured. For example, after a user finishes capturing Take 1 seen, the user may decide to capture another video take. The user may then repeat step 1656 such that a new video take is captured (e.g., Take 2), where the selected first audio track also plays while the new video take is being captured. For example, Take 2 as seen in may be a second video take captured after a user has captured Take 1. The user may capture as many additional video takes as desired. In some embodiments, a user may delete one or more video takes and/or replace one or more video takes with one or more additional video takes.

If, however, at step 1658, it is determined that the user has captured all the video takes needed to create the music video of his/her choice, then process 1600A proceeds to step 1660. At step 1660, a determination is made as to whether or not the user wants to add second audio track. If, at step 1660, it is determined that the user wants to add second audio track for the music video, then at step 1662 user can select second audio track 1523 and then at step 1664 user can select duration for the next audio track (describe in detail in above) and then in step 1666 as a user begins to play video, the selected second audio track, or selected section of the second audio track selected, may begin playing. For example, after a user selects video play button, the selected second audio track may begin to play. In some embodiments, by playing the selected second audio track while the video is playing, automatically creating or appending second audio track file.

At step 1660, a determination is made as to whether or not the user wants to add next or third audio track. If, at step 1660, it is determined that the user does not wants to add next or third audio track for the music video, then at step 1670, an independent video files is created with one or more independent audio track file(s)/

In some embodiments, in the event of receiving instruction to play video and receiving instruction to play selected audio file, then automatically and concurrently start playing video file as well as selected audio file.

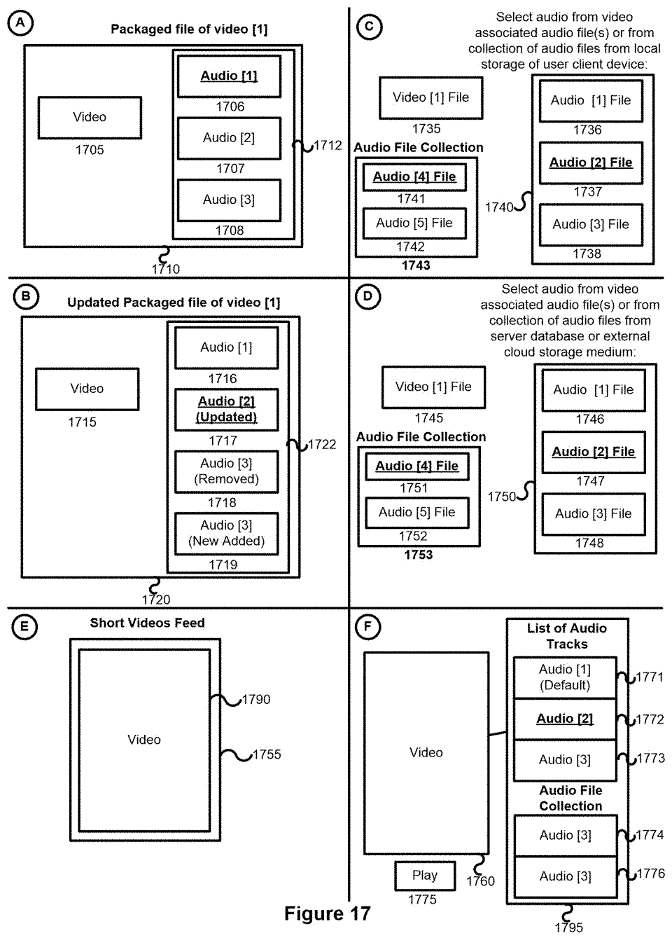

FIG. 17 illustrates various embodiments. In one embodiment FIG. 17 (A) illustrates packaged video file 1710 comprises video contains series of images 1705 and one or more synchronized audio tracks and in the event of receiving instruction to play video, play video and automatically play associated default audio track 1706 or in the event of receiving instruction to select audio track 1706 from list of audio tracks, play video 1705 and automatically play selected audio track 1706.

In another embodiment FIG. 17 (B) illustrates enabling to add, remove and update one or more audio tracks from packaged video file 1720. For example enable user or creator or owner of video to update packaged video file 1720 comprises video contains series of images 1715 and one or more synchronized audio tracks including updated audio track 1717, removed audio track 1718 and newly added audio track 1719. In the event of receiving instruction to play video 1715, play video and automatically play associated default audio track 1716 or in the event of receiving instruction to select audio track 1717 from list of updated audio tracks 1722, play video 1715 and automatically play selected audio track 1717.

In another embodiment FIG. 17 (C) illustrates video file 1735 without audio or muted audio or removed audio or packaged synchronized one or more audio tracks or associated default audio track. In the event of receiving instruction to play video 1735, play video file 1735 (without audio or playing integrated or synchronized audio within video or muted) and automatically play associated default independent audio track file 1736 (non-packaged with video) from local storage of client device or in the event of receiving instruction to select audio track file 1737 from list of independent audio tracks files 1740 (non-packaged with video) pre-associated with video, play video 1735 and automatically play selected audio track 1737 from local storage of client device or in the event of receiving instruction to select audio track file 1741 from collection of independent audio tracks files 1743 (non-packaged with video) non associated with video 1735, play video 1735 and automatically play selected audio track 1741 from local storage of client device, wherein non-associated audio file playing length is equal to video playing length and start from beginning and end or pause or stop when video ends or paused or stopped or restart from same position from last paused.

In another embodiment FIG. 17 (D) illustrates video file 1745 without audio or muted audio or removed audio or packaged synchronized one or more audio tracks or associated default audio track. In the event of receiving instruction to play video 1745, play video file 1745 (without audio or playing integrated or synchronized audio within video or muted) and automatically play associated default independent audio track file 1746 (non-packaged with video) from server database or storage or external database or storage including cloud storage or in the event of receiving instruction to select audio track file 1747 from list of independent audio tracks files 1750 (non-packaged with video) pre-associated with video, play video 1745 and automatically play selected audio track 1747 from server database or storage or external database or storage including cloud storage or in the event of receiving instruction to select audio track file 1751 from collection of independent audio tracks files 1753 (non-packaged with video) non associated with video 1745, play video 1745 and automatically play selected audio track 1751 from server database or storage or external database or storage including cloud storage, wherein non-associated audio file playing length is equal to video playing length and start from marked position or start from beginning and end or pause or stop when video ends or paused or stopped or restart from same position from last paused.

In another embodiment receiving instruction to select audio track based on receiving instruction from user or viewing user of video to select audio track or automatically receiving instruction to select audio track based on audio track selected by user, selected by user based on voice command or providing eye or face expression command based on recognizing pre-defined eye and face movement, randomly select audio track, select suggested audio track, automatically select audio track from rank wise list of pre-selected audio tracks, select audio track based on current location or current location associated identified place or identified pre-defined geofence associated audio track, nearby identified contact associated or pre-set audio track, change audio track after each view video, change of time or time range of day including morning, afternoon, evening, night, date, time, date associated festival or event, schedule, identified current event, profile of user and connected users including age, gender, interest, preferences, languages or preferred language(s), past listened or bookmarked or related to particular singers or artists or movies, liked audio tracks or a music or a songs or a voice by user and connected users of user, current trend specific identified an audio or a music or a song or a voice, home and work location and address, education, income range, skills and triggering of one or more triggers and rules.

In another embodiment FIG. 17 (E) illustrates exemplary video feed or video presentation graphical user interface 1755, wherein the server 110 receiving request to display video 1790, wherein video 1790 is without integrated or synchronized audio or muted and receiving request to select default 1746 or manually or automatically select audio file 1751 from plurality of audio files 1753 or receiving request to select audio file 1747 from set of audio files 1750 associated with video 1790. Server 110 downloading video 1790 and one or more audio files 1747 or 1751 to user client device 200 and displaying requested video 1790 and enable to select audio track 1747 or 1751 from list of audio tracks and in the event of receiving instruction to play video 1790, start playing video 1790 and concurrently automatically start playing associated default audio 1746 or user selected audio 1747 or 1751. In an embodiment in the event of receiving instruction to pause or stop video, pause playing video and concurrently automatically pause or stop playing associated default audio or user selected audio. In an embodiment in the event of receiving instruction to restart paused video, start playing video and concurrently automatically start playing associated default audio or user selected audio. In an embodiment in the event of receiving instruction to play next video, stop currently playing video and concurrently automatically stop playing associated default audio or user selected audio and start playing next video and concurrently automatically start playing associated default audio or user selected audio. In an embodiment in the event of ending of video and audio, automatically receiving instruction to play next video, downloading or displaying requested next video and one or more audio files and start playing video and concurrently automatically start playing associated default audio or user selected audio. In an embodiment in the event of receiving instruction to play video from particular selected position, start playing video from particular selected position and concurrently automatically start playing associated default audio or user selected audio from same position as particular selected position of video.

In another embodiment FIG. 17 (F) illustrates new video 1760 integrated list control 1795, wherein user can select audio track 1772 from list of displayed audio tracks 1795 and select “Play” button or control 175 to start playing video 1760 and in the event of clicking or tapping on “Play” button or control 175, start playing video 1760 and concurrently also automatically start playing selected audio file 1772 associated or non-associated with video 1760 from local or server or remote or external storage medium.

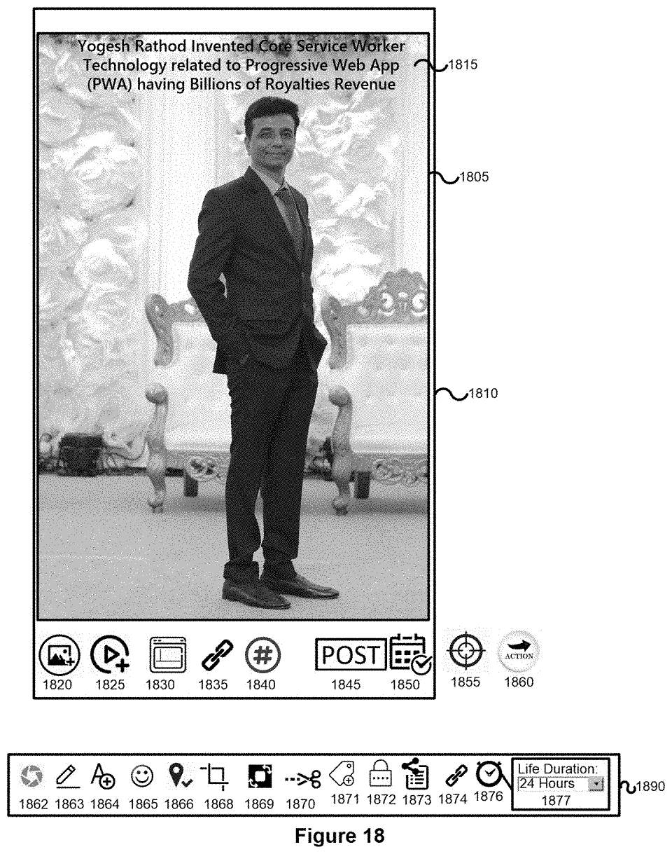

FIG. 18 illustrates graphical user interface wherein user can draft or prepare microblog post 1805 and apply various types of settings by using various options and settings 1890. User can add photo 1820, video 1825, use template or ready content 1830 from suggested list of contents or templates, add uniform resource locator (URL) or link 1835, add one or more tags or hashtags, keywords, categories, taxonomies 1840, set schedule of posting 1850, select target viewers or audience including followers, contacts or connections, target criteria specific users of network, wherein target criteria comprises interests keywords, user profile attributes, all users of network and structured query language (SQL) specific users of network. In another embodiment user can add one or more actions with post style microblog post, so viewing user can access or take said post associated said actions, reactions, functions, user interface. Microblog post may comprise photo and text, short video and text, ephemeral story and text, video and text and links or URLs, emoticons, location information, tags and user actions. User can apply filters 1862, draw in post 1863, add text 1864, emoticon 1865, add place or location 1866, crop 1868, edit 1869, edit video 1870, add tags 1871, apply password 1872, share with one or more social networks or destinations 1873, add link(s) 18740, set ephemeral duration or settings 1877. User can post or publish prepared post 1805 by selecting post control 1845. If user set schedule for publishing post then post will publish as per pre-set schedule 1850.

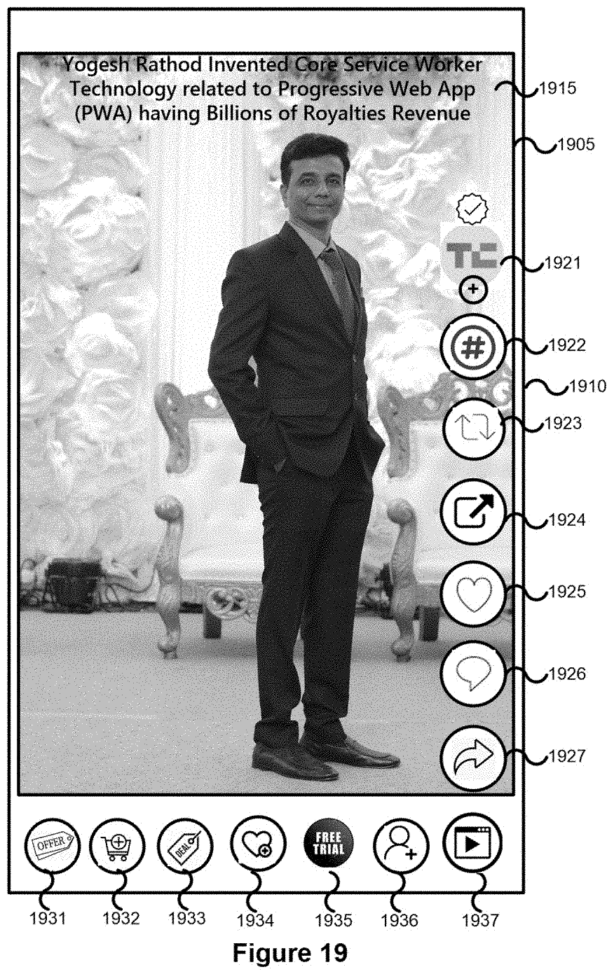

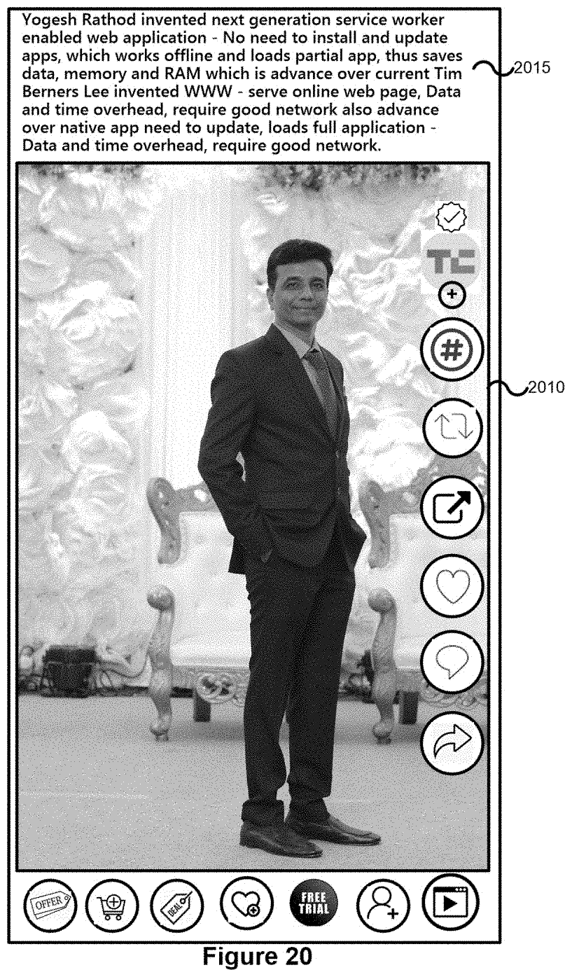

FIGS. 19-20 illustrates viewing users of post can view microblog post 1905, view associated text content 1915, view or access profile 1921 of source of post 1905, view associated tags 1922, can use reshare option 1923 for resharing post 1905, use like action 1925 to like post 1905, use resharing of post option 1927 for sharing post 1905 in present network or on selected one or more applications, websites, social networks and destinations. In another embodiment user can access post 1905 associated one or more actions including access post associated offer 1931, purchase displayed or in-image products 1932, claim or get or save associated voucher or coupon 1933, add to one or more types of list 1934, claim free trail 1935, and like.

In an embodiment display full screen post of microblog including full screen photo or video and overlay pre-set number of characters of text 1915 including location information, emoticons and uniform resource locator (URL) for opening associated web page for detailed blog or news or contents or opening user interface or application. In an embodiment in the event of selecting uniform resource locator (URL) control 1924, open uniform resource locator (URL) associated web page or website or resources for detailed blog or news or contents or opening user interface or application. In another embodiment in the event of identification of more than one uniform resource locators (URLs), generating menu and enabling user to select uniform resource locator (URL) control to open menu and select menu item to open particular menu item associated selected uniform resource locator (URL). In another embodiment display post of microblog including photo or video 2010 and separately display pre-set number of characters of text 2015 above or bottom photo or video. In an embodiment enabling user to view post associated hashtag associated posts by selecting post associated hashtag control 1922. In another embodiment in the event of identification of more than one hashtags, generating menu and enabling user to select hashtag control to open menu and select menu item to view particular menu item associated selected hashtag associated posts.

In an embodiment automatically identify posts for presentation based on triggers, wherein triggers comprises recognized voice associated keywords, voice command, identified keywords based on scanned objects, face and text based on object and face or body parts recognition and optical characters recognition, user associated information and logged data from linked systems, accounts, applications, databases, servers, wherein information comprises search keywords, activities, transactions, actions, call-to-actions, participations, sharing, communications, interaction with entities, and locations including visited places, selected or searched place on map, current places, like places and one or more types of digital activities and actions.

In an embodiment user can swipe left to prepare, schedule and post new posts or swipe right to view current post associated contextual posts from same or other sources.

In another embodiment automatically generate microblog posts based on each identified uniform resource locator (URL) of web page and automatically extracting webpage associated resources including photo(s), video(s) and headlines or key information or abstract and generating post(s) and in another embodiment automatically post or publish or present posts for viewing users of network including followers, contacts or connections, target criteria specific users or contextual users of network.

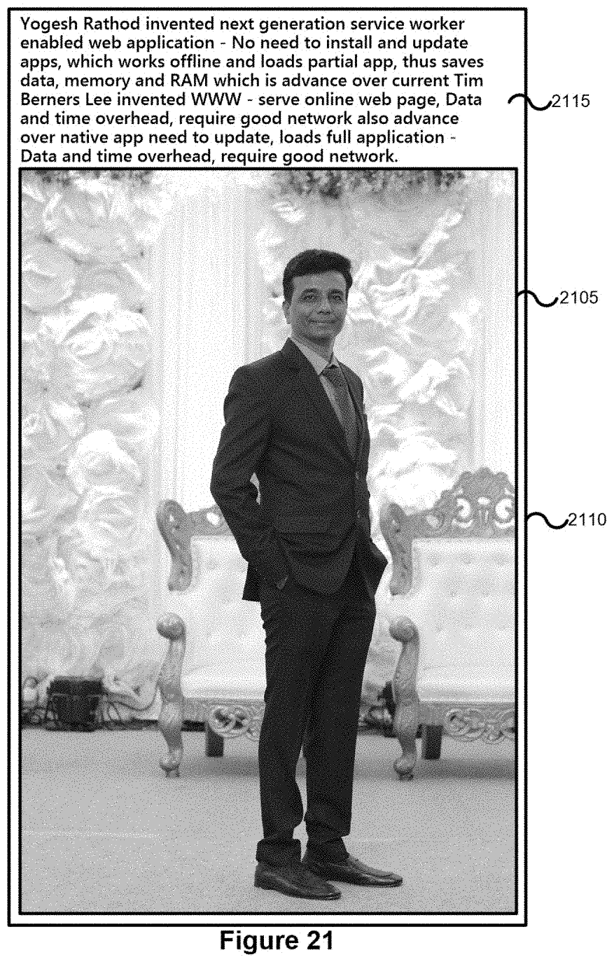

FIG. 21 illustrates graphical user interface (GUI) wherein user can view text content 2115 of microblog and can select or tap on content 2115 to visit associated or linked website/webpage/hastag(s) associated contents. In another embodiment user can select or tap on microblog post or post associated photo or video 2105 to view next microblog post or based on pre-set duration settings, automatically display next microblog post after pre-set duration interval and in the event of tap on post pause timer and in the event of again tap on post, restart timer. In another embodiment enabling user to manually view next by swipe down or view previous post by swipe up. In another embodiment enabling user to swipe left to create post or short video of microblog and associate selected actions. In another embodiment enabling user to swipe rights to access all other features and actions including features and actions related to currently viewing post or swipe right to view contextual microblog posts related to user. In another embodiment enabling user to long press or based on pre-defined face reaction or voice command (e.g. “like or love” to indicate like). In another embodiment in the event of like make user as follower of said currently viewing post associated source. In another embodiment per microblog post allow one photo or video and allow pre-set number of characters including text and uniform resource locator (URL). In another embodiment in the event of drag on post and drop on particular pre-defined area on post or icon on post reshare microblog post.

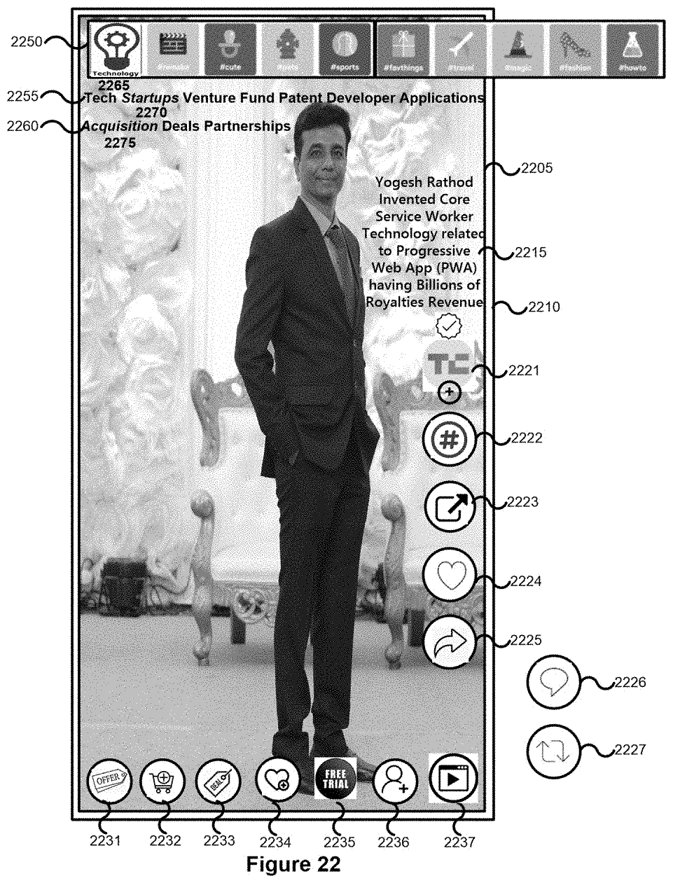

FIG. 22 illustrates graphical user interface (GUI) wherein user can select main category 2265 from list of main category 2250, select sub-category 2270 from said selected main category associated list of sub-categories 2255, select sub-sub-category 2275 from said selected sub-category 2270 associated list of sub-categories 2260 and based on said selections identify microblog posts or contents and start displaying first post 2205 from identified posts. In an embodiment automatically displaying next post from identified posts after preset duration or after end of short video or after pre-set duration (e.g. 20 second), automatically display next post from identified posts. User can tap on post to pause and tap again on post to restart displaying of posts from identified posts or swipe down for next or swipe up to view previous post from identified posts.

In another embodiment allowing pre-eligible and verified users to post microblog posts or post microblog posts under allowed one or more pre-defined categories or keywords. In another embodiment categories may comprise system categories including suggested (For You) for user, followed, preference based, local, news and liked. In another embodiment categories may comprise collaboratively suggested categories and keywords by user and published by server admin after verification.

In another embodiment enabling viewing user to view or access profile 2221 of source of post 2205, view associated tags 2222, can use reshare option 2223 for resharing post 2205, use like action 2225 to like post 2205, use resharing of post option 2227 for sharing post 2205 in present network or on selected one or more applications, websites, social networks and destinations. In another embodiment user can access post 2205 associated one or more actions including access post associated offer 2231, purchase displayed or in-image products 2232, claim or get or save associated voucher or coupon 2233, add to one or more types of list 2234, claim free trail 2235, and like.

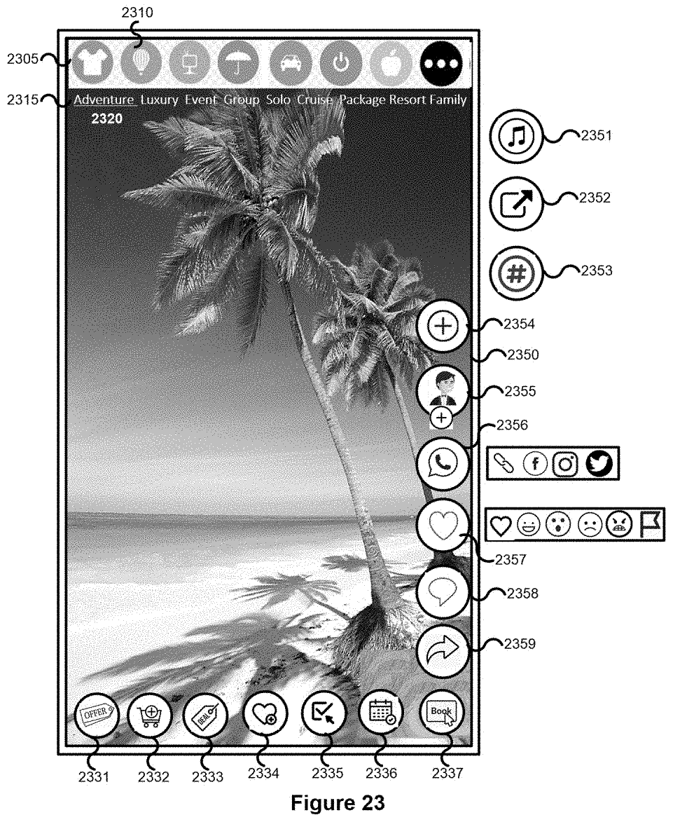

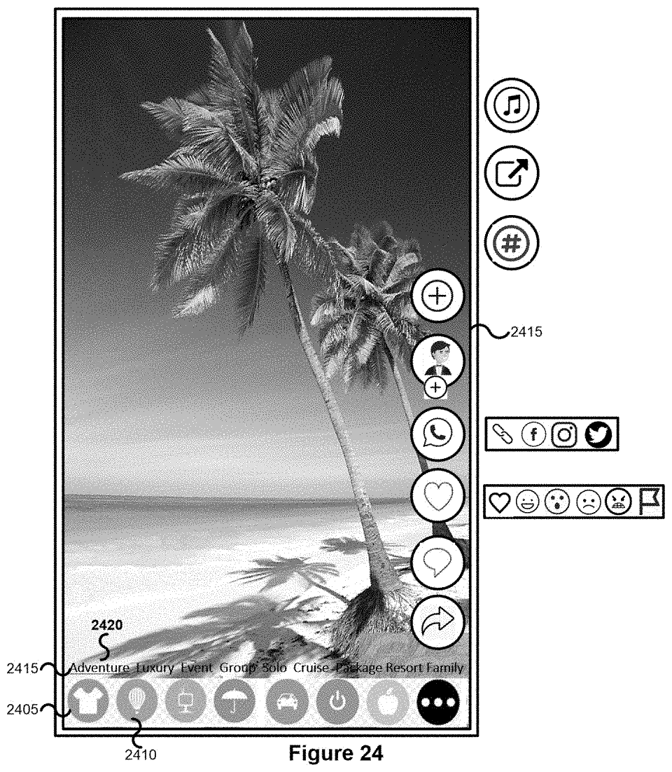

FIGS. 23-24 illustrates full screen short video feed graphical user interface (GUI) wherein user can select category 2310/2410 from list of categories 2305/2405 and/or select sub-category 2320/2420 from list of sub-categories 2315/2415 and view selected category 2310 and/or select sub-category 2320 associated short videos, wherein in the event of selection of category 2310 and/or selection of sub-category 2320, identify associated short videos and displaying first short video 2350 from identified set of short videos and in the event of end of video, automatically displaying second short video. In an embodiment tap on screen of short video 2350, pause video and in the event of further tap on screen of short video 2350 restart playing of short video. In the event of swipe down show next or swipe up show previous short video from set of identified short videos. In another embodiment user can add or play music 2351 and can also share with newly selected music, open associated uniform resource locator (URL) associated web page 2352, access associated hashtag 2353 related contents including short videos, follow source 2354, view source profile 2355, reshare via one or more 3^{rd} parties applications, services, severs, web sites and social networks 2356, provide reaction 2357, make comment 2358, share via one or more options 2359. In another embodiment user can select and access one or more associated actions including get offer 2331, buy 2332, claim coupon 2333, add to like list 2334, schedule 2336, book 2337.

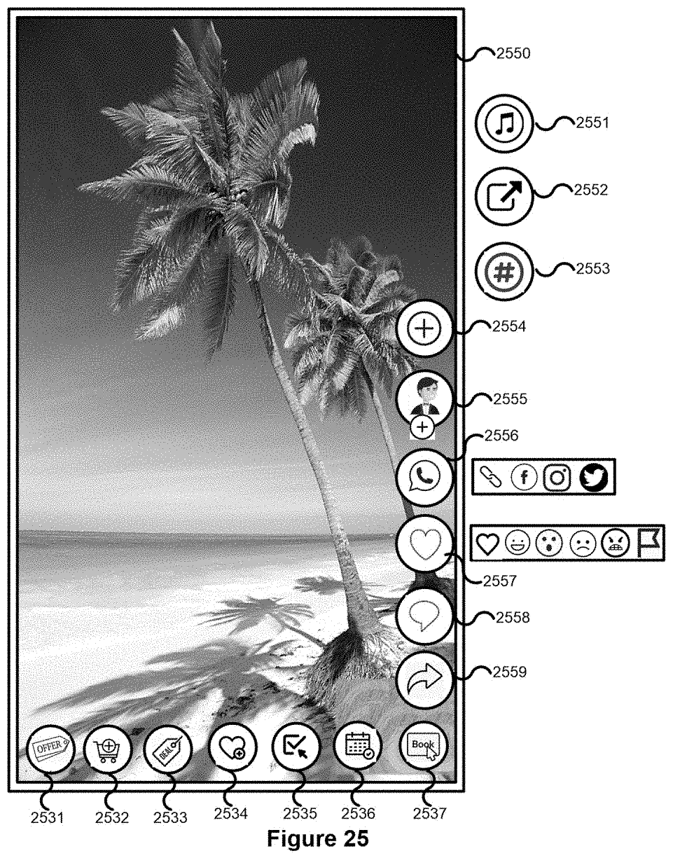

FIG. 25 illustrates graphical user interface 2550 wherein user can view story of short videos, each story comprises more than one short videos or series of photos. In another embodiment in the event of displaying first story, starting playing of first video of first story and in the event of ending of first video of first story, automatically displaying second video of first story. In another embodiment in the event of tap on screen displaying third video of first story. In another embodiment in the event of swipe down displaying first video of second story and in the event of ending of first video of first story, automatically displaying second video of first story. In another embodiment in the event of tap on screen displaying third video of second story. In another embodiment in the event of swipe up displaying previous i.e. second video of second story. In another embodiment in the event of long press on screen and release pause currently playing short video and in the event of further tap on screen restart playing of short video. In another embodiment user can add or play music 2551 and can also share with newly selected music, open associated uniform resource locator (URL) associated web page 2552, access associated hashtag 2553 related contents including short videos, follow source 2554, view source profile 2555, reshare via one or more 3^{rd} parties applications, services, severs, web sites and social networks 2556, provide reaction 2557, make comment 2558, share via one or more options 2559. In another embodiment user can select and access one or more associated actions including get offer 2531, buy 2532, claim coupon 2533, add to like list 2534, schedule 2536, book 2537. In another embodiment identifying stories for display based on following of sources, suggested based on user data, profile, logged activities, preferences and privacy settings, user related data from linked sources, systems, servers, websites, applications and databases.

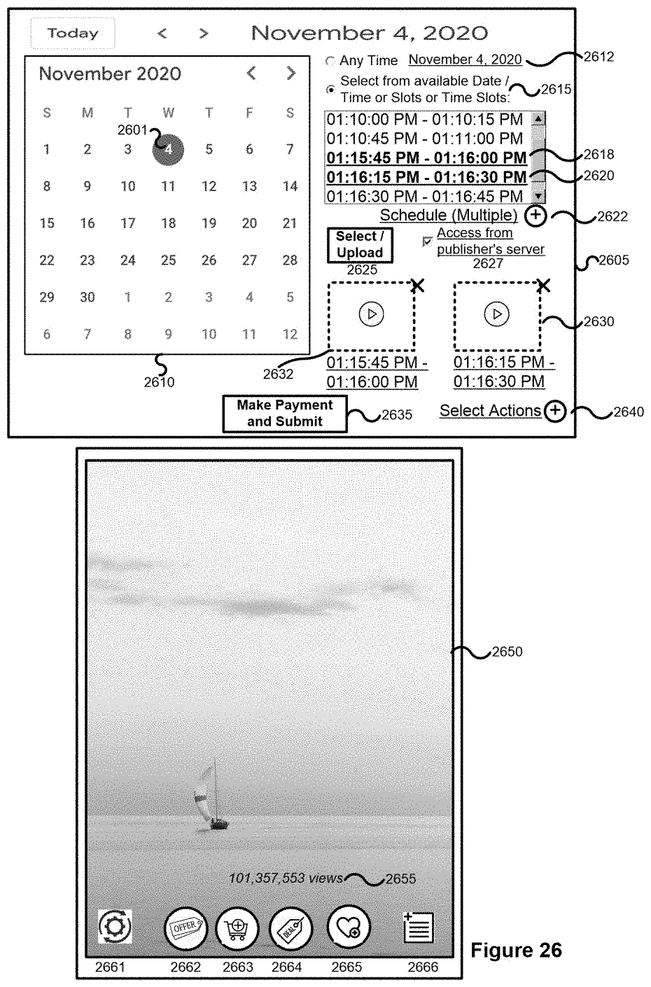

FIG. 26 illustrates self-service graphical user interface for broadcasting, publishing scheduled short video or content and associated action(s) as per schedule, wherein publisher or user or admin can select date 2601 from available date 2610 and select time 2618 or select anytime 2612 at said selected date 2601. In an embodiment publisher can select short video for upload and associate with said selected date and time said selected video 2632. Publisher can select other date and/or time 2620 and can select short video for upload and associate with said selected date and time said selected content including short video 2630. In an embodiment instead of uploading video publisher can select access short video from defined server or website or application or database or storage medium 2627. Publisher can select user actions and associate with one or more content including short videos 2630/2632. Publisher can select make payment and submit control or button 2635 to open payment and submission user interface 2635 for providing payment amount, details and submit for said scheduled publication of said selected and uploaded content including short video for viewing users of network. Server 115 store schedule, associate content including short video and action(s) and other details.

In an embodiment viewing users of network can view said contents including short video 2650 as per pre-scheduled date 2601 and time 2618 set by associated publisher. In an embodiment user can view and access said contents including short video 2650 associated actions including offer 2662, shop or buy 2663, voucher or coupon 2664, add to like 2665 and add to list 2666.

In an embodiment when user opens application or user interface for viewing short videos, then system identifies short video based on current date and time and short video associated date and time and further identify position of identified short video based on current time and start playing short video from said identified position. In an embodiment in the event of ending of current time specific first video automatically presenting current time specific second short video.

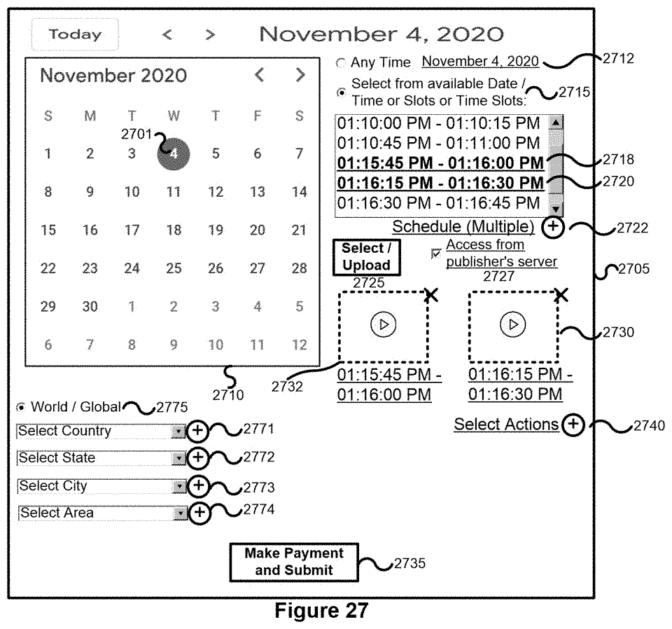

FIG. 27 illustrates self-service graphical user interface for broadcasting, publishing scheduled short video or content and associated action(s) as per schedule, wherein publisher or user or admin can select date 2701 from available date 2710 and select time 2718 or select anytime 2712 at said selected date 2701. In an embodiment publisher can select short video for upload and associate with said selected date and time said selected video 2732. Publisher can select other date and/or time 2720 and can select short video for upload and associate with said selected date and time said selected content including short video 2730. In an embodiment instead of uploading video publisher can select access short video from defined server or website or application or database or storage medium 2727. Publisher can select user actions and associate with one or more content including short videos 2630/2632. Publisher can select global 2775 or select country 2771 or select state 2772 or select city 2773 or select area 2774 for publishing content or short video 2732/2730. Publisher can select make payment and submit control or button 2735 to open payment and submission user interface 2735 for providing payment amount, details and submit for said scheduled publication of said selected and uploaded content including short video for viewing users of network. Server 115 store schedule, associate content including short video and action(s) and other details.

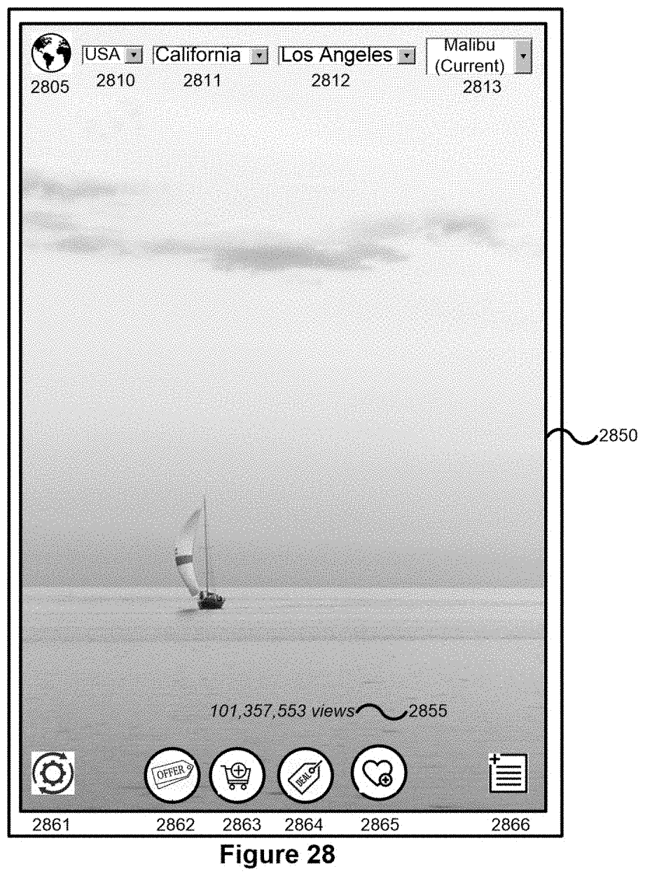

FIG. 28 illustrates in an embodiment viewing users of network can select global 2805 or select country 2810 or select state 2811 or select city 2812 or select area 2813 to view all contents including short video 2732/2730 posted under global option 2775 or country option 2771 or state option 2772 or city option 2773 or area option 2774 respectively selected by publisher as per pre-scheduled date 2701 and time 2718 set by associated publisher. In an embodiment user can view and access said contents including short video 2850 associated actions including offer 2862, shop or buy 2863, voucher or coupon 2864, add to like 2865 and add to list 2866.

In an embodiment when user opens application or user interface for viewing short videos, then system identifies bookmarked or selected or default option (e.g. global) specific short video based on current date and time and short video associated date and time and further identify position of identified short video based on current time and start playing short video from said identified position. In an embodiment in the event of ending of current time specific first video automatically presenting current time specific second short video.

In another important embodiment OTT or video on demand service providers or publishers can pre-set date and time (schedule) with selected video content including movies, television programs, short videos and any types of videos and select or associate one or more categories or keywords and when viewing user select particular category or keyword, connecting server of publisher and streaming or downloading and displaying current date and time associated video content. In another embodiment enabling publisher to advertise about publication, associated details and date and time and enabling users to opt-in notification, so publisher can send notification before pre-set duration of scheduled publication including video contents like particular movie, television program.

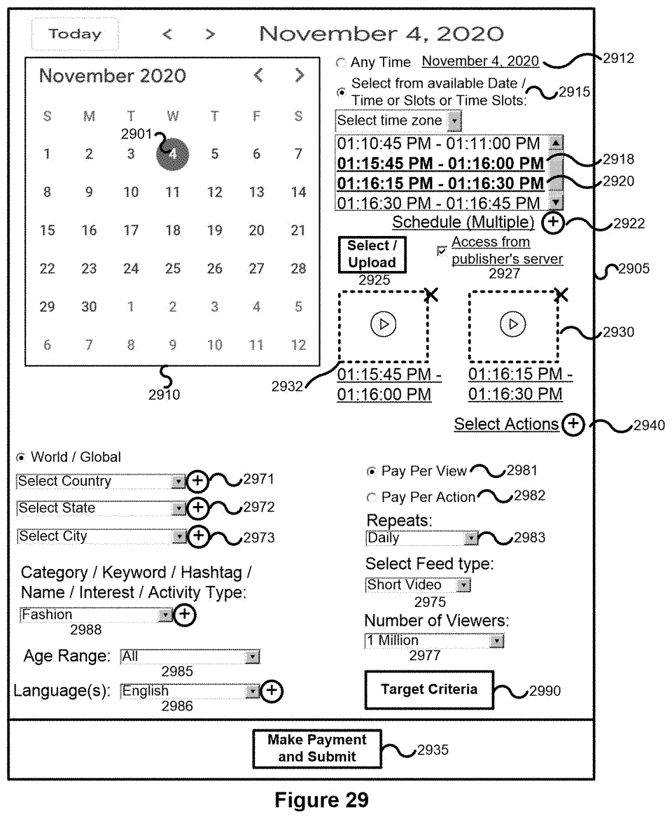

FIG. 29 illustrates self-service graphical user interface for broadcasting, publishing scheduled short video or content and associated action(s) as per pre-set schedule under selected one or more categories and keywords by publisher, wherein publisher or user or admin can select date 2901 from available date 2910 and select time 2918 or select anytime 2912 at said selected date 2901. In an embodiment publisher can select short video for upload and associate with said selected date and time said selected video 2932. Publisher can select other date and/or time 2920 and can select short video for upload and associate with said selected date and time said selected content including short video 2930. In an embodiment instead of uploading video publisher can select access short video from defined server or website or application or database or storage medium 2927. Publisher can select user actions and associate with one or more content including short videos 2930/2932. Publisher can select global 2975 or select country 2971 or select state 2972 or select city 2973 or select area 2974, select one or more categories and keywords 2988 for publishing content or short video 2932/2930. Publisher can also select age range 2985 and language(s) Publisher can select make payment and submit control or button 2735 to open payment and submission user interface 2735 for providing payment amount, details and submit for said scheduled publication of said selected and uploaded content including short video for viewing users of network. Server 115 store schedule, associate content including short video and action(s) and other details. In an embodiment publisher cans select payment models including pay per view 2981 and pay per action 2982, select repeat publishing options including daily, selected day or days in week at specific time 2983, select type of feed including short video 2975.

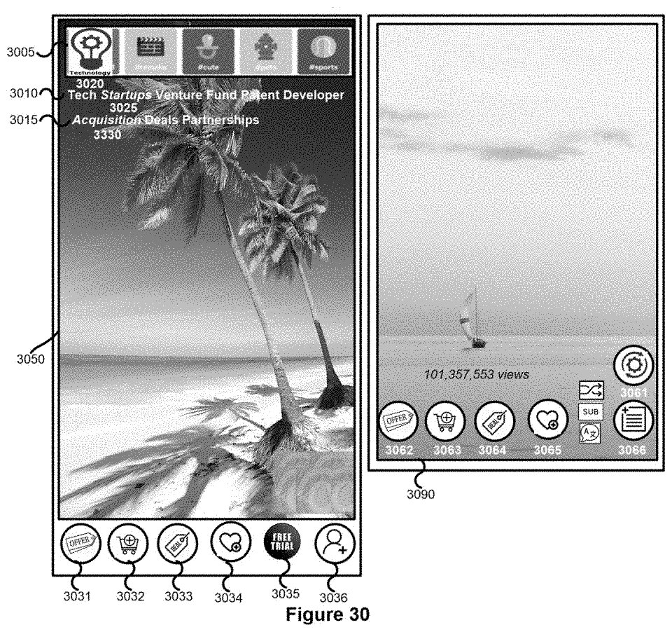

FIG. 30 illustrates in an embodiment in the event of selection of category 3020 from list of displayed categories 3005, selection of sub-category 3025 from list of displayed sub-categories 3010 and selection of sub-sub-category 3030 from list of displayed sub-sub-categories 3015, displaying short video based on associated category, sub-category and sub-sub-category, current date and time and short video associated date and time. In an embodiment user can view and access said contents including short video 3050 associated actions including offer 3031, shop or buy 303, voucher or coupon 3033, add to like 3034 and like.

In an embodiment when user opens application or user interface for viewing short videos, then system identifies bookmarked or selected or default option (e.g. global) specific short video based on current date and time and short video associated date and time and further identify position of identified short video based on current time and start playing short video from said identified position. In an embodiment in the event of ending of current time specific first video automatically presenting current time specific second short video.

In another embodiment FIG. 29 illustrates, publisher can select or input or set publication target criteria including location, interest, gender, age range, education, school, college, job, business name, type, category, location associated target viewing users, currently using and liked products and services by target viewing users, interacted name, type, location of entities 2990 and plurality types of other possible and available criteria in addition to major criteria including country, state, city, one or more keywords and categories, age range, languages.

In another embodiment FIG. 30 illustrates graphical user interface 3090 wherein viewing user can view short videos based on matching target criteria associated with short videos with viewing user associated profile, data, logged activities details, preferences, privacy settings.

In another important embodiment OTT or video on demand service providers or publishers can pre-set date and time (schedule) with selected video content including movies, television programs, short videos and any types of videos and select or associate one or more categories or keywords and when viewing user select particular category or keyword, connecting server of publisher for streaming or downloading and displaying current date and time associated video content. In another embodiment enabling publisher to advertise about publication, associated details and date and time and enabling users to opt-in notification, so publisher can send notification before pre-set duration of scheduled publication including video contents like particular movie, television program. In an embodiment user can view and access said contents including short video 3050 associated actions including offer 3062, shop or buy 3063, voucher or coupon 3064, add to like 3065 and add to list 3066. In an embodiment when user opens application or user interface for viewing short videos, then system identifies bookmarked or selected or default option (e.g. global) specific short video based on current date and time and short video associated date and time and further identify position of identified short video based on current time and start playing short video from said identified position. In an embodiment in the event of ending of current time specific first video automatically presenting current time specific second short video.

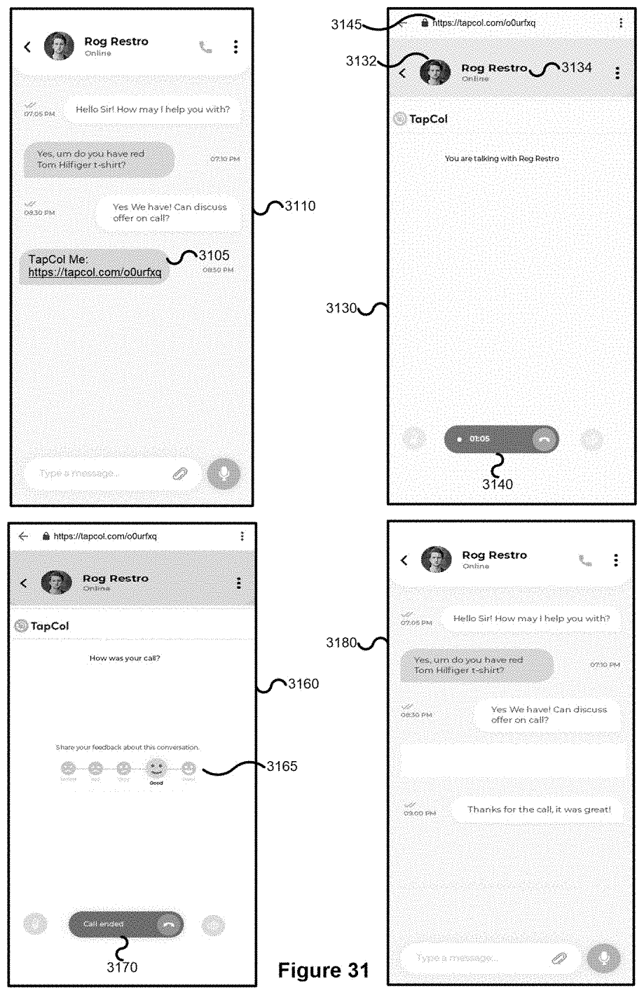

FIG. 31 illustrates graphical user interface of instant messenger wherein user can share uniform resource locator (URL) or link or link control 3105 with one or more contacts or connections, wherein in an embodiment each user is provided with unique uniform resource locator (URL) or link or in another embodiment graphical user interface enabling user to generate the uniform resource locator (URL) or link and share with all or one or more selected contacts, groups, connections or users of network. In another embodiment providing each registered user unique uniform resource locator (URL) or link and user can enter or select name(s) or group name(s), photo or image and other details of user(s) or group(s) and generate or configure uniform resource locator (URL) or link to identify name, photo and details of user or group with whom user share uniform resource locator (URL) or link via 3^{rd} parties instant messenger applications. In another embodiment instant messenger comprises 3^{rd} parties instant messenger applications wherein user can share uniform resource locator (URL) or link with one or more contacts or groups via 3^{rd} parties instant messenger applications. In the event of sharing uniform resource locator (URL) or link or link control, displaying uniform resource locator (URL) or link or link control 3105 in user interface (e.g. 3^{rd} parties Instant messenger application like WhatsApp™) 3110. In the event of selecting or clicking or tapping on uniform resource locator (URL) or link or link control 3105, displaying said selected uniform resource locator (URL) or link or link control 3105/3145 associated online web page or web app or progressive web app (PWA) and establishing connection with user selected or generated or configured uniform resource locator (URL) or link associated user(s) or group(s) and start real-time communication session or channel or communication interface including establishing voice communication channel between user who selected uniform resource locator (URL) or link 3105 and user who shared uniform resource locator (URL) or link 3105 and in the event of establishing communication session automatically displaying web page or user interface or application or progressive web application (PWA) in user device who shared said link 3105 and displaying interface or link control 3140 for enabling user to start voice or video call conversation and enabling both to end call, view status of call including calling or connecting, connected, online, ended and missed call, duration of call. Based on user configured link displaying name 3134, photo or image 3132 of user 3134 or group. In an embodiment, in the event of selecting or clicking or tapping on end button or link control 3140 by caller or callee, ending call or call session or disconnecting user(s) who ended call and displaying call ended interface 3160 and status interface 3170. In another embodiment instructing or requesting user to provide feedback about call quality 3165. In another embodiment in separate independent user interface, displaying recorded call conversation 3190 and enabling user to hear recorded voice call(s) 3190 or view recorded video call(s). In an embodiment generating, configuring link and voice and video communication interface, application, service and network and 3^{rd} parties instant messenger or chat application both are independent and different application, service, interface, platform, server and entity. In another embodiment requiring user to register to generating, configuring uniform resource locator (URL) or link and accessing said selected URL or link associated voice and video communication interface, application, service and network and in the event of registration automatically informing all contacts, adding user in contacts of all contacts of user and enabling contact of user to select user for configure URL or link for enabling to connecting for communication. So user can conduct voice/video communication in-between instant messenger or chat communication session on 3^{rd} parties instant messenger or chat application via URL or link or short link associated voice/video communication user interface or application or progressive web application (PWA). In another embodiment user or system can automatically generate unique URL or link for each contacts or added contacts or related registered users and automatically send to contacts or connections or related users, so contacts of suer can reuse uniform resource locator (URL) or link and communicate with user. In another embodiment user can use 3^{rd} parties messaging or chat application for sending and receiving messages and if require use separate application and select user and conduct voice or video call and after conversation, manually or based on settings automatically share or send recorded voice or video to said contact or connection or user via 3^{rd} parties messaging or chat application. So user can anytime view messages and also play, pause, reply, download, reshare said shared or received voice or video in 3^{rd} parties messaging or chat application. In another embodiment user can communicate anonymously or without disclosing identity. In another embodiment in the event of selecting URL or link 3105, automatically and directly enabling caller and callee to immediately allow caller and callee to conduct voice/video communication with each other. In another embodiment in the event of selecting URL or link 3105, displaying incoming call interface to callee (as per settings enabling ringtone, vibration or only display user interface) and in the event of acceptance of incoming call, allow caller and callee to conduct voice/video communication with each other.

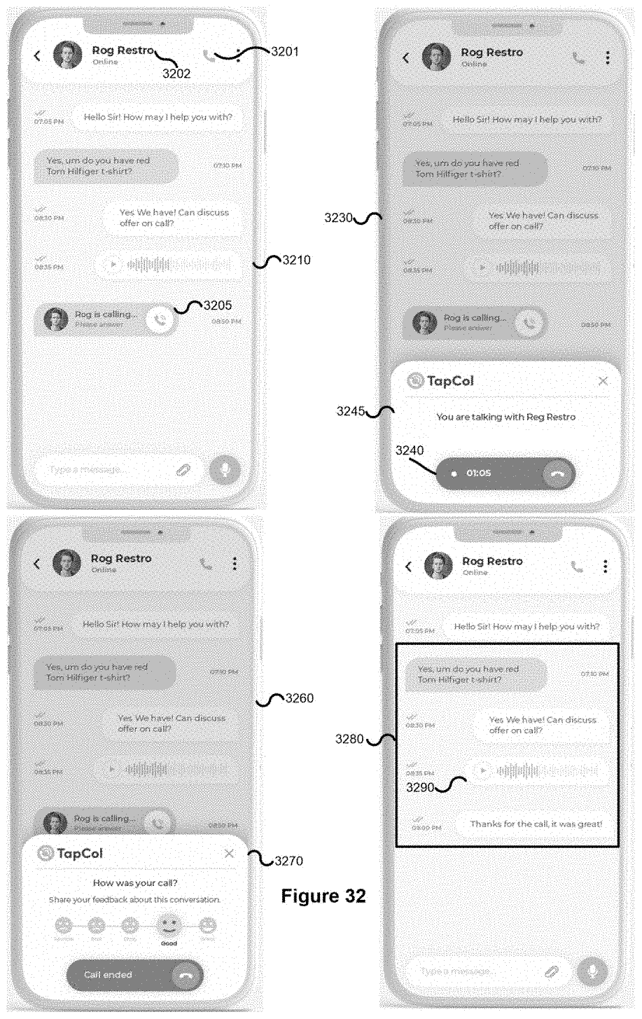

FIG. 32 illustrates graphical user interface of instant messaging or chat or communication or publishing or sharing application wherein during messaging or sharing or publishing or more types of contents including messages, text, posts, photos, videos, uniform resource locator (URL), audio, emoticons, locations, files or documents, user can select two way voice or video messaging or communication option 3201 via control including button or icon or link or can share or send voice/video communication interface 3205. In the event of selection of option 3201, displaying voice/video communication interface 3245/3240 and based on settings directly enabling caller and callee to start voice/video communication with each other or in another embodiment displaying or notifying or providing indication of starting of voice/video call or displaying of incoming call interface 3245/3240 and in the event of providing indication of call acceptance via control 3205 or selecting call acceptance button or control, displaying voice/video communication interface 3245 and enabling caller and callee to start voice/video communication with each other. In another embodiment in the event of sharing of voice/video interface or control 3205 or in the event of selection of two or multi ways voice/video communication option 3201, displaying integrated call interface 3245 for enabling user to view different status of all including incoming, outgoing, connecting, connected, call accepted, call rejected, missed call, call duration and enabling caller user to end call, pause call, recall, and enabling callee to accept or reject call or recall. In the event of ending of call by caller or callee via control or button 3240, end voice call, instructing or requesting user to provide feedback about call quality 3270. In another embodiment displaying recorded call conversation 3290 and enabling user to select recorded call conversation 3290 in-between messages 3280 and hear recorded voice call 3290 or view recorded video call. So in-between sending and receiving of messages or contents, when need user(s) can one or more time conduct voice/video communication to expedite the communication.

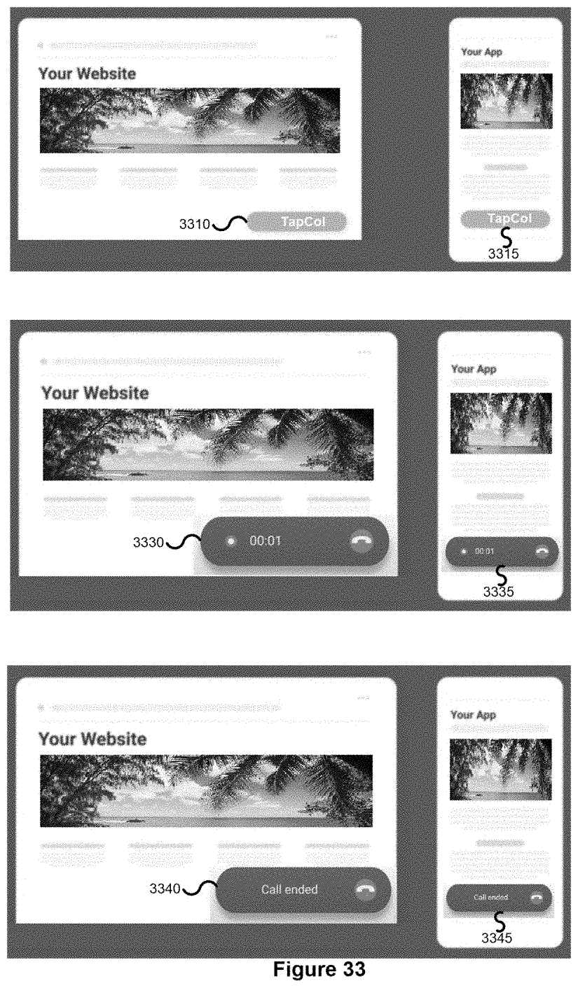

FIG. 33 illustrates graphical user interface for enabling website visitors can select voice and/or video communication control or button 3310/3315 and can conduct voice and/or video communication with website admin or staff or associated authorized person(s). In the event of selecting voice and/or video communication control or button 3310/3315, notifying said website associated admin or staff or associated authorized person(s) and in the event of identifying available person and/or in the event of accepting call establishing communication session and enabling website visitor and said call accepted user to communicate 3330/3335 with each other. In another embodiment based on settings directly initiating voice and/or video communication session and enabling visitor and said website associated identified or available admin or staff or associated authorized person(s) to communication with each other. In the event of ending of call 3330/3335 by caller or callee, ending communication and display call ended indication 3340/3345.

In an embodiment website admin can integrate voice and/or video communication control and interface via application programming interfaces (APIs), web services and software development toolkit (SDKs).

In another embodiment enabling user to install progressive web application, input one or more types of unique identity including phone number, email address, and other types of unique identity, wherein system automatically identify phone number and/or email address based on associated one or more types of unique identity and send SMS or email or notification or instant message, wherein message comprise short link or uniform resource locator (URL) which enabling receiving user to select short link or uniform resource locator (URL) or link control and in the event of selection of short link or uniform resource locator (URL) or link control, displaying communication user interface, establishing communication session between caller and callee and enabling them to communicate with each other or displaying incoming call interface and in the event of accepting of call, displaying communication user interface and establishing communication session between caller and callee and enabling them to communicate with each other. In another embodiment enabling callee to report caller as inappropriate, logging IP address and block caller user.

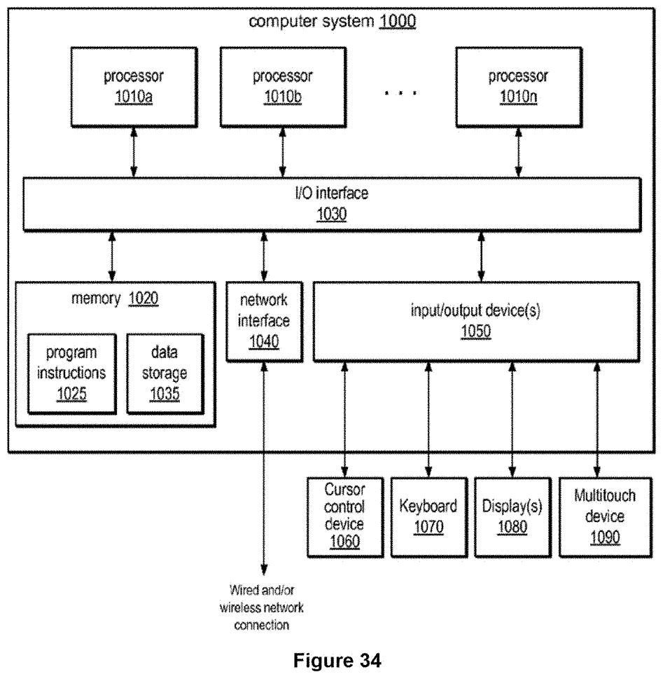

Various components of embodiments of methods as illustrated and described in the accompanying description may be executed on one or more computer systems, which may interact with various other devices. One such computer system is illustrated by FIG. 34. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random-access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 34, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations. Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense. In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data.

The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object-oriented programming language(s). The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application. Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. Embodiments of the invention may also relate to an apparatus for performing the operations herein. Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on.

I claim:

1. The method of two-way voice and video communication within instant messaging or chatting session and user interface, wherein method comprising:
a. initiating or establishing messaging session between the first user and the second user;
b. enabling a first user and a second user to send and receive messages and one or more types of contents from the messaging or sharing user interface;
c. in the event of receiving from the first user, indication of voice and/or video call by the second user, displaying voice and/or video interface to the first user and the second user or displaying indication or notification or incoming call interface to the second user and in the event of acceptance of call, displaying voice and/or video interface to the first user and the second user;
d. initiate voice and/or video communication session between the first user and the second user and enabling the first user and the second user to start voice and/or video communication with each other;
e. in the event of receiving call ending indication from the first user or the second user, ending call, ending voice and/or video communication session, closing or hiding voice and/or video communication user interface and store recorded voice and/or video communication between the first user and the second user;
f. displaying recorded voice and/or video communication between the first user and the second user in messaging or shared contents interface or messages threads of the first user and the second user in current message session; and
g. in the event of selection of recorded voice and/or video communication, playing recorded voice and/or video communication.

2. The method of claim 1 wherein in the event of making or initiating call by the caller, automatically start one or two way voice or video communication and enabling callee or user(s) to speak, pause, end call and listen recorded voice or video call conversation and based on settings or selection of option(s), enabling callee to listen, view video, listen or view recorded, speak, mute or unmute microphone or voice, pause, restart, reject, miss, block and end call or read or view voice to text messages or transcript based on voice to text technology.

3. The method of claim 1 wherein in the event of making call, display incoming call interface or message within messaging session with accept call, reject call control including button or link or provide voice notification or notification or play pre-set ringtone or voice or audio or conduct pre-set type of vibration or any combination thereof.

4. The method of claim 1 wherein enabling the second user to reject call; in the event of rejecting call notifying the first user about rejected call and continue communication via messaging within current message session.

5. The method of claim 1 enabling the second user to miss call, wherein in the event of non-acceptance of call within pre-set duration, notifying the first user about mis call and continue communication via messaging within current message session.

6. The method of claim 1 wherein enabling user to play recorded voice and video call or view or read text transcript of recorded voice call or voice of recorded video call or displaying text transcript while playing recorded video of video call.

7. The method of claim 1 wherein enabling user to select ephemeral voice or video call option; in the event of ending of voice or video call, does not record or show recorded voice or video call within messaging thread of current messaging session within messaging interface.

8. The method of claim 1 wherein after making and accepting voice or video call during messaging session within messaging interface, during voice or video call, enabling users to pause or hold or re-start voice or video call or turn off or turn on voice or video of current voice or video call within messaging interface, wherein record and display voice or video of voice or video call between start and pause or re-start and pause voice or video call.

9. The system of two-way voice and video communication within instant messaging or chatting session and user interface, wherein system comprising:
a. initiate or establish messaging session between the first user and the second user;
b. enable a first user and a second user to send and receive messages and one or more types of contents from the messaging or sharing user interface;
c. in the event of receiving from the first user, indication of voice and/or video call by the second user, displaying voice and/or video interface to the first user and the second user or displaying indication or notification or incoming call interface to the second user and in the event of acceptance of call, displaying voice and/or video interface to the first user and the second user;
d. initiate voice and/or video communication session between the first user and the second user and enabling the first user and the second user to start voice and/or video communication with each other;
e. in the event of receiving call ending indication from the first user or the second user, end call, end voice and/or video communication session, close or hide voice and/or video communication user interface and store recorded voice and/or video communication between the first user and the second user;
f. display recorded voice and/or video communication between the first user and the second user in messaging or shared contents interface or messages threads of the first user and the second user in current message session; and
g. in the event of selection of recorded voice and/or video communication, play recorded voice and/or video communication.

10. The system of claim 9 wherein in the event of making or initiating call by the caller, automatically start one or two way voice or video communication and enable callee or user(s) to speak, pause, end call and listen recorded voice or video call conversation and based on settings or selection of option(s), enable callee to listen, view video, listen or view recorded, speak, mute or unmute microphone or voice, pause, restart, reject, miss, block and end call or read or view voice to text messages or transcript based on voice to text technology.

11. The system of claim 9 wherein in the event of making call, display incoming call interface or message within messaging session with accept call, reject call control including button or link or provide voice notification or notification or play pre-set ringtone or voice or audio or conduct pre-set type of vibration or any combination thereof.

12. The system of claim 9 wherein enable the second user to reject call; in the event of rejecting call, notify the first user about rejected call and continue communication via messaging within current message session.

13. The system of claim 9 wherein enable the second user to miss call, wherein in the event of non-acceptance of call within pre-set duration, notify the first user about mis call and continue communication via messaging within current message session.

14. The system of claim 9 wherein enable user to play recorded voice and video call or view or read text transcript of recorded voice call or voice of recorded video call or display text transcript while playing recorded video of video call.

15. The system of claim 9 wherein enable user to select ephemeral voice or video call option; in the event of ending of voice or video call, does not record or show recorded voice or video call within messaging thread of current messaging session within messaging interface.

16. The system of claim 9 wherein after making and accepting voice or video call during messaging session within messaging interface, during voice or video call, enable users to pause or hold or re-start voice or video call or turn off or turn on voice or video of current voice or video call within messaging interface, wherein record and display voice or video of voice or video call between start and pause or re-start and pause voice or video call.

17. The method of two-way voice and video communication within 3^{rd} parties independent instant messaging or chatting session and user interface or application, wherein method comprising:
a. receiving from a first user, selection of a second user; generating uniform resource locator (URL) or short link based on information associated with the second user;
b. initiating or establishing messaging session between the first user and the second user;
c. enabling a first user and a second user to send and receive messages and one or more types of contents from the messaging or sharing user interface;
d. enabling a first user to send or share uniform resource locator (URL) or short link associated with the second user to the second user;
e. in the event of selection of received uniform resource locator (URL) or short link associated with the second user by the second user, displaying voice and/or video interface to the first user and the second user or displaying indication or notification or incoming call interface to the second user and in the event of acceptance of call, displaying voice and/or video interface to the first user and the second user;
f. initiate voice and/or video communication session between the first user and the second user and enabling the first user and the second user to start voice and/or video communication with each other;
g. in the event of receiving call ending indication from the first user and the second user, ending call, end voice and/or video communication session, closing or hiding voice and/or video communication user interface and store recorded voice and/or video communication between the first user and the second user;
h. enabling to, the first user and the second user, to share or automatically share recorded voice and/or video communication with the first user and the second user;
i. displaying recorded voice and/or video communication between the first user and the second user in messaging or shared contents interface or messages threads in the 3^{rd} parties instant messenger or chat application of the first user and the second user; and
j. in the event of selection of recorded voice and/or video communication, playing recorded voice and/or video communication.

18. The method of claim 17 wherein in the event of making or initiating call by the caller, automatically start one or two way voice or video communication and enabling callee or user(s) to speak, pause, end call and listen recorded voice or video call conversation and based on settings or selection of option(s), enabling callee to listen, view video, listen or view recorded, speak, mute or unmute microphone or voice, pause, restart, reject, miss, block and end call or read or view voice to text messages or transcript based on voice to text technology.

19. The system of two-way voice and video communication within 3^{rd} parties independent instant messaging or chatting session and user interface or application, wherein method comprising:
a. receive from a first user, selection of a second user; generate uniform resource locator (URL) or short link based on information associated with the second user;
b. initiate or establish messaging session between the first user and the second user;
c. enable a first user and a second user to send and receive messages and one or more types of contents from the messaging or sharing user interface;
d. enable a first user to send or share uniform resource locator (URL) or short link associated with the second user to the second user;
e. in the event of selection of received uniform resource locator (URL) or short link associated with the second user by the second user, display voice and/or video interface to the first user and the second user or display indication or notification or incoming call interface to the second user and in the event of acceptance of call, display voice and/or video interface to the first user and the second user;
f. initiate voice and/or video communication session between the first user and the second user and enable the first user and the second user to start voice and/or video communication with each other;
g. in the event of receiving call ending indication from the first user and the second user, end call, end voice and/or video communication session, close or hide voice and/or video communication user interface and store recorded voice and/or video communication between the first user and the second user;
h. enable to, the first user and the second user, to share or automatically share recorded voice and/or video communication with the first user and the second user;
i. display recorded voice and/or video communication between the first user and the second user in messaging or shared contents interface or messages threads in the 3^{rd} parties instant messenger or chat application of the first user and the second user; and
j. in the event of selection of recorded voice and/or video communication, play recorded voice and/or video communication.

20. The system of claim 19 wherein in the event of making or initiating call by the caller, automatically start one or two way voice or video communication and enable callee or user(s) to speak, pause, end call and listen recorded voice or video call conversation and based on settings or selection of option(s), enable callee to listen, view video, listen or view recorded, speak, mute or unmute microphone or voice, pause, restart, reject, miss, block and end call or read or view voice to text messages or transcript based on voice to text technology.
